(19) United States
(12) Patent Application Publication
(10) Pub. No.: US 2026/0352475 A1
(43) Pub. Date: Nov. 5, 2026

(54) COMPUTER-IMPLEMENTED SYSTEM AND METHOD FOR SECURING AUTHENTICATION OF USERS

(71) Applicant: Hawcx Inc, Los Altos, CA (US)

(72) Inventors: Sri Soundarya Kottur Shanmugam, Los Altos, CA (US); Ravindraraj Ramaraju, Round Rock, TX (US); Selvanathan Kumaraswamy, Round Rock, TX (US)

(21) Appl. No.: 19/745,122

(22) Filed: Jul. 17, 2026

Related U.S. Application Data
(63) Continuation-in-part of application No. 18/659,245, filed on May 9, 2024, now Pat. No. 12,706,744.

(51) Int. Cl. H04L 9/32

(52) U.S. Cl. CPC H04L 9/3213; H04L 9/3218; H04L 9/3231; H04L 9/3271

(57) ABSTRACT

A computer-implemented method and system for securing authentication of users, is disclosed. The computer-implemented method includes: registering a user identity; for every subsequent login, authenticating user through zero-knowledge proof ceremony in which biometric check is performed within hardware security module of user device; upon detection of newly added biometric entry after registration of user identity, initiating cryptographic zeroization of credential material stored on user device; upon successful authentication, deriving cryptographic keys assigned to AI agent from master cryptographic key using deterministic key derivation function; generating a single-use authorization token encoding a permitted tool the AI agent is permitted to call, authorized data scope, action constraints, and trust tier; requiring cryptographic signature from second enrolled device that has independently completed biometric authentication; and generating bilateral cryptographic receipt comprising authorization signature from user and execution signature from service provider.

### CROSS REFERENCE TO RELATED APPLICATION(S)

The present application is a continuation-in-part of U.S. Patent Application No. 18/659,245, filed on May 09, 2024, titled “COMPUTER-IMPLEMENTED SYSTEM AND METHOD FOR MANAGING AUTHENTICATION BETWEEN USER DEVICE AND AUTHENTICATION SERVER USING PRIVATE-PUBLIC KEY CRYPTOGRAPHY”.

### FIELD OF INVENTION

Embodiments of the present disclosure relate to authentication based computing systems, and more particularly relates to a computer-implemented system and method for securing authentication of users and authorization of artificial intelligence (AI) agent actions.

### BACKGROUND

In a realm of digital security and authentication, a landscape is constantly evolving to meet ever-growing challenges posed by cyber threats. Traditional authentication methods including username/password combinations have proven to be susceptible to various forms of an attack, leading to an increased demand for more robust and secure solutions.

One prominent advancement in this domain is a development of Fast Identity Online (FIDO) standards, which aim to address shortcomings of traditional authentication methods by introducing stronger security measures, including at least one of: a biometric authentication and public-key cryptography. However, existing implementations of the FIDO standards, such as those relying on Trusted Platform Modules (TPMs) for storing private keys are constrained by a vendor lock-in. This means that the private keys employed for the authentication are tied to specific hardware or ecosystems, limiting interoperability and flexibility for users. Additionally, the reliance on hardware-based storage solutions like the TPMs presents challenges for a cross-platform authentication.

Furthermore, the traditional authentication methods rely on a centralized storage of user credentials, making the authentication methods susceptible to data breaches and unauthorized access. When an attacker gains access to a central repository of the user credentials, the attacker may potentially compromise accounts of the numerous users, leading to widespread security implications.

In the existing technology, a key encryption and decryption mechanisms are disclosed. The key encryption and decryption mechanisms may provide an asymmetric encryption circuit. When a session encrypted data key (SEDK) is wrapped with an asymmetric encryption, an asymmetric decryption is required, using the private key of a public-private key pair set. In this case, the private key is only accessible by hardware internal to an Application Specific Integrated Circuit (ASIC), and requirements to intertwine the controls for multiplexors are much reduced. However, this ensures that the private key and the result of the decryption with the private key, are not accessible externally to the ASIC. Nevertheless, the key encryption and decryption mechanisms rely on the ASICs for the encryption and decryption processes. Hence, there are vendor lock-in issues, where the key encryption and decryption mechanisms become tightly coupled with a particular hardware vendor or technology stack.

There are various technical problems with the traditional authentication methods in the prior art. In the existing technology, a traditional password-based authentication is vulnerable to the various attacks, including brute force attacks, dictionary attacks, and credential stuffing. The users may choose weak passwords or reuse the passwords across the multiple accounts, increasing the risk of compromise. In the traditional authentication methods, the passwords are stored on servers, making the passwords susceptible to theft in the event of the data breach. The attackers may exploit vulnerabilities in a server infrastructure to gain the unauthorized access to the user credentials. Some traditional authentication methods, such as those based on proprietary hardware or cloud services, may lead to the vendor lock-in, limiting interoperability and flexibility. For instance, the traditional authentication methods that rely on the vendor specific TPMs or the cloud services restrict the users to a particular ecosystem.

Although modern authentication systems have introduced hardware-backed biometrics, public-key cryptography, multi-factor authentication, and passwordless login mechanisms, such systems are primarily directed toward verifying a user's identity during an authentication event. Once authenticated, existing systems generally provide limited controls over how subsequent actions are authorized, delegated, or executed, particularly in environments involving autonomous software agents.

The increasing adoption of artificial intelligence (AI) agents and autonomous software agents capable of performing actions on behalf of users introduces additional security challenges that are not adequately addressed by conventional authentication and authorization frameworks. Such AI agents may access sensitive information, invoke external services, execute transactions, modify data, or perform other actions under delegated authority. Existing authorization mechanisms commonly rely on passwords, one-time passcodes (OTPs), account recovery procedures, human review processes, policy-based controls, or application-layer permissions, each of which may be susceptible to phishing attacks, social engineering, credential theft, replay attacks, device compromise, deepfake impersonation, or user coercion.

Existing authentication systems also frequently depend upon account recovery workflows, remote identity verification procedures, customer-support-mediated access restoration, or human review processes. These approaches create additional attack surfaces that may be exploited through forged documents, synthetic identities, manipulated audio or video content, deepfake technologies, or other forms of impersonation. As advances in generative artificial intelligence continue to improve the realism of such attacks, traditional human-verification mechanisms become increasingly unreliable for security-critical decisions.

Furthermore, conventional authorization systems typically treat successful user authentication as sufficient authority for subsequent actions. As a result, once a device, credential, or session is compromised, an attacker may gain the ability to perform high-risk actions without additional cryptographic verification. Existing systems generally lack mechanisms for independently validating high-risk actions, restricting agent capabilities under duress conditions, cryptographically linking individual actions to verified user intent, or generating tamper-resistant evidence of authorization and execution.

Hence, there is a need for an improved computer-implemented system for securing authentication of users and authorization of artificial intelligence (AI) agent actions, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a computer-implemented method for securing authentication of users, is provided. The computer-implemented method includes registering, by one or more hardware processors, a user identity. The registration of the user identity generates a master cryptographic key stored in a hardware security module of a user device. No secret data is transmitted after the registration of the user identity is completed.

For every subsequent login, the computer-implemented method further includes authenticating, by the one or more hardware processors, a user through a zero-knowledge proof ceremony in which a biometric check is performed within the hardware security module of the user device.

The computer-implemented method further includes monitoring, by the one or more hardware processors, an enrolled biometric set of the user device. Upon detection of a newly added biometric entry after the registration of the user identity, the computer-implemented method further includes initiating, by the one or more hardware processors, cryptographic zeroization of credential material stored on the user device.

upon successful authentication, The computer-implemented method further includes deriving, by the one or more hardware processors, cryptographic keys assigned to each artificial intelligence (AI) agent from a master cryptographic key using a deterministic key derivation function. Each cryptographic key assigned to each AI agent is cryptographically isolated, whereby access to credentials of one AI agent provide no information regarding credentials of other AI agents. for each action requested by an AI agent, the computer-implemented method further includes generating, by the one or more hardware processors, a single-use authorization token encoding a permitted tool or service the AI agent is permitted to call, an authorized data scope, action constraints, and a trust tier. The single-use authorization token is atomically consumed upon first use, rendering the single-use authorization token unavailable for replay. For AI agent actions above a configurable risk threshold, the computer-implemented method further includes requiring, by the one or more hardware processors, a cryptographic signature from a second enrolled device that has independently completed biometric authentication. A notification tap, video confirmation, or voice confirmation is insufficient to satisfy the requiring. Upon execution of each AI agent action, the computer-implemented method further includes generating, by the one or more hardware processors, a bilateral cryptographic receipt comprising an authorization signature from the user and an execution signature from a service provider. The bilateral cryptographic receipt is independently verifiable by a third party without access to session keys.

In an embodiment, the computer-implemented method further includes (a) detecting, by the one or more hardware processors, a duress authentication event based on entry of a designated panic PIN or activation of a distress biometric; (b) in response to detecting the duress authentication event, silently transitioning, by the one or more hardware processors, the authentication to a restricted operational mode without visible indication to an authenticating party; (c) transmitting, by the one or more hardware processors, an encrypted alert comprising GPS coordinates, a timestamp, and a device identifier, to a server; (d) setting, by the one or more hardware processors, trust levels of each AI agent to read-only for precluding execution of transactions and irreversible actions during a duress session; and (e) logging, by the one or more hardware processors, every action attempted during the duress session with enhanced forensic metadata comprising geolocation, timestamp, and a duress session identifier

In another embodiment, the computer-implemented method further includes re-routing, by the one or more hardware processors, client initiated backchannel authentication (CIBA) approval requests generated during the duress session to a pre-registered emergency contact instead of routing to the user.

In yet another embodiment, registering the user identity comprises: (a) for an enterprise user, verifying, by the one or more hardware processors, a government-issued identity document in person by an authority, and generating a one-time registration code tied to the verified government-issued identity document, wherein the one-time registration code is single-use, time-bounded, and valid only on a specific device being enrolled; and (b) for a consumer user, capturing, by the one or more hardware processors, the government-issued identity document, completing a live selfie check with liveness detection using challenge-response verification, performing a document authenticity check to verify that the government-issued identity document is not forged, and performing a face match to confirm that the user matches the government-issued identity document.

In yet another embodiment, the computer-implemented method provides authorization of AI agent actions, and further includes assigning, by the one or more hardware processors, a maximum AI agent authorization trust tier to an account based on an assurance level of an identity verification method used during the registration of the user identity, wherein the maximum AI agent authorization trust tier is enforced cryptographically at a token minting layer. In an embodiment, in-person physical verification maps to a maximum available AI agent authorization trust tier, a near field communication (NFC) passport chip cryptographic verification maps to a higher trust tier instead of selfie-based verification, and selfie plus document verification maps to a defined lower trust tier ceiling.

In yet another embodiment, authenticating the user further comprises: (a) providing, by the one or more hardware processors, dual cryptographically distinct keys to the hardware security module of the user device, comprising a normal key bound to a primary enrolled biometric entry and a distress key bound to a secondary enrolled biometric entry; (b) upon each authentication attempt, silently attempting, by the one or more hardware processors, the authentication attempts to unlock the normal key, and if the normal key fails, silently attempting to unlock the distress key; and (c) upon activation of the distress key, unlocking, by the one or more hardware processors, a sandboxed AI agent environment that is operationally identical to but capability-restricted from a normal AI agent environment, wherein the sandboxed AI agent environment is indistinguishable from the normal AI agent environment to an external observer.

In yet another embodiment, the user device is designated as a sole recovery authority for an associated user account, and, responsive to loss of the user device, re-establishment of access requires re-registration based on physical identity verification. Each security-critical operation is authorized exclusively based on cryptographic verification of one or more cryptographic proofs generated by the user device. Authorization of a security-critical operation requires validation of a cryptographic signature, successful completion of a cryptographic challenge, and verification of possession of an enrolled physical device, thereby preventing execution of the security-critical operation by synthetic media, impersonation artifacts, or other non-device-based authentication attempts.

In yet another embodiment, the authentication of the user is a mutual cryptographic challenge-response in which both the user device and the server prove that the user device and the server possess a correct private key without transmitting the correct private key between each other. The server learns that the user device possesses the correct private key, and wherein upon success authentication of the user, the master cryptographic key is released to unlock an agent credential chain.

In one aspect, a computer-implemented system for securing authentication of users, is disclosed. The computer-implemented system includes one or more hardware processors and a memory coupled to the one or more hardware processors. The memory includes a plurality of subsystems in the form of programmable instructions executable by the one or more hardware processors.

The plurality of subsystems comprises a user registering subsystem configured to register a user identity. The registration of the user identity generates a master cryptographic key stored in a hardware security module of a user device. No secret data is transmitted after the registration of the user identity is completed.

The plurality of subsystems further comprises a user authenticating subsystem configured to authenticate a user for every subsequent login, through a zero-knowledge proof ceremony in which a biometric check is performed within the hardware security module of the user device. The plurality of subsystems further comprises a credential self-destructing subsystem configured to: (a) monitor an enrolled biometric set of the user device; and (b) upon detection of a newly added biometric entry after the registration of the user identity, initiate cryptographic zeroization of credential material stored on the user device.

The plurality of subsystems further comprises an agent authorizing subsystem configured to: (a) upon successful authentication, derive cryptographic keys assigned to each artificial intelligence (AI) agent from a master cryptographic key using a deterministic key derivation function, wherein each cryptographic key assigned to each AI agent is cryptographically isolated, whereby access to credentials of one AI agent provide no information regarding credentials of other AI agents; (b) for each action requested by an AI agent, generate a single-use authorization token encoding a permitted tool or service the AI agent is permitted to call, an authorized data scope, action constraints, and a trust tier, wherein the single-use authorization token is atomically consumed upon first use, rendering the single-use authorization token unavailable for replay; (c) for AI agent actions above a configurable risk threshold, require a cryptographic signature from a second enrolled device that has independently completed biometric authentication, wherein a notification tap, video confirmation, or voice confirmation is insufficient to satisfy the requiring; and (d) upon execution of each AI agent action, generate a bilateral cryptographic receipt comprising an authorization signature from the user and an execution signature from a service provider, wherein the bilateral cryptographic receipt is independently verifiable by a third party without access to session keys.

In another aspect, a non-transitory computer-readable storage medium having instructions stored therein that, when executed by a hardware processor, causes the hardware processor to perform method steps for securing authentication of users, as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with a computer-implemented system for securing authentication of users, in accordance with an embodiment of the present disclosure;

FIG. 2A is a detailed view of the computer-implemented system, such as those shown in FIG. 1, in accordance with another embodiment of the present disclosure;

FIG. 2B is a detailed view of the computer-implemented system, such as those shown in FIG. 1, in accordance with another embodiment of the present disclosure;

FIG. 2C is an interface view depicting a cryptographic bridge between the users and AI agents, in accordance with another embodiment of the present disclosure;

FIG. 3 is a flow chart illustrating a registration/signup process for the authentication between the one or more user devices and the one or more authentication servers, in accordance with an embodiment of the present disclosure;

FIG. 4 is a flow chart illustrating a logging in process for the authentication between the one or more user devices and the one or more authentication servers, in accordance with an embodiment of the present disclosure;

FIG. 5 is a flow chart illustrating a registration/signup process for the authentication between the one or more user devices and the one or more authentication servers based on one or more device fingerprints, in accordance with an embodiment of the present disclosure;

FIG. 6 is a flow chart illustrating a logging in process for the authentication between the one or more user devices and the one or more authentication servers based on the one or more device fingerprints, in accordance with an embodiment of the present disclosure;

FIG. 7A-7C is a process flow of a user registration process for the authentication between the one or more user devices and the one or more authentication servers, through one or more applications, in accordance with an embodiment of the present disclosure;

FIG. 8A-8C is a process flow of the user registration process for the authentication between the one or more user devices and the one or more authentication servers, through one or more applications, in accordance with an embodiment of the present disclosure;

FIG. 9A-9C is a process flow of the user registration process for the authentication between the one or more user devices and the one or more authentication servers, through one or more devices, in accordance with an embodiment of the present disclosure;

FIG. 10A-10C is a process flow of the user registration process for the authentication between the one or more user devices and the one or more authentication servers, through one or more registered user devices, in accordance with an embodiment of the present disclosure;

FIG. 11 is a schematic representation of a pre-computation server for generating one or more private key variables and one or more encryption keys, in accordance with an embodiment of the present disclosure;

FIG. 12 is a schematic representation of the pre-computation server for pre-computing one or more unique user identities, in accordance with an embodiment of the present disclosure;

FIG. 13 is a schematic representation of one or more vaults in a cloud to store one or more user credentials, in accordance with an embodiment of the present disclosure;

FIG. 14 is a schematic representation of generation of a private key based on biometric information, in accordance with an embodiment of the present disclosure;

FIG. 15 is a schematic representation of a hash lookup table having delta values based on range of values associated with the biometric information, such as those shown in FIG. 14, in accordance with an embodiment of the present disclosure;

FIG. 16A-16B is a schematic representation depicting the login process for the authentication between the one or more user devices and the one or more authentication servers, in accordance with an embodiment of the present disclosure;

FIG. 17 is a schematic representation depicting the registration process for the authentication between the one or more user devices and the one or more authentication servers, in accordance with an embodiment of the present disclosure;

FIG. 18A-18B is a schematic representation depicting the registration process for the authentication between the one or more user devices and the one or more authentication servers, based on one or more passwords used to encrypt extended unique identifier and one or more keys, in accordance with an embodiment of the present disclosure;

FIG. 19 is a schematic representation depicting a vault synchronization service for the authentication between the one or more user devices and the one or more authentication servers, in accordance with an embodiment of the present disclosure;

FIG. 20 is a schematic representation depicting the login process for the authentication between the one or more user devices and the one or more authentication servers, based on existing information, in accordance with an embodiment of the present disclosure;

FIG. 21 is a schematic representation depicting a conversion of username and password based authentication to zero knowledge authentication based on public private key cryptography, in accordance with an embodiment of the present disclosure;

FIG. 22 is a schematic representation depicting a secure vault storing the private keys for the authentication, in accordance with an embodiment of the present disclosure;

FIG. 23 is a schematic representation depicting the authentication between the one or more user devices and the one or more authentication servers based on one or more private key variables generated from the one or more servers, in accordance with an embodiment of the present disclosure;

FIG. 24 is a schematic representation depicting the authentication between the one or more user devices and the one or more authentication servers based on the one or more private key variables with one or more encryption keys, in accordance with an embodiment of the present disclosure;

FIG. 25 is a schematic representation depicting the authentication between the one or more user devices and the one or more authentication servers based on one or more vault keys, in accordance with an embodiment of the present disclosure;

FIG. 26A-26B is a schematic representation depicting the authentication between the one or more user devices and the one or more authentication servers using one or more salts, in accordance with an embodiment of the present disclosure;

FIG. 27A-27B is a schematic representation depicting the login process for the authentication between the one or more user devices and the one or more authentication servers, based hash square functions, in accordance with an embodiment of the present disclosure;

FIG. 28A-28B is an exemplary process depicting an implementation for authentication between the one or more user devices and the one or more authentication servers, in accordance with an embodiment of the present disclosure; and

FIG. 29A-29B is a flow chart illustrating a computer-implemented method for securing authentication of users, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises… a'' does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

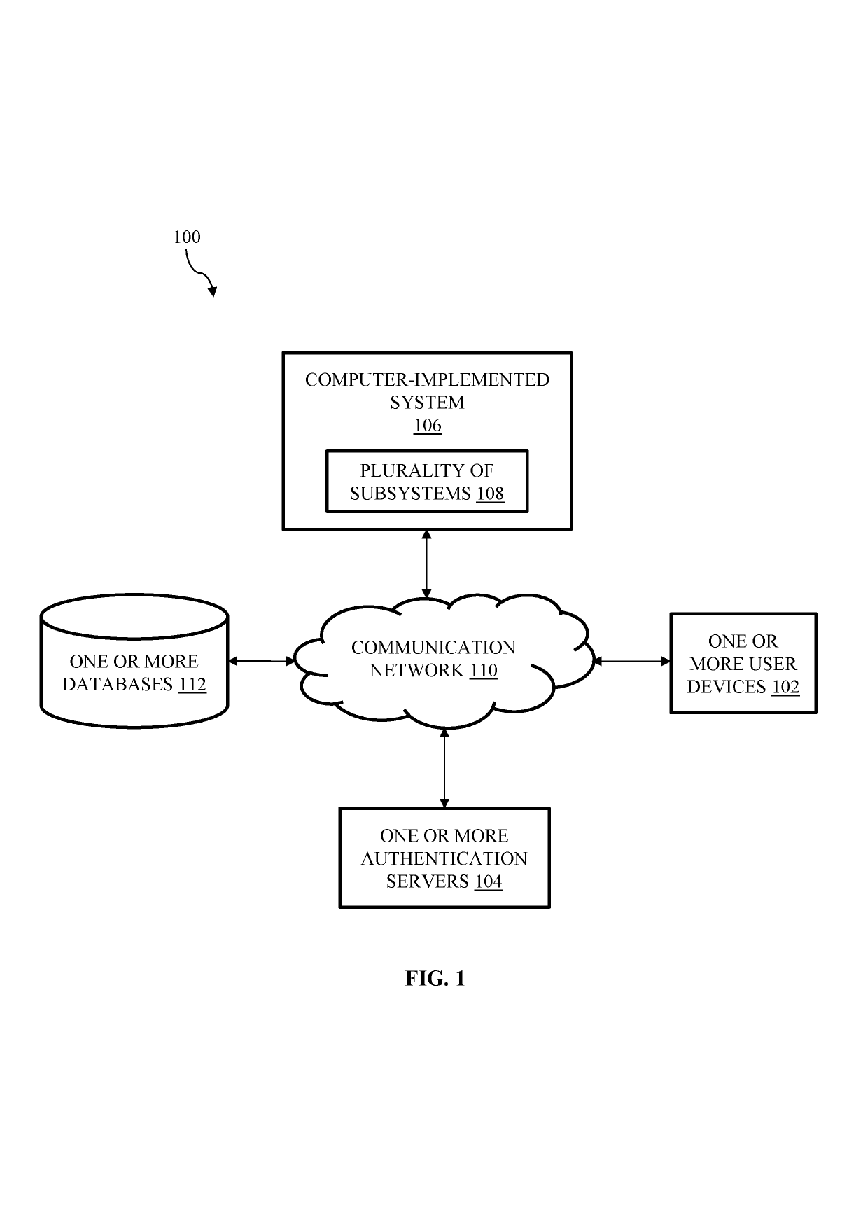

Referring now to the drawings, and more particularly to FIG. 1 through FIG. 29B, where similar reference characters denote corresponding features consistently throughout the figures, there are shown preferred embodiments and these embodiments are described in the context of the following exemplary system and/or method.

FIG. 1 is a block diagram illustrating a computing environment 100 with a computer-implemented system 106 for securing authentication of users, in accordance with an embodiment of the present disclosure. According to FIG. 1, the computing environment 100 includes one or more user devices 102 that are communicatively coupled to one or more authentication servers 104 through a network 110.

In one aspect, the present invention with the computer-implemented system 106 is configured to manage an authentication between the one or more user devices 102 and the one or more authentication servers 104 based on generation of the one or more private keys using the private-public key cryptography. The one or more user devices 102 are initially configured to obtain one or more user credentials associated with one or more users by the one or more user devices 102. In an embodiment, the one or more user credentials may include at least one of: one or more user identities (ID) and one or more public keys, associated with the one or more users.

The one or more user devices 102 are further configured to retrieve information associated with one or more device fingerprints corresponding to the one or more user devices 102. In an embodiment, retrieving the information associated with one or more device fingerprints may include regenerating one or more indices including at least one of: first index and second index, associated with the one or more device fingerprints.

The one or more user devices 102 are further configured to generate one or more cipher messages by at least one of: creating one or more random numbers and encrypting the one or more random numbers with one or more keys derived from at least one of: the first index and the second index. The one or more user devices 102 are further configured to transmit at least one of: the one or more user identities, the first index, the second index, and the one or more cipher messages, to the one or more authentication servers 104.

The one or more authentication servers 104 are configured to determine whether the one or more user identities are matched with first index associated with the one or more device fingerprints. The one or more authentication servers 104 are further configured to retrieve at least one of: one or more public keys and the one or more private key variables, from the one or more user devices 102.

The one or more authentication servers 104 are configured to decode the one or more cipher messages received from the one or more user devices 102. The one or more authentication servers 104 are configured to generate the one or more authentication based questions based on at least one of: the decoded one or more cipher messages and the one or more random numbers. The one or more authentication servers 104 are configured to transmit the one or more private key variables and the one or more authentication based questions, to the one or more user devices 102.

The one or more user devices 102 are configured to dynamically regenerate the one or more private keys from one or more private key variables using at least one of: no password and the one or more passwords. The one or more user devices 102 are further configured to generate one or more authentication responses by decoding one or more authentication based questions obtained from the one or more authentication servers 104, using at least one of: the one or more cipher messages and the one or more private keys. The one or more user devices 102 are further configured to transmit the one or more authentication responses to the one or more authentication servers 104 for adapting the one or more authentication servers 104 to authenticate the one or more user devices 102.

Upon receiving the one or more authentication responses from the one or more users devices 102, the one or more authentication servers 104 are configured to validate the one or more authentication responses received from the one or more user devices 102. The one or more authentication servers 104 are further configured to determine whether the one or more authentication responses received from the one or more user devices 102 are matched with the one or more authentication based questions. The one or more authentication servers 104 are further configured to authenticate the one or more user devices 102 upon matching of the one or more authentication responses received from the one or more user devices 102 with the one or more authentication based questions.

In another aspect, the present invention is configured to secure authentication of users. The computer-implemented system 106 is configured to register a user identity by verifying a government-issued identity document. The registration of the user identity generates a master cryptographic key stored in a hardware security module of the user device 102. No secret data is transmitted after the registration of the user identity is completed. The computer-implemented system 106 is further configured to authenticate a user for every subsequent login, through a zero-knowledge proof ceremony in which a biometric check is performed within the hardware security module of the user device 102.

The computer-implemented system 106 is further configured to monitor an enrolled biometric set of the user device 102. The computer-implemented system 106 is further configured to upon detection of a newly added biometric entry after the registration of the user identity, initiate cryptographic zeroization of credential material stored on the user device 102. The computer-implemented system 106 is further configured to, upon successful authentication, derive cryptographic keys assigned to each artificial intelligence (AI) agent from a master cryptographic key using a deterministic key derivation function. Each cryptographic key assigned to each AI agent is cryptographically isolated, whereby access to credentials of one AI agent provide no information regarding credentials of other AI agents.

The computer-implemented system 106 is further configured to, for each action requested by an AI agent, generate a single-use authorization token encoding a permitted tool or service the AI agent is permitted to call, an authorized data scope, action constraints, and a trust tier. The single-use authorization token is atomically consumed upon first use, rendering the single-use authorization token unavailable for replay.

The computer-implemented system 106 is further configured to for AI agent actions above a configurable risk threshold, require a cryptographic signature from a second enrolled device that has independently completed biometric authentication. A notification tap, video confirmation, or voice confirmation is insufficient to satisfy the requiring. The computer-implemented system 106 is further configured to, upon execution of each AI agent action, generate a bilateral cryptographic receipt comprising an authorization signature from the user and an execution signature from a service provider. The bilateral cryptographic receipt is independently verifiable by a third party without access to session keys.

In an embodiment, The computer-implemented system 106 may be hosted on a central server including at least one of: a cloud server or a remote server. In an embodiment, the computer-implemented system 106 may include at least one of: a user device, a server computer, a server computer over the network 110, a cloud-based computing system, a cloud-based computing system over the network 110, a distributed computing system, and the like. Further, the network 110 may be at least one of: a Wireless-Fidelity (Wi-Fi) connection, a hotspot connection, a Bluetooth connection, a local area network (LAN), a wide area network (WAN), any other wireless network, and the like. In an embodiment, the one or more user devices 102 may include at least one of: a laptop computer, a desktop computer, a tablet computer, a Smartphone, a wearable device, a Smart watch, and the like.

Further, the computing environment 100 includes one or more databases 112 communicatively coupled to the computer-implemented system 106 through the network 110. In an embodiment, the one or more databases 112 include at least one of: one or more relational databases, one or more object-oriented databases, one or more data warehouses, one or more cloud-based databases, and the like. Furthermore, the one or more user devices 102 may include at least one of: a local browser, a mobile application, and the like.

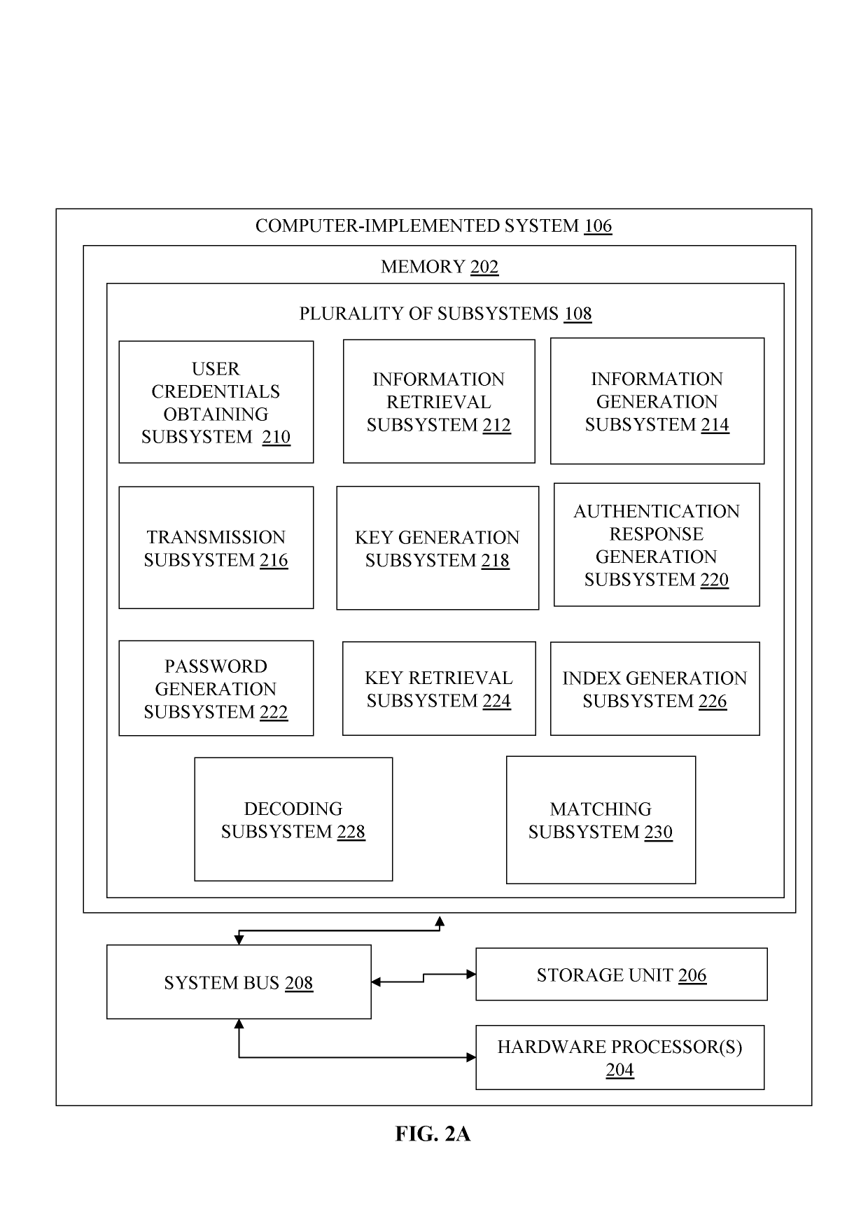

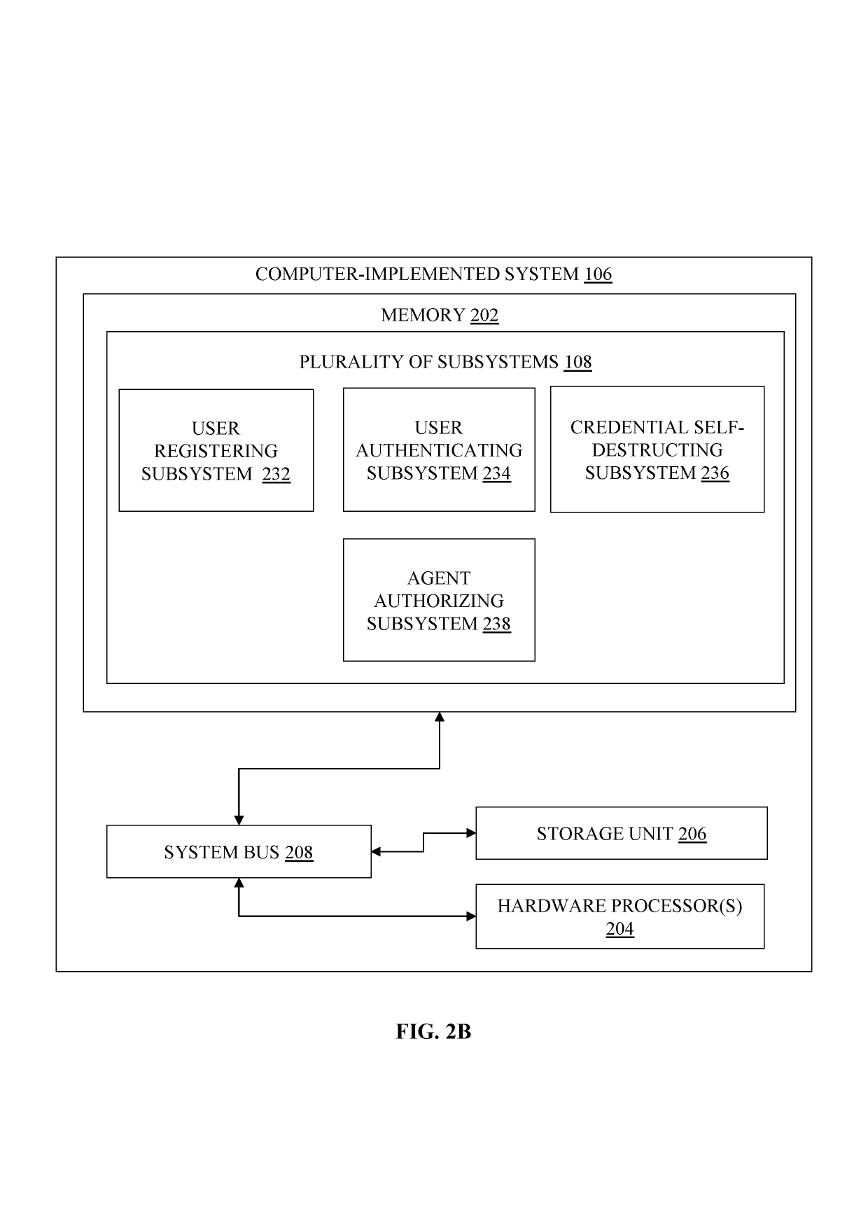

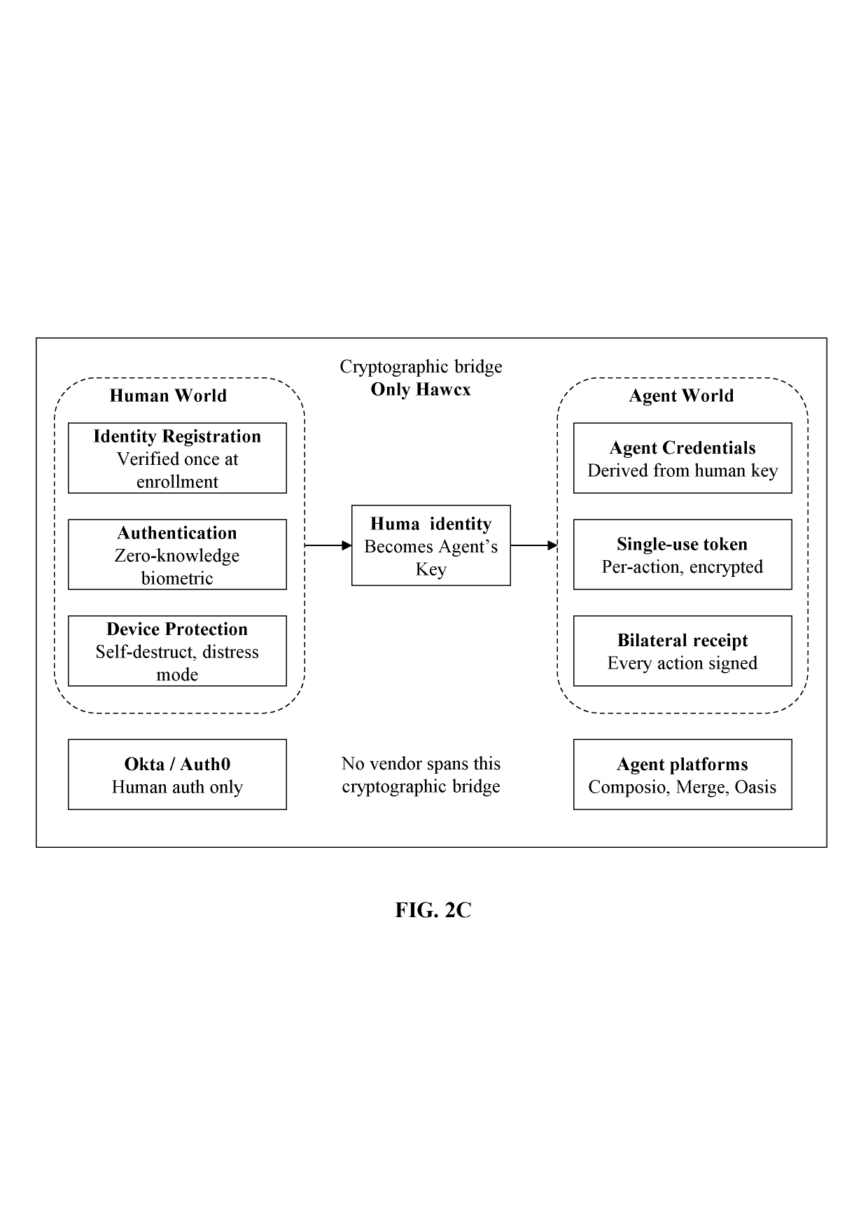

Furthermore, the one or more users may use a web application through the local browser, the mobile application to authenticate with the one or more authentication servers 106. In an embodiment of the present disclosure, the computer-implemented system 106 includes a plurality of subsystems 108. Details on the plurality of subsystems 108 have been elaborated in subsequent paragraphs of the present description with reference to FIG. 2A and 2B.

FIG. 2A is a detailed view of the computer-implemented system 106, such as those shown in FIG. 1, in accordance with another embodiment of the present disclosure. The computer-implemented system 106 includes a memory 202, one or more hardware processors 204, and a storage unit 206. The memory 202, the one or more hardware processors 204, and the storage unit 206 are communicatively coupled through a system bus 208 or any similar mechanism. The memory 202 includes the plurality of subsystems 108 in the form of programmable instructions executable by the one or more hardware processors 204.

The plurality of subsystems 108 includes a user credentials obtaining subsystem 210, an information retrieval subsystem 212, an information generation subsystem 214, a transmission subsystem 216, a key generation subsystem 218, an authentication response generation subsystem 220, a password generation subsystem 222, a key retrieval subsystem 224, an index generation subsystem 226, a decoding subsystem 228, and a matching subsystem 230.

The plurality of subsystems 108, as shown in FIG. 2B, further includes a user registering subsystem 232, a user authenticating subsystem 234, a credential self-destructing subsystem 236, and an agent authorizing subsystem 238.

The one or more hardware processors 204, as used herein, means any type of computational circuit, including, but not limited to, at least one of: a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, including at least one of: generic or programmable logic devices or arrays, application specific integrated circuits, single-chip computers, and the like.

The memory 202 may be non-transitory volatile memory and non-volatile memory. The memory 202 may be coupled for communication with the one or more hardware processors 204, being a computer-readable storage medium. The one or more hardware processors 204 may execute machine-readable instructions and/or source code stored in the memory 202. A variety of machine-readable instructions may be stored in and accessed from the memory 202. The memory 202 may include any suitable elements for storing data and machine-readable instructions, including at least one of: read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes the plurality of subsystems 108 stored in the form of machine-readable instructions on any of the above-mentioned storage media and may be in communication with and executed by the one or more hardware processors 204.

The storage unit 206 may be a cloud storage, a Structured Query Language (SQL) data store, a noSQL database or a location on a file system directly accessible by the plurality of subsystems 108.

The plurality of subsystems 108 includes the user credentials obtaining subsystem 210 that is communicatively connected to the one or more hardware processors 204. The user credentials obtaining subsystem 210 is configured to obtain the one or more user credentials associated with the one or more users. In an embodiment, the one or more user credentials may include at least one of: the one or more user identities (ID) and the one or more public keys, associated with the one or more users.

The plurality of subsystems 108 further includes the information retrieval subsystem 212 that is communicatively connected to the one or more hardware processors 204. The information retrieval subsystem 212 is configured to retrieve the information associated with the one or more device fingerprints corresponding to the one or more user devices 102. In an embodiment, retrieving the information associated with the one or more device fingerprints may include regenerating the one or more indices including at least one of: the first index and the second index, associated with the one or more device fingerprints.

The plurality of subsystems 108 further includes the information generation subsystem 214 that is communicatively connected to the one or more hardware processors 204. The information generation subsystem 214 is configured to generate the one or more cipher messages by at least one of: creating the one or more random numbers and encrypting the one or more random numbers with the one or more keys derived from at least one of: the first index and the second index.

The plurality of subsystems 108 further includes the transmission subsystem 216 that is communicatively connected to the one or more hardware processors 204. The transmission subsystem 216 is configured to transmit at least one of: the one or more user identities, the first index, the second index, and the one or more cipher messages, to the one or more authentication servers 104.

The one or more authentication servers 104 are configured to determine whether the one or more user identities are matched with first index associated with the one or more device fingerprints. The one or more authentication servers 104 are further configured to retrieve at least one of: one or more public keys and the one or more private key variables, from the one or more user devices 102.

The one or more authentication servers 104 are configured to decode the one or more cipher messages received from the one or more user devices 102. The one or more authentication servers 104 are configured to generate the one or more authentication based questions based on at least one of: the decoded one or more cipher messages and the one or more random numbers. The one or more authentication servers 104 are configured to transmit the one or more private key variables and the one or more authentication based questions, to the one or more user devices 102.

The plurality of subsystems 108 further includes the key generation subsystem 218 that is communicatively connected to the one or more hardware processors 204. The key generation subsystem 218 is configured to dynamically regenerate the one or more private keys from one or more private key variables using at least one of: no password and the one or more passwords.

The plurality of subsystems 108 further includes the authentication response generation subsystem 220 that is communicatively connected to the one or more hardware processors 204. The authentication response generation subsystem 220 is configured to generate the one or more authentication responses by decoding the one or more authentication based questions obtained from the one or more authentication servers 104, using at least one of: the one or more cipher messages and the one or more private keys.

The transmission subsystem 216 is further configured to transmit the one or more authentication responses to the one or more authentication servers 104 for adapting the one or more authentication servers 104 to authenticate the one or more user devices 102.

In an embodiment, prior to a logging in process, a registration process (Method 1) needs to be performed for authenticating the one or more user devices 102 with the one or more authentication servers 104. During the registration process, the one or more user devices 102 are configured to obtain the one or more user credentials including at least one of: the one or more user identities and the one or more public keys from the one or more users associated with the one or more user devices 102. The one or more user devices 102 are configured to transmit the one or more user credentials to the one or more authentication servers 104.

The one or more authentication servers 104 are configured to determine whether the user identity exists or not. The one or more authentication servers 104 are configured to send a response to the existence of the user identity to the one or more user devices 102. In one embodiment, the one or more user devices 102 are configured to generate one or more prime numbers (P and Q) having 1024 bit length. The one or more user devices 102 may compute the one or more public keys (n) based on the one or more prime numbers (i.e., n = P*Q). The one or more user devices 102 are further configured to generate one or more random salts including at least one of: first salt and second salt. The one or more user devices 102 are further configured to generate the one or more device fingerprints associated with the one or more user devices 102.

The one or more user devices 102 are further configured to generate the one or more private key variables (PKV) based on at least one of: (a) a hash function (H1) of a combination of a first user identity, the first salt and the one or more passwords/passcodes, (b) a hash function (H2) of a combination of a second user identity, the second salt and the one or more passwords/passcodes, (c) one or more delts values (Δ) including at least one of: a first delta value (Δ1) and a second delta value (Δ2). In an embodiment, the one or more private key variables (PKV) are generated/computed based on the first delta value (Δ1), the second delta value (Δ2), the first salt, and the second salt. In another embodiment, the first delta value (Δ1) is a difference between the prime number (P) and the hash function (H1). In another embodiment, the second delta value (Δ2) is a difference between the prime number (Q) and the hash function (H2). The one or more user devices 102 are further configured to generate one or more hash indices (i.e., a first index = H(fingerprint) and a second index = H(tnirpregnif)) from the one or more device fingerprints associated with the one or more user devices 102.

The one or more user devices 102 are further configured to transmit the one or more user identities, the first index, the second index, the one or more private key variables, and the one or more public keys (n), to the one or more authentication servers 104. The one or more authentication servers 104 are configured to store the user information. In an embodiment, the one or more authentication servers 104 may store the user information in two different dissociated databases. In an embodiment, in an event of the database being compromised, there is no information available to combine all the data associated with the user information. The one or more authentication servers 104 are configured to determine/verify whether the one or more user credentials are stored. Further, the one or more user devices 102 are further configured to store the one or more device fingerprints in a secure storage of the one or more user devices 102.

In an alternate embodiment (Method 2), the computer-implemented system 106 is configured to provide passwordless experience. In this scenario, the one or more passwords are not used during the private key regeneration step. The one or more private keys are generated in the one or more user devices 102 during registration and login processes. Further, a unique device fingerprint is generated and the device fingerprint is required for the authentication, providing additional level of security.

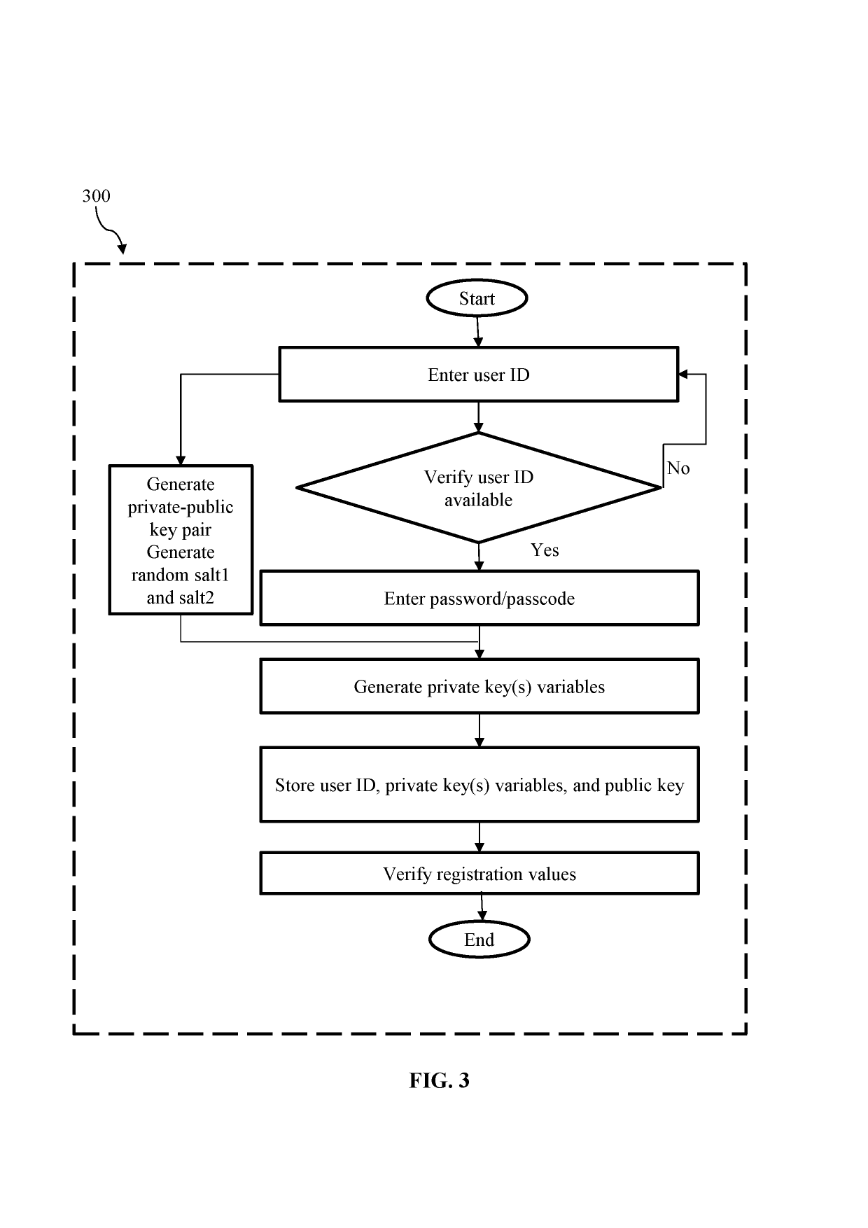

In order to perform the registration process (as shown in FIG. 3), the one or more user devices 102 are configured to obtain the one or more user identities from the one or more users associated with the one or more user devices 102. The one or more authentication servers 104 are configured to determine whether the user identity exists or not. The one or more authentication servers 104 are configured to send a response to the existence of the user identity to the one or more user devices 102. In one embodiment, the one or more user devices 102 are configured to generate one or more prime numbers (P and Q) having 1024 bit length. The one or more user devices 102 may compute the one or more public keys (n) based on the one or more prime numbers (i.e., n = P*Q). The one or more user devices 102 are further configured to generate one or more random salts including at least one of: the first salt and the second salt. The one or more user devices 102 are further configured to generate the one or more device fingerprints associated with the one or more user devices 102.

The one or more user devices 102 are further configured to generate/compute the one or more private key variables (PKV) based on at least one of: (a) a hash function (H1) of a combination of a first user identity, the first salt and the one or more device fingerprints, (b) a hash function (H2) of a combination of a second user identity, the second salt and the one or more device fingerprints, (c) one or more delts values (Δ) including at least one of: a first delta value (Δ1) and a second delta value (Δ2). In an embodiment, the one or more private key variables (PKV) are generated/computed based on the first delta value (Δ1), the second delta value (Δ2), the first salt, and the second salt. In another embodiment, the first delta value (Δ1) is a difference between the prime number (P) and the hash function (H1). In another embodiment, the second delta value (Δ2) is a difference between the prime number (Q) and the hash function (H2). The one or more user devices 102 are further configured to generate the one or more hash indices (i.e., the first index = H(fingerprint) and the second index = H(tnirpregnif)) from the one or more device fingerprints associated with the one or more user devices 102.

The one or more user devices 102 are further configured to transmit the one or more user identities, the first index, the second index, the one or more private key variables, and the one or more public keys (n), to the one or more authentication servers 104. The one or more authentication servers 104 are configured to store the user information. In an embodiment, the one or more authentication servers 104 may store the user information in two different dissociated databases. In an embodiment, in an event of the database being compromised, there is no information available to combine all the data associated with the user information. The one or more authentication servers 104 are configured to determine/verify whether the one or more user credentials are stored. Further, the one or more user devices 102 are further configured to store the one or more device fingerprints in the secure storage of the one or more user devices 102.

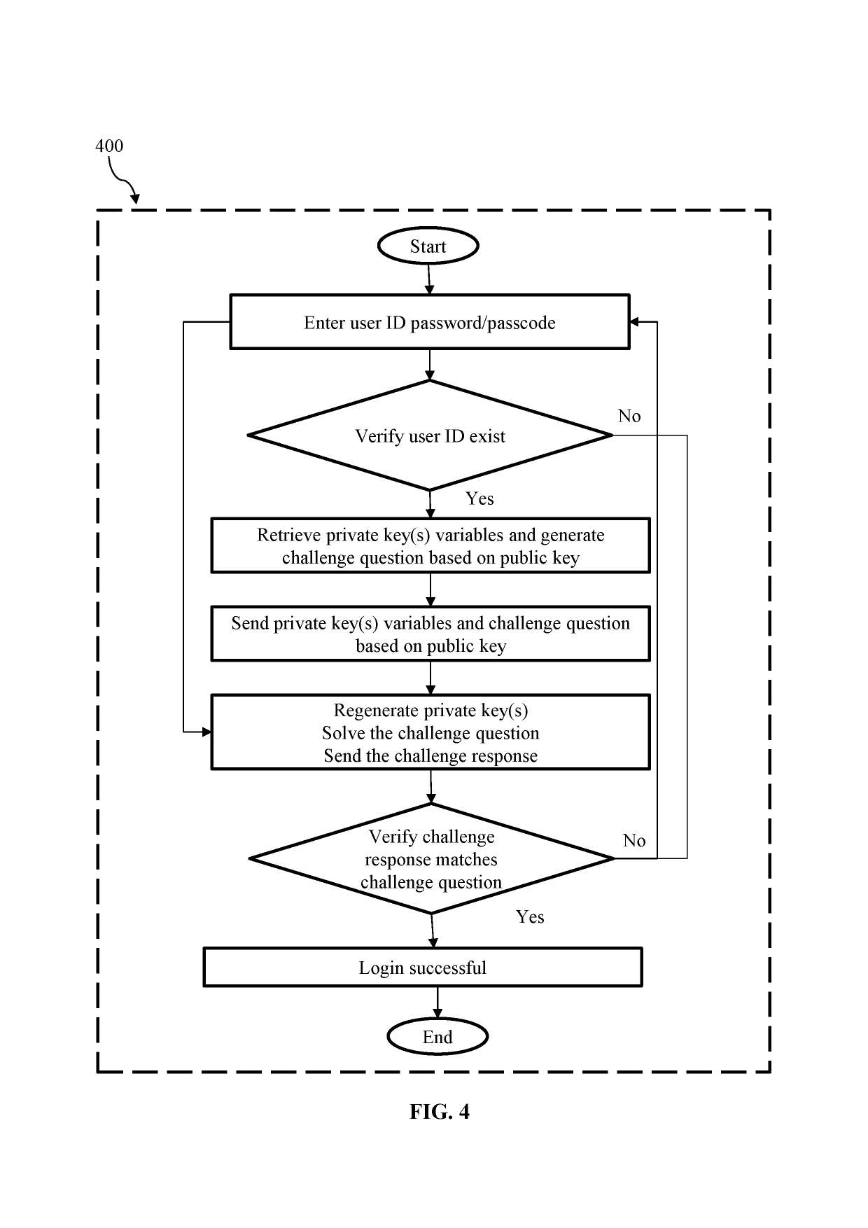

In order to perform the logging in process (as shown in FIG. 4), the user credentials obtaining subsystem 210 of the one or more user devices 102 is configured to obtain the one or more user identities associated with the one or more users. The information retrieval subsystem 212 of the one or more user devices 102 is configured to retrieve the information associated with the one or more device fingerprints corresponding to the one or more user devices 102. In an embodiment, retrieving the information associated with the one or more device fingerprints may include regenerating the one or more indices including at least one of: the first index and the second index, associated with the one or more device fingerprints.

The information generation subsystem 214 of the one or more user devices 102 is configured to generate the one or more cipher messages by at least one of: creating the one or more random numbers and encrypting the one or more random numbers with the one or more keys derived from at least one of: the first index and the second index. The transmission subsystem 216 of the one or more user devices 102 is configured to transmit at least one of: the one or more user identities, the first index, the second index, and the one or more cipher messages, to the one or more authentication servers 104.

The one or more authentication servers 104 are configured to determine whether the one or more user identities are matched with first index associated with the one or more device fingerprints. The one or more authentication servers 104 are further configured to retrieve at least one of: one or more public keys and the one or more private key variables, from the one or more user devices 102. The one or more authentication servers 104 are configured to decode the one or more cipher messages received from the one or more user devices 102. The one or more authentication servers 104 are configured to generate the one or more authentication based questions based on at least one of: the decoded one or more cipher messages and the one or more random numbers. The one or more authentication servers 104 are configured to transmit the one or more private key variables and the one or more authentication based questions, to the one or more user devices 102.

The key generation subsystem 218 is configured to dynamically generate the one or more private keys from one or more private key variables using the one or more passwords or passcodes. The authentication response generation subsystem 220 is configured to generate the one or more authentication responses by decoding the one or more authentication based questions obtained from the one or more authentication servers 104, using at least one of: the one or more cipher messages and the one or more private keys. The transmission subsystem 216 is further configured to transmit the one or more authentication responses to the one or more authentication servers 104 for adapting the one or more authentication servers 104 to authenticate the one or more user devices 102.

The one or more authentication servers 104 are further configured to determine whether the one or more authentication responses match the one or more authentication based questions. If the one or more authentication responses match the one or more authentication based questions, then the one or more authentication servers 104 may authenticate the one or more user devices 102. If not, the one or more user devices 102 are denied to authenticate with the one or more authentication servers 104.

In another alternate embodiment (Method 3), the computer-implemented system 106 is configured to provide a username and password authentication experience for the one or more users and the authentication is based on a zero-knowledge authentication using the private-public key cryptography. In this scenario, neither the one or more passwords nor the one or more private keys is transmitted to the one or more authentication servers 104. The one or more private keys regeneration variable hints are locally stored in the one or more user devices 102 during registration and login processes. Further, a unique device fingerprint is generated and the device fingerprint is required for the authentication, providing additional level of security.

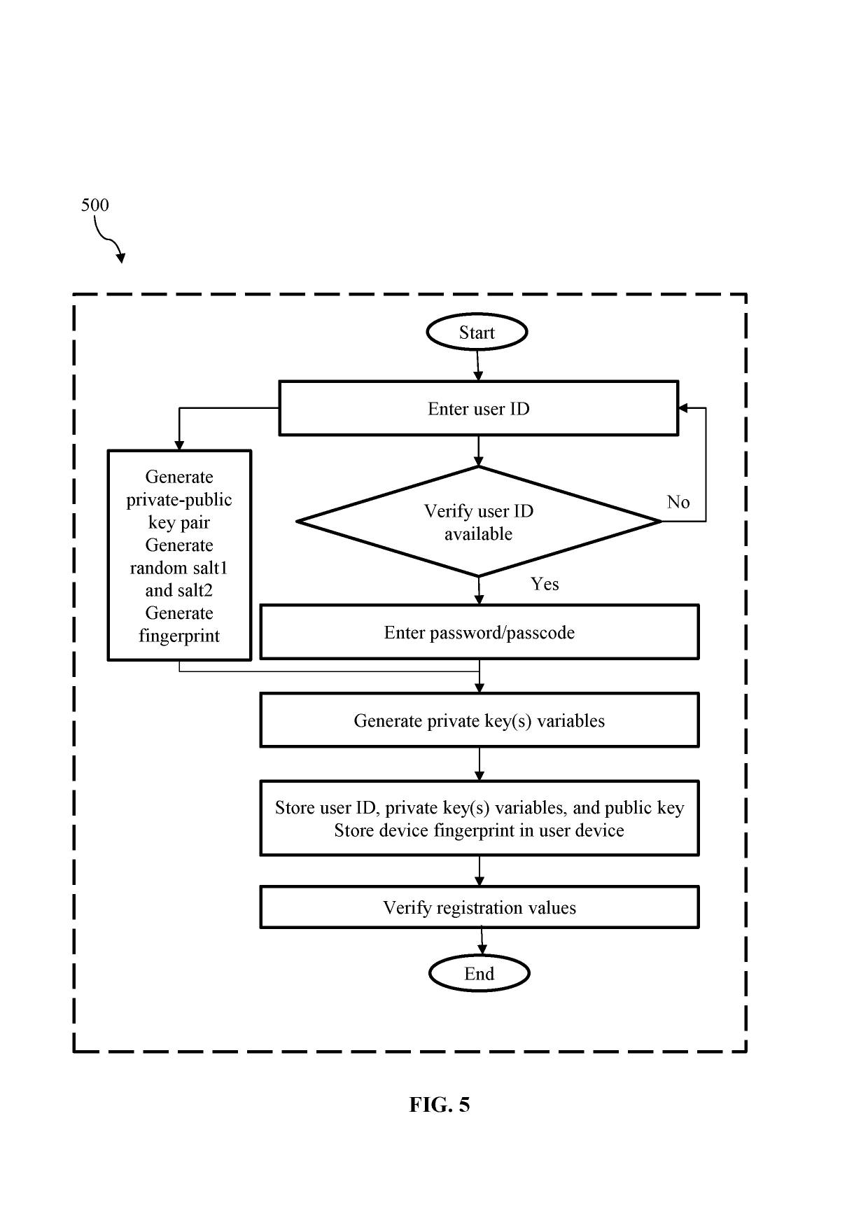

In order to perform the registration process (as shown in FIG. 5), the one or more user devices 102 are configured to obtain the one or more user identities and public keys from the one or more users associated with the one or more user devices 102. The one or more authentication servers 104 are configured to determine whether the user identity exists or not. The one or more authentication servers 104 are configured to send a response to the existence of the user identity to the one or more user devices 102. In one embodiment, the one or more user devices 102 are configured to generate one or more prime numbers (P and Q) having 1024 bit length. The one or more user devices 102 may compute the one or more public keys (n) based on the one or more prime numbers (i.e., n = P*Q). The one or more user devices 102 are further configured to generate one or more random salts including at least one of: the first salt and the second salt. The one or more user devices 102 are further configured to generate one or more random numbers (Y).

The one or more user devices 102 are further configured to generate one or more strong passwords. In an embodiment, the one or more strong passwords are generated based on a hash function of K values. The K values represents a combination of a hash function of the one or more passwords (i.e., X), a hash function of the user identity (i.e., Z), and the one or more random numbers (Y). The one or more user devices 102 are further configured to generate the one or more device fingerprints associated with the one or more user devices 102.

The one or more user devices 102 are further configured to generate/compute the one or more private key variables (PKV) based on at least one of: (a) a hash function (H1) of a combination of a first user identity, the first salt and the one or more strong passwords, (b) a hash function (H2) of a combination of a second user identity, the second salt and the one or more strong passwords, (c) one or more delts values (Δ) including at least one of: a first delta value (Δ1) and a second delta value (Δ2). In an embodiment, the one or more private key variables (PKV) are generated/computed based on the first delta value (Δ1), the second delta value (Δ2), the first salt, and the second salt. In another embodiment, the first delta value (Δ1) is a difference between the prime number (P) and the hash function (H1). In another embodiment, the second delta value (Δ2) is a difference between the prime number (Q) and the hash function (H2). The one or more user devices 102 are further configured to generate the one or more hash indices (i.e., the first index = H(fingerprint) and the second index = H(tnirpregnif)) from the one or more device fingerprints associated with the one or more user devices 102.

The one or more user devices 102 are further configured to transmit the one or more user identities, the first index, the second index, the one or more private key variables, the one or more public keys (n), and the one or more random numbers (Y), to the one or more authentication servers 104. The one or more authentication servers 104 are configured to store the user information. In an embodiment, the one or more authentication servers 104 may store the user information in two different dissociated databases. In an embodiment, in an event of the database being compromised, there is no information available to combine all the data associated with the user information. The one or more authentication servers 104 are configured to determine/verify whether the one or more user credentials are stored. Further, the one or more user devices 102 are further configured to store the one or more device fingerprints in the secure storage of the one or more user devices 102.

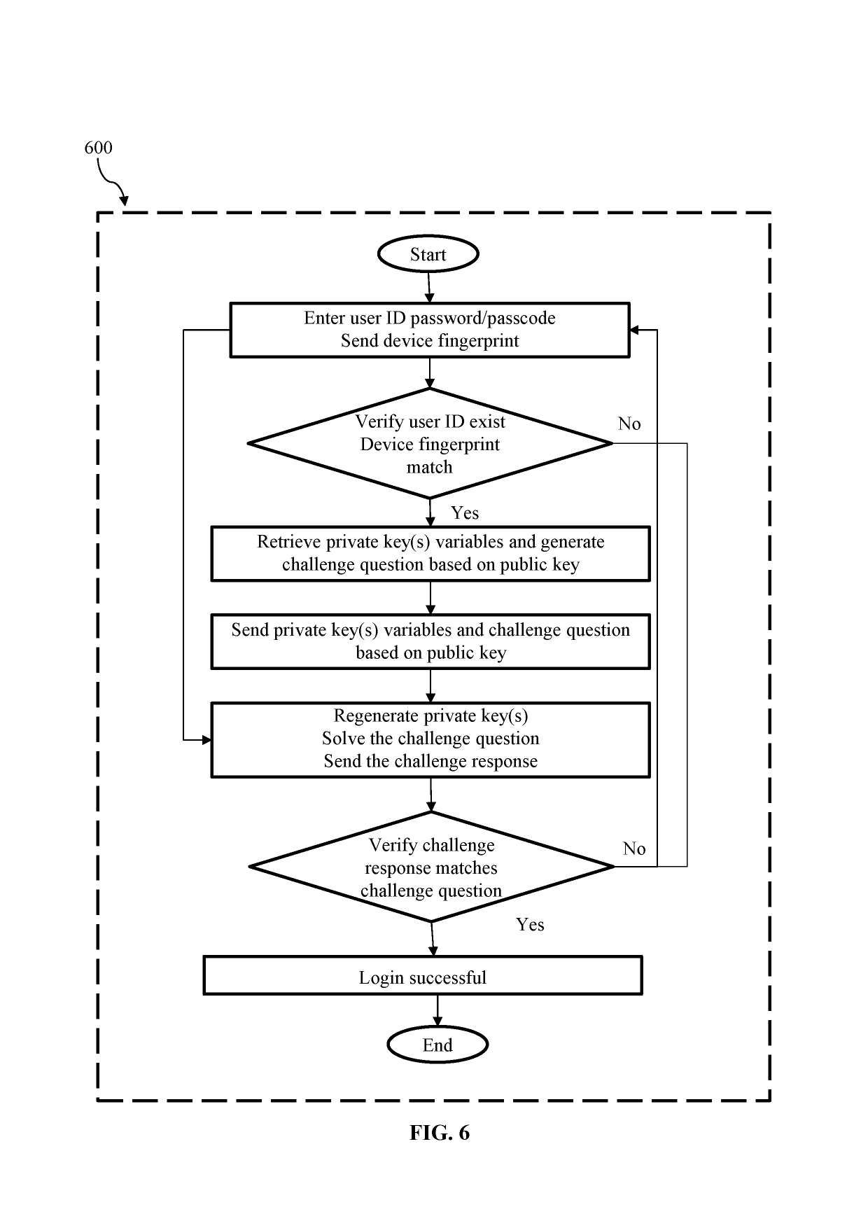

In order to perform the logging in process (as shown in FIG. 6), the user credentials obtaining subsystem 210 of the one or more user devices 102 is configured to obtain the one or more user identities and the one or more public keys, associated with the one or more users. The information retrieval subsystem 212 of the one or more user devices 102 is configured to retrieve the information associated with the one or more device fingerprints corresponding to the one or more user devices 102. In an embodiment, retrieving the information associated with the one or more device fingerprints may include regenerating the one or more indices including at least one of: the first index and the second index, associated with the one or more device fingerprints.

The information generation subsystem 214 of the one or more user devices 102 is configured to generate the one or more cipher messages by at least one of: creating the one or more random numbers and encrypting the one or more random numbers with the one or more keys derived from at least one of: the first index and the second index. The transmission subsystem 216 of the one or more user devices 102 is configured to transmit at least one of: the one or more user identities, the first index, the second index, and the one or more cipher messages, to the one or more authentication servers 104.

The one or more authentication servers 104 are configured to determine whether the one or more user identities are matched with first index associated with the one or more device fingerprints. The one or more authentication servers 104 are further configured to retrieve at least one of: the one or more random numbers (Y), the one or more public keys and the one or more private key variables, from the one or more user devices 102. The one or more authentication servers 104 are configured to decode the one or more cipher messages received from the one or more user devices 102. The one or more authentication servers 104 are configured to generate the one or more authentication based questions based on at least one of: the decoded one or more cipher messages and the one or more random numbers. The one or more authentication servers 104 are configured to transmit the one or more private key variables, the one or more random numbers (Y), and the one or more authentication based questions, to the one or more user devices 102.

The password generation subsystem 222 is configured to regenerate the one or more strong passwords/passcodes using the one or more user identities, passwords/passcodes, and the one or more random numbers (Y). The key generation subsystem 218 is configured to regenerate the one or more private keys using the one or more private key variables and the one or more strong passwords. The authentication response generation subsystem 220 is configured to generate the one or more authentication responses by decoding the one or more authentication based questions obtained from the one or more authentication servers 104, using at least one of: the one or more cipher messages and the one or more private keys. The transmission subsystem 216 is further configured to transmit the one or more authentication responses to the one or more authentication servers 104 for adapting the one or more authentication servers 104 to authenticate the one or more user devices 102.

The one or more authentication servers 104 are further configured to determine whether the one or more authentication responses match the one or more authentication based questions. If the one or more authentication responses match the one or more authentication based questions, then the one or more authentication servers 104 may authenticate the one or more user devices 102. If not, the one or more user devices 102 are denied to authenticate with the one or more authentication servers 104.

In yet alternate embodiment (Method 4), the computer-implemented system 106 is configured to provide passwordless experience.. The one or more private keys are generated in the one or more user devices 102 during registration and login processes. Further, a unique device fingerprint is generated and the device fingerprint is required for the authentication, providing additional level of security.

In order to perform the registration process, the one or more user devices 102 are configured to obtain the one or more user identities from the one or more users associated with the one or more user devices 102. The one or more authentication servers 104 are configured to determine whether the user identity exists or not. The one or more authentication servers 104 are configured to send a response to the existence of the user identity to the one or more user devices 102. In one embodiment, the one or more user devices 102 are configured to generate the one or more prime numbers (P and Q) having 1024 bit length. The one or more user devices 102 may compute the one or more public keys (n) based on the one or more prime numbers (i.e., n = P*Q). The one or more user devices 102 are further configured to generate one or more random salts including at least one of: the first salt and the second salt. The one or more user devices 102 are further configured to generate the one or more device fingerprints associated with the one or more user devices 102. The one or more user devices 102 are further configured to generate the one or more random numbers (Y).

The one or more user devices 102 are further configured to generate the one or more strong passwords. In an embodiment, the one or more strong passwords are generated based on a hash function of K values. The K values represents a combination of a hash function of the one or more passwords (i.e., X), a hash function of the user identity (i.e., Z), and the one or more random numbers (Y). The one or more user devices 102 are further configured to generate the one or more device fingerprints associated with the one or more user devices 102.

The one or more user devices 102 are further configured to generate/compute the one or more private key variables (PKV) based on at least one of: (a) a hash function (H1) of a combination of a first user identity, the first salt and the one or more strong passwords, (b) a hash function (H2) of a combination of a second user identity, the second salt and the one or more strong passwords, (c) one or more delts values (Δ) including at least one of: a first delta value (Δ1) and a second delta value (Δ2). In an embodiment, the one or more private key variables (PKV) are generated/computed based on the first delta value (Δ1), the second delta value (Δ2), the first salt, and the second salt. In another embodiment, the first delta value (Δ1) is a difference between the prime number (P) and the hash function (H1). In another embodiment, the second delta value (Δ2) is a difference between the prime number (Q) and the hash function (H2). The one or more user devices 102 are further configured to generate the one or more hash indices (i.e., the first index = H(fingerprint) and the second index = H(tnirpregnif)) from the one or more device fingerprints associated with the one or more user devices 102.

The one or more user devices 102 are further configured to transmit the one or more user identities, the first index, the second index, the one or more private key variables, the one or more public keys (n), and the one or more random numbers (Y), to the one or more authentication servers 104. The one or more authentication servers 104 are configured to store the user information. In an embodiment, the one or more authentication servers 104 may store the user information in two different dissociated databases. In an embodiment, in an event of the database being compromised, there is no information available to combine all the data associated with the user information. The one or more authentication servers 104 are configured to determine/verify whether the one or more user credentials are stored. Further, the one or more user devices 102 are further configured to store the one or more device fingerprints in the secure storage of the one or more user devices 102.

In order to perform the logging in process, the user credentials obtaining subsystem 210 of the one or more user devices 102 is configured to obtain the one or more user identities, associated with the one or more users. The information retrieval subsystem 212 of the one or more user devices 102 is configured to retrieve the information associated with the one or more device fingerprints corresponding to the one or more user devices 102. In an embodiment, retrieving the information associated with the one or more device fingerprints may include regenerating the one or more indices including at least one of: the first index and the second index, associated with the one or more device fingerprints.

The information generation subsystem 214 of the one or more user devices 102 is configured to generate the one or more cipher messages by at least one of: creating the one or more random numbers and encrypting the one or more random numbers with the one or more keys derived from at least one of: the first index and the second index. The transmission subsystem 216 of the one or more user devices 102 is configured to transmit at least one of: the one or more user identities, the first index, the second index, and the one or more cipher messages, to the one or more authentication servers 104.

The one or more authentication servers 104 are configured to determine whether the one or more user identities are matched with first index associated with the one or more device fingerprints. The one or more authentication servers 104 are further configured to retrieve at least one of: the one or more public keys and the one or more private key variables, from the one or more user devices 102. The one or more authentication servers 104 are configured to decode the one or more cipher messages received from the one or more user devices 102. The one or more authentication servers 104 are configured to generate the one or more authentication based questions based on at least one of: the decoded one or more cipher messages and the one or more random numbers. The one or more authentication servers 104 are configured to transmit the one or more private key variables and the one or more authentication based questions, to the one or more user devices 102.

The key generation subsystem 218 is configured to regenerate the one or more private keys using the one or more private key variables and the one or more passwords/passcodes. The authentication response generation subsystem 220 is configured to generate the one or more authentication responses by decoding the one or more authentication based questions obtained from the one or more authentication servers 104, using at least one of: the one or more cipher messages and the one or more private keys. The transmission subsystem 216 is further configured to transmit the one or more authentication responses to the one or more authentication servers 104 for adapting the one or more authentication servers 104 to authenticate the one or more user devices 102.

The one or more authentication servers 104 are further configured to determine whether the one or more authentication responses match the one or more authentication based questions. If the one or more authentication responses match the one or more authentication based questions, then the one or more authentication servers 104 may authenticate the one or more user devices 102. If not, the one or more user devices 102 are denied to authenticate with the one or more authentication servers 104.

In above said embodiments, the one or more prime numbers required for the one or more private keys are generated in the one or more user devices 102. In an alternative embodiment, the one or more prime numbers and thereby the public-private keys may be pre-computed on the one or more authentication servers 104 and stored in-memory/secure storage that is isolated from the user database. During the user sign up process, when the one or more user identities are verified on the one or more authentication servers 104, the one or more private keys may be sent to the one or more user devices 102 and deleted from the precomputed storage. The precomputed stored public-private key may be deleted after a set time interval if the one or more private keys are not used, for security measures. The one or more private keys are transmitted during the sign up process from the one or more authentication servers 104 to the one or more user devices 102 and the one or more authentication servers 104 which is isolated from the one or more pre-computation servers may not know the private key information.

In yet alternate embodiment (Method 5), the computer-implemented system 106 is configured to provide passwordless authentication. In this scenario, one or more unique identities or the one or more device fingerprints are used as part of the generation of the one or more private keys. Further, one or more random numbers (R1, R2, and R3) are generated along with the one or more prime numbers (P and Q).

In one embodiment, in order to perform the registration process, the one or more user devices 102 are configured to generate the one or more prime numbers (P and Q) having 1024 bit length. the one or more user devices 102 are further configured to generate the one or more random numbers (R1 and R2, having 1024 bit length, and R3 has 256 bit length, in one embodiment). In an embodiment, the generation of the one or more prime numbers may take longer than the generation of the one or more random numbers. The one or more user devices 102 may compute the one or more public keys (n) based on the one or more prime numbers (i.e., n = P*Q). The one or more user devices 102 may generate secure hash algorithm (SHA256) of the one or more public keys (i.e., n: H(n)).

The one or more user devices 102 may generate/compute the one or more delts values. In an embodiment, the first delta value (Δ1) is a difference between the prime number (P) and the first random number (R1). In another embodiment, the second delta value (Δ2) is a difference between the prime number (Q) and the second random number (R2). The one or more authentication servers 104 are configured to determine whether the user identity exists or not. The one or more user devices 102 may encrypt an advanced encryption standard (AES 256) using the one or more random numbers (i.e., R3). The one or more user devices 102 may encrypt concatenated random numbers (R1 and R2) using the one or more random numbers (i.e., R3).

The above said encryption is performed by encrypting concatenated delta values (Δ1 and Δ2) using the random number R3 and encrypting the random number R3 using the secure hash algorithm (SHA256) of encrypted and concatenated random numbers (R1 and R2). The encryption of the random number R3 may involve a first method including (a) obtaining the secure hash algorithm (SHA256) of the encrypted and concatenated random numbers (R1 and R2) and (b) utilizing the resultant 256 bit value to encrypt the random number R3. The encryption of the random number R3 may involve a first method including (a) splitting the derived encrypted and concatenated random numbers (Ra and R2) values into at least 8 pieces array as 256 bit each, (b) performing XOR operation for each of 256 bits, and (c) utilizing the resultant 256 bit value to encrypt the random number R3.

The one or more user devices 102 may generate the one or more hash indices based on a hash function of a combination of the encrypted random numbers (R1 and R2) and the one or more user identities. The one or more user devices 102 may transmit the one or more user identities, the encrypted random number R3, the encrypted delta values (Δ1 and Δ2), the first hash index, the second hash index, and the one or more public keys (n), to the one or more authentication servers 104. In an embodiment, the encrypted random numbers (R1 and R2) and the one or more user identities are stored in the one or more user devices 102. In an embodiment, the encrypted random numbers (R1 and R2) are the unique identities or the device fingerprints. In an embodiment, the hash function of the one or more public keys (n) is used to encrypt the one or more ciphertexts (m1) that is transmitted to the one or more authentication servers 104 during the login process, which may save one network round trip to improve the latency.

The one or more user devices 102 may store one or more application identities, the one or more user identities, the encrypted random numbers (R1 and R2), and the hash function of the one or more public keys (n), in a trusted platform module (TPM) or secure keychain store. In an embodiment, the one or more user devices 102 may have n number of user identities. Upon transmitting the data to the one or more authentication servers 104, the one or more authentication servers 104 may store the one or more user identities, the first hash index, the encrypted random number R3, the second hash index, the encrypted delta values (Δ1 and Δ2), and the one or more public keys (n).

In order to perform the logging in process, the user credentials obtaining subsystem 210 of the one or more user devices 102 is configured to obtain the one or more user identities, associated with the one or more users. The information retrieval subsystem 212 of the one or more user devices 102 is configured to retrieve the information associated with the encrypted random numbers (R1 and R2) from a local key store. The information generation subsystem 214 of the one or more user devices 102 is configured to regenerate the one or more hash indices based on the hash function of a combination of the encrypted random numbers (R1 and R2) and the one or more user identities. The information generation subsystem 214 of the one or more user devices 102 is further configured to regenerate the one or more cipher messages by at least one of: creating a random number R4 and encrypting the random number R4 using a hash function of the one or more public keys as one or more encryption keys.

The transmission subsystem 216 of the one or more user devices 102 is configured to transmit at least one of: the one or more user identities, the first hash index, the second hash index, and the encrypted one or more random numbers R4, to the one or more authentication servers 104.

The one or more authentication servers 104 may determine whether the one or more user identities are matched with the first hash index (H1). The one or more authentication servers 104 are further configured to retrieve at least one of: the encrypted random number R3 and the encrypted delta values (Δ1 and Δ2). The one or more authentication servers 104 are further configured to generate the one or more authentication based questions by decrypting the encrypted random numbers (R3) using the hash function of the one or more public keys (i.e., H(n)). The one or more authentication servers 104 are further configured to transmit the one or more authentication based questions with at least one of: the encrypted random number (i.e., encrypted third random number E(R3)) and the encrypted one or more deltas (E(Δ1Δ2)), to the one or more user devices 102.

Upon receiving the one or more authentication based questions from the one or more authentication servers 104, the one or more user devices 102 are configured to decrypt the encrypted third random number (E(R3)) using the encrypted first random number and the encrypted second random number (E(R1R2)). The one or more user devices 102 are further configured to decrypt the encrypted first random number and the encrypted second random number (E(R1R2)) using the decrypted third random number (R3). The one or more user devices 102 are further configured to decrypt the encrypted one or more deltas (E(Δ1Δ2)) using the decrypted third random number (R3). The one or more user devices 102 are further configured to regenerate the one or more prime numbers (P and Q) based on a combination of the one or more deltas and the one or more random numbers (R1 and R2). The one or more user devices 102 are further configured to decrypt the one or more authentication based questions to generate the one or more authentication responses and transmit the one or more authentication responses to the one or more authentication servers 104.

In yet alternate embodiment (Method 6), the computer-implemented system 106 is configured to utilize the one or more pre-computation servers that generate the public-private key, the one or more private key variables and the one or more encryption keys, which are separated and isolated from the one or more authentication servers 104. The one or more pre-computation servers are configured to generate the one or more random numbers (i.e., R1 having 1024 bit, R2 having 1024 bit, R3 having 256 bit, in one embodiment), and the one or more prime numbers (P and Q having 1024 bit, in one embodiment). The one or more pre-computation servers are further configured to compute the one or more public keys (n) based on the one or more prime numbers (i.e., n = P*Q). The one or more pre-computation servers are further configured to generate the hash function of the one or more public keys (i.e., H(n)). The one or more pre-computation servers are further configured to generate/compute the one or more delts values. In an embodiment, the first delta value (Δ1) is a difference between the prime number (P) and the first random number (R1). In another embodiment, the second delta value (Δ2) is a difference between the prime number (Q) and the second random number (R2).

The one or more pre-computation servers are further configured to encrypt concatenated random numbers (Concatenated(R1R2)) using the third random number (R3) as a key. The one or more pre-computation servers are further configured to encrypt concatenated delta values (Concatenated(Δ1Δ2)) using the third random number (R3) as a key. The one or more pre-computation servers are further configured to encrypt the third random number (R3) using the encrypted random numbers (E(R1R2)) as a key. The one or more pre-computation servers are further configured to generate the hash indices based on a hash function of a combination of encrypted random numbers (E(R1R2)) and the one or more user identities.

In order to perform the registration process, the one or more user devices 102 are configured to transmit the one or more user identities to the one or more authentication servers 104. Upon receiving the one or more user identities from the one or more user devices 102, the one or more authentication servers 104 are configured to verify the one or more user identities. The one or more authentication servers 104 are configured to send a token and request the one or more pre-computation servers when the one or more user identities are verified. The one or more pre-computation servers are configured to send the encrypted random numbers (E(R1R2)) and the hash function of the one or more public keys (H(n)), to the one or more user devices 102. In an embodiment, the values are then stored in the one or more user devices 102.

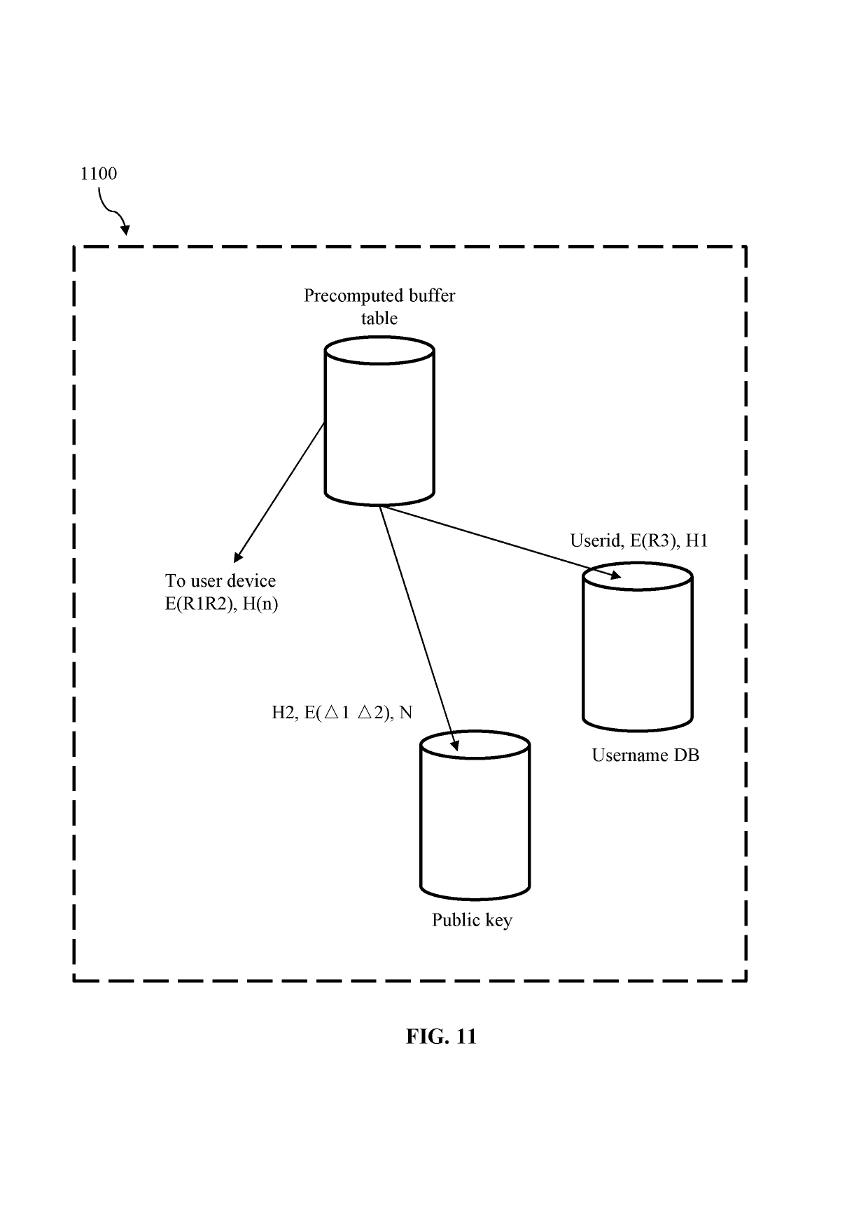

In an embodiment, the one or more pre-computation servers are configured to transmit at least one of: the token, the encrypted third random number (E(R3)), the first hash index (H1), the second hash index (H2), and the one or more public keys (n), to the one or more databases (i.e., username databases) of the one or more user devices 102. The username database may store at least one of: the one or more user identities, the first hash index (H1), the encrypted third random number (E(R3)), the second hash index (H2), the encrypted delta values (E(Δ1Δ2)), and the one or more public keys (n), as shown in FIG. 11.

In order to perform the logging in process, the user credentials obtaining subsystem 210 of the one or more user devices 102 is configured to obtain the one or more user identities, associated with the one or more users. The information retrieval subsystem 212 of the one or more user devices 102 is configured to retrieve the information associated with the encrypted random numbers (R1 and R2) from the local key store. The information generation subsystem 214 of the one or more user devices 102 is configured to regenerate the one or more hash indices based on the hash function of a combination of the encrypted random numbers (R1 and R2) and the one or more user identities. The information generation subsystem 214 of the one or more user devices 102 is further configured to regenerate the one or more cipher messages by at least one of: creating a random number R4 and encrypting the random number R4 using the hash function of the one or more public keys as one or more encryption keys.

The transmission subsystem 216 of the one or more user devices 102 is configured to transmit at least one of: the one or more user identities, the first hash index (H1), the second hash index (H2), and the encrypted one or more random numbers (R4), to the one or more authentication servers 104.

The one or more authentication servers 104 may determine whether the one or more user identities are matched with the first hash index (H1). The one or more authentication servers 104 are further configured to retrieve at least one of: the encrypted random number R3 and the encrypted delta values (Δ1 and Δ2). The one or more authentication servers 104 are further configured to generate the one or more authentication based questions by decrypting the encrypted random numbers (R4) using the hash function of the one or more public keys (i.e., H(n)). The one or more authentication servers 104 are further configured to transmit the one or more authentication based questions with at least one of: the encrypted random number (i.e., encrypted third random number E(R3)) and the encrypted one or more deltas (E(Δ1Δ2)), to the one or more user devices 102.

Upon receiving the one or more authentication based questions from the one or more authentication servers 104, the one or more user devices 102 are configured to decrypt the encrypted third random number (E(R3)) using the encrypted first random number and the encrypted second random number (E(R1R2)). The one or more user devices 102 are further configured to decrypt the encrypted first random number and the encrypted second random number (E(R1R2)) using the decrypted third random number (R3). The one or more user devices 102 are further configured to decrypt the encrypted one or more deltas (E(Δ1Δ2)) using the decrypted third random number (R3). The one or more user devices 102 are further configured to regenerate the one or more prime numbers (P and Q) based on a combination of the one or more delta values (Δ1 and Δ2) and the one or more random numbers (R1 and R2). The one or more user devices 102 are further configured to decrypt the one or more authentication based questions to generate the one or more authentication responses and transmit the one or more authentication responses to the one or more authentication servers 104.

In yet alternate embodiment (Method 7), the one or more pre-computation servers are configured to pre-compute one or more unique user identities and send the one or more user identities to the one or more user devices 102 during the registration process.

The one or more pre-computation servers may pre-generate one or more user names and pre-compute the public-private keys, in a buffer and the buffer is completely separate from the username databases and isolated from the username databases. The one or more pre-computation servers are configured to generate the one or more random numbers (i.e., R1 having 1024 bit, R2 having 1024 bit, R3 having 256 bit, in one embodiment), and the one or more prime numbers (P and Q having 1024 bit, in one embodiment). The one or more pre-computation servers are further configured to compute the one or more public keys (n) based on the one or more prime numbers (i.e., n = P*Q). The one or more pre-computation servers are further configured to generate the hash function of the one or more public keys (i.e., H(n)). The one or more pre-computation servers are further configured to generate/compute the one or more delts values. In an embodiment, the first delta value (Δ1) is a difference between the prime number (P) and the first random number (R1). In another embodiment, the second delta value (Δ2) is a difference between the prime number (Q) and the second random number (R2).

The one or more pre-computation servers are further configured to encrypt concatenated random numbers (Concatenated(R1R2)) using the third random number (R3) as the key. The one or more pre-computation servers are further configured to encrypt concatenated delta values (Concatenated(Δ1Δ2)) using the third random number (R3) as the key. The one or more pre-computation servers are further configured to encrypt the third random number (R3) using the encrypted random numbers (E(R1R2)) as the key. The one or more pre-computation servers are further configured to generate the hash indices based on a hash function of a combination of encrypted random numbers (E(R1R2)) and the one or more user identities.

In order to perform the registration process, the one or more user devices 102 are configured to request the one or more authentication servers 104 for user sign up. The one or more authentication servers 104 may request the one or more pre-computation servers for the one or more user identities and the one or more private key variables. The one or more pre-computation servers are configured to send at least one of: the user names, the encrypted random numbers (E(R1R2)) and the hash function of the one or more public keys (H(n)), to the one or more user devices 102. In an embodiment, the values are then stored in a secure storage of the one or more user devices 102.

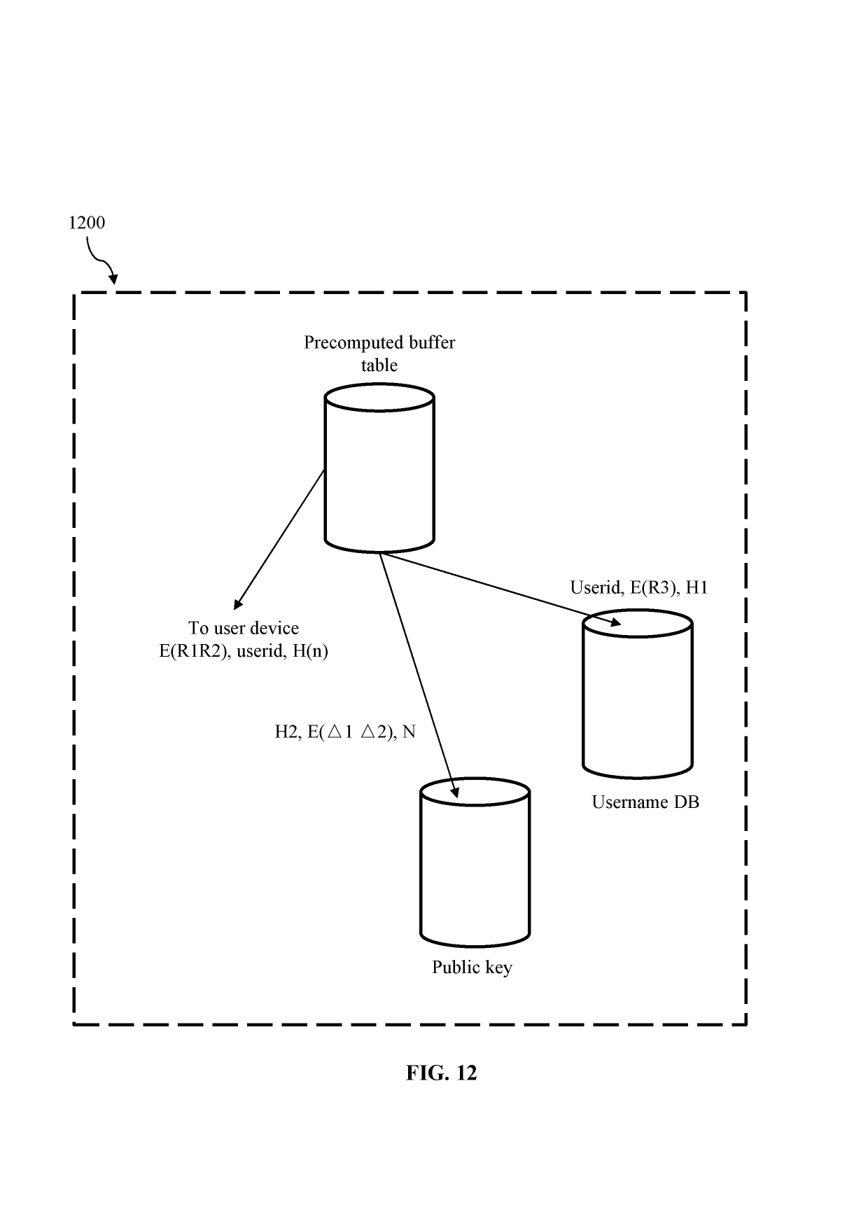

In an embodiment, the one or more pre-computation servers are configured to transmit at least one of: the user names, the encrypted third random number (E(R3)), the first hash index (H1), the second hash index (H2), and the one or more public keys (n), to the one or more databases (i.e., the username databases) of the one or more user devices 102. The username databases may store at least one of: the one or more user identities, the first hash index (H1), the encrypted third random number (E(R3)), the second hash index (H2), the encrypted delta values (E(Δ1Δ2)), and the one or more public keys (n), as shown in FIG. 12.

In yet alternate embodiment (Method 8), the computer-implemented system 106 is configured to add a process to make sure the one or more authentication servers 104 are true and not fake by verifying the HASH(HASH(n)) = H²(n) sent by the server on the user/client device before proceeding the authentication process.

In order to perform the logging in process, the user credentials obtaining subsystem 210 of the one or more user devices 102 is configured to obtain the one or more user identities, associated with the one or more users. The information retrieval subsystem 212 of the one or more user devices 102 is configured to retrieve the information associated with the encrypted random numbers (R1 and R2) from the local key store. The information generation subsystem 214 of the one or more user devices 102 is configured to regenerate the one or more hash indices based on the hash function of a combination of the encrypted random numbers (R1 and R2) and the one or more user identities. The information generation subsystem 214 of the one or more user devices 102 is further configured to regenerate the one or more ciphertext messages by at least one of: creating the random number R4 and encrypting the random number R4 using a hash function of the one or more public keys as the one or more encryption keys.

The transmission subsystem 216 of the one or more user devices 102 is configured to transmit at least one of: the one or more user identities, the first hash index (H1), the second hash index (H2), and the encrypted one or more random numbers R4, to the one or more authentication servers 104.

The one or more authentication servers 104 may determine whether the one or more user identities are matched with the first hash index (H1). The one or more authentication servers 104 are further configured to retrieve at least one of: the encrypted random number R3 and the encrypted delta values (Δ1 and Δ2). The one or more authentication servers 104 are further configured to generate the one or more authentication based questions by decrypting the encrypted random numbers (R4) using the hash function of the one or more public keys (i.e., H(n)). The one or more authentication servers 104 are further configured to transmit the one or more authentication based questions with at least one of: the encrypted random number (i.e., encrypted third random number E(R3)), the encrypted one or more deltas (E(Δ1Δ2)), and the hash square functions (H²(n)), to the one or more user devices 102.

The one or more user devices 102 are configured to determine whether the hash square functions of the one or more public keys sent by the one or more authentication servers 104 are matched with the hash function of the one or more public keys (HASH(H(n))). The one or more user devices 102 are configured to decrypt the encrypted third random number (R3) using the encrypted first random number and the encrypted second random number (E(R1R2)) upon matching of the hash square functions of the one or more public keys (H²(n)) sent by the one or more authentication servers 104, with the hash function of the one or more public keys (HASH(H(n))). The one or more user devices 102 are further configured to decrypt the encrypted first random number and the encrypted second random number (E(R1R2)) using the decrypted third random number (R3).

The one or more user devices 102 are further configured to decrypt the encrypted one or more deltas (E(Δ1Δ2)) using the decrypted third random number (R3). The one or more user devices 102 are further configured to regenerate the one or more prime numbers (P and Q) based on a combination of the one or more deltas and the one or more random numbers (R1 and R2). The one or more user devices 102 are further configured to decrypt the one or more authentication based questions to generate the one or more authentication responses and transmit the one or more authentication responses to the one or more authentication servers 104.

In an embodiment, an example implementation may be provided for the authentication between the one or more user devices 102 and the one or more authentication servers 104. The example implementation may include one additional round trip between the one or more user devices 102 and the one or more authentication servers 104.

In order to perform the registration/sign up process, the one or more user devices 102 may generate the one or more strong passwords (i.e., k = x+y+z), where x represents a big integer value from pin number, y represents a big integer value from 10 digit random number, and z represents a big integer value from an electronic mail. The one or more user devices 102 may further send the one or more strong passwords to the one or more authentication servers 104. The one or more user devices 102 are configured to generate the one or more prime numbers (P and Q) having 1024 bit length, in one embodiment. The one or more user devices 102 may further generate the one or more salts based on the one or more random numbers. The one or more user devices 102 may further generate the one or more hash indices based on a combination of at least one of: the one or more strong passwords, the one or more emails, and the one or more salts.

The one or more user devices 102 may further generate the one or more private key variables (delta values) based on the one or more hash indices and the one or more private keys. In an embodiment, the one or more user devices 102 may further encrypt the one or more private key variables. The one or more user devices 102 may further transmit at least one of: the one or more strong passwords, the one or more public keys, the token and the keys, to the one or more authentication servers 104. In an embodiment, the one or more authentication servers 104 may store the one or more identities (e.g., the email), the random number (Y), the one or more strong passwords, the one or more private key variables, and the one or more public keys (n), in the one or more databases.

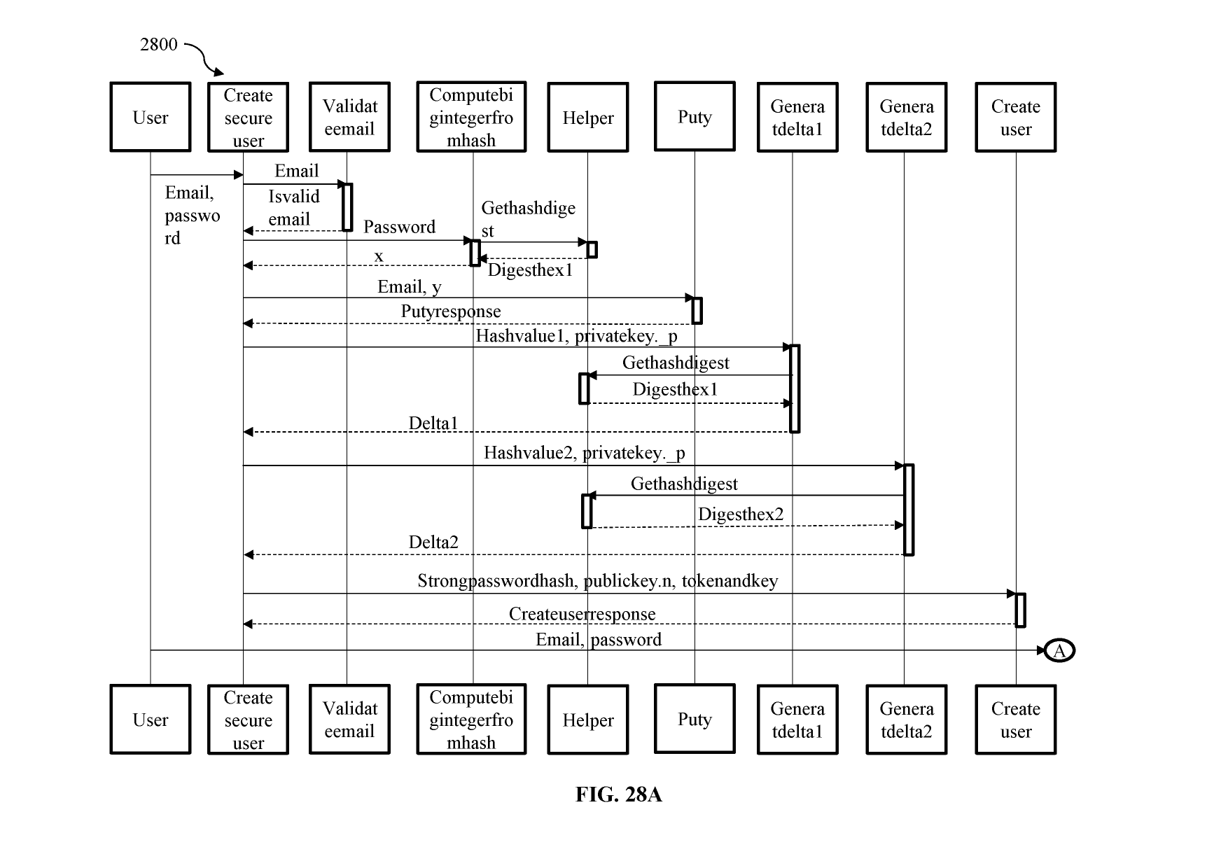

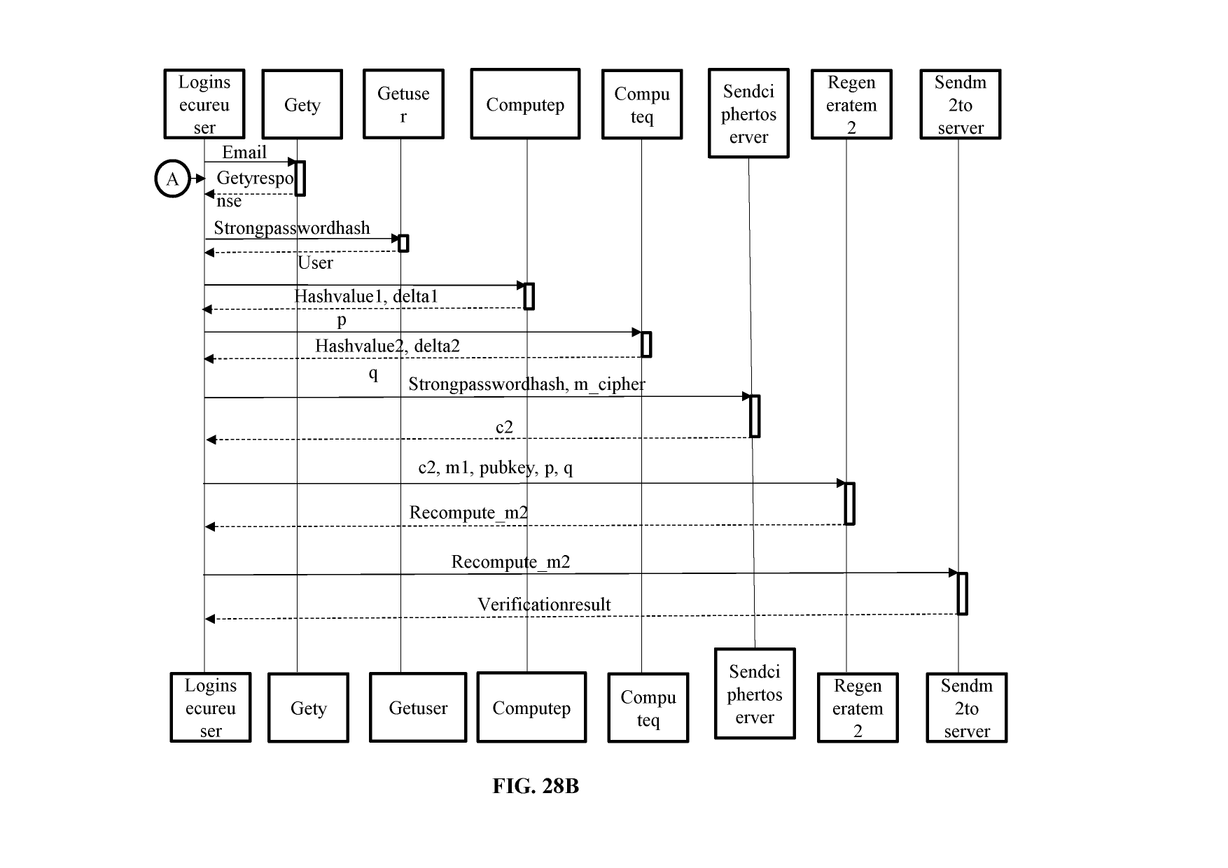

In order to perform the logging in process, the one or more user devices 102 may obtain the data (e.g., the emails) from the one or more authentication servers 104 (i.e., gety). The one or more user devices 102 may further generate the one or more strong passwords, and transmit the one or more strong passwords to the one or more authentication servers 104. The one or more user devices 102 may further retrieve the one or more private key variables with at least one of: the one or more salts and the one or more delta values. The one or more user devices 102 may further generate the one or more hash indices based on a combination of the one or more strong passwords, the one or more emails, and the one or more salts. The one or more user devices 102 may further regenerate the one or more prime numbers (P and Q) based on the hash indices and the delta values. The one or more user devices 102 may further encrypt the one or more ciphertexts with the one or more public keys (n) and send the one or more ciphertexts to the one or more authentication servers 104. The one or more user devices 102 may further decrypt the encrypted ciphertexts. Finally, the one or more user devices 102 may transmit the decrypted ciphertexts to the one or more authentication servers 104 and verify the ciphertexts based on at least one of: precomputation of m2, hash function of strong password, and the email (as shown in FIG. 28A-28B).

The computer-implemented system 106 is configured to allow for the one or more user devices 102 to be marked as a golden device or a primary device, which is used to authenticate non-primary registration. In an embodiment, the non-primary registration may be a web browser, additional devices, and the like. In an embodiment, a dynamic regeneration may allow the same passcode to the one or more users to authenticate across the one or more user devices 102 with different device fingerprint and public key pair.

The primary device may obtain the one or more user identities from the one or more users associated with the primary device. The one or more authentication servers 104 may verify the one or more user identities and send a notification to the primary/golden device. The one or more authentication servers 104 may further authenticate the one or more users associated with the primary device to allow the secondary device registration. Upon verifying the primary device, the one or more user identities are sent to the primary device.

The primary device may generate a public-private key pair. The primary device may further generate the one or more private key variables. The primary device may further generate the one or more device fingerprints by creating the one or more indices associated with the one or more device fingerprints. The primary device may transmit the one or more indices associated with the one or more device fingerprints, the one or more private key variables, and the one or more public keys, to the one or more authentication servers 104. The one or more authentication servers 104 may store the secondary device information including at least one of: the one or more user identities, the first index (H1), type of the device, the encrypted random numbers (E(R2R3)), the second index (H2), the one or more private key variables, and the one or more public keys (n2). In an embodiment, the one or more user devices may store the one or more fingerprints securely.

In an embodiment, the secondary device logging in process may be similar to the logging process of the primary device. The one or more user identities and the one or more indices based on the one or more device fingerprints are sent to the one or more authentication servers 104 and normal authentication steps are followed. From the primary device, the secondary device registration may be revoked and for switching the primary device to a new device, the user authentication in the primary device is required and then new primary device registration is allowed.

FIG. 2B is a detailed view of the computer-implemented system 106, such as those shown in FIG. 1, in accordance with another embodiment of the present disclosure.

In an aspect of the present disclosure, the plurality of subsystems 108 further includes the user registering subsystem 232 that is communicatively connected to the one or more hardware processors 204. The user registering subsystem 232 is configured to register the user identity by verifying the government-issued identity document. The registration of the user identity generates the master cryptographic key stored in the hardware security module of the user device 102. In an embodiment, no secret data is transmitted after the registration of the user identity is completed.

In an embodiment, for registering the user identity, i.e., for an enterprise user, the user registering subsystem 232 is further configured to verify the government-issued identity document in person by an authority (e.g., a human resources officer), and generate a one-time registration code tied to the verified government-issued identity document. The one-time registration code is single-use, time-bounded, and valid only on a specific device being enrolled. For a consumer user, the user registering subsystem 232 is further configured to capture the government-issued identity document, completing a live selfie check with liveness detection using challenge-response verification, performing a document authenticity check to verify that the government-issued identity document is not forged, and performing a face match to confirm that the user matches the government-issued identity document.

The user registering subsystem 232 is a software component configured to establish a verified human identity as the foundational anchor for all subsequent authentication and AI agent authorization operations. The registration is the identity anchor for everything that follows, and the strength of the entire chain depends on how confidently the system can establish who the person actually is at enrollment time. The OTP-based verification is eliminated entirely because SMS OTP is vulnerable to SIM swapping, SS7 interception, real-time phishing relay, and malware with notification access. The user registering subsystem 232 functions by verifying a government-issued identity document through one of two tracks.

For enterprise users, identity is verified through the employer's existing HR verification process before the application is touched, where the employee completes standard onboarding identity verification with a passport, driving license, or equivalent government-issued document in person with HR, and the HR system or IT administrator generates a one-time registration code tied to that verified identity, which is single-use, time-bounded, and valid only on the specific device being enrolled. For consumer users, identity is verified through government-issued document plus live selfie, where the user photographs their government-issued ID, completes a live selfie check with liveness detection using challenge-response verification rather than a static photo match, a document authenticity check verifies the ID is not forged, face match confirms the person holding the phone matches the document, and for NFC-enabled passports, the chip's cryptographic signature is verified against the issuing government's public key.

Upon successful verification, the user registering subsystem 232 generates a master cryptographic key that is stored exclusively within the hardware security module, such as a Secure Enclave or TPM chip, of the user device 102, and the private key never leaves this secure hardware. After registration, every subsequent login is a cryptographic proof ceremony where no secret of any kind is transmitted - not a password, not a biometric hash, not a private key. The key principle is that the registration code is issued after identity is verified, not as the means of verifying identity, meaning the one-time registration code presupposes verified identity rather than substituting for it.

For example, when a new employee joins an organization, the HR officer verifies the employee's passport in person, then generates a time-limited registration code; the employee enters this code on their enrolled device, which triggers the generation of the master cryptographic key within the device's secure hardware, and from this point forward, no secret ever crosses the network during authentication, as the device proves possession of the key through zero-knowledge cryptographic proofs rather than transmitting credentials.

In an embodiment, the computer-implemented system 106 provides the authorization of artificial intelligence (AI) agent actions. The user registering subsystem 232 is further configured to assign a maximum AI agent authorization trust tier to an account based on an assurance level of an identity verification method used during the registration of the user identity. The maximum AI agent authorization trust tier is enforced cryptographically at a token minting layer. In an embodiment, in-person physical verification maps to a maximum available AI agent authorization trust tier, a near field communication (NFC) passport chip cryptographic verification maps to a higher trust tier instead of selfie-based verification, and selfie plus document verification maps to a defined lower trust tier ceiling.

The maximum AI agent authorization trust tier assignment feature is a security mechanism within the user registering subsystem 232 that establishes a cryptographically enforced ceiling on the permission levels available to AI agents based on the strength and assurance level of the identity verification method used during the initial user registration process. The feature functions by mapping different identity verification methods to corresponding trust tier ceilings that are enforced at the token minting layer, meaning that when the agent authorizing subsystem 238 generates single-use authorization tokens for AI agent actions, the tokens cannot exceed the trust tier ceiling established during registration regardless of any subsequent policy configurations. The trust tier mapping operates on a graduated scale where in-person physical verification maps to the maximum available AI agent authorization trust tier, NFC passport chip cryptographic verification maps to a higher trust tier than selfie-based verification, and selfie plus document verification maps to a defined lower trust tier ceiling. This graduated approach reflects the principle that selfie plus ID liveness checks are vulnerable to sophisticated deepfake attacks today, and the mitigation is not making the check impenetrable but rather implementing risk-tiered access where a consumer who passes enrollment starts at a lower trust tier, and high-stakes agent actions require independent cryptographic confirmation regardless of how clean the enrollment was, ensuring that the cost of the deepfake attack exceeds the value of what it unlocks.

The enterprise users who complete in-person verification with HR using physical government documents receive the highest trust tier because the identity check is physical document verification by a trained person, not a video call with a remote agent, eliminating the deepfake vulnerability entirely. For NFC-enabled passports, the chip's cryptographic signature is verified against the issuing government's public key, which is currently deepfake-proof, justifying a higher trust tier than standard selfie-based verification. The cryptographic enforcement at the token minting layer ensures that the trust tier ceiling cannot be bypassed through application-layer policy changes or configuration modifications, as the ceiling is embedded in the cryptographic token generation process itself. For example, when a consumer user registers using the selfie plus document verification method by photographing their driving license and completing a live selfie check with liveness detection, the user registering subsystem 232 assigns a lower trust tier ceiling to their account. Subsequently, when this user's AI agents request authorization tokens for various actions, the agent authorizing subsystem 238 can only mint tokens up to the assigned trust tier ceiling, meaning that even if the user configures their financial AI agent to have full transaction authority, the tokens generated for that agent will be cryptographically limited to the lower trust tier, preventing high-stakes actions like large wire transfers or irreversible operations; in contrast, an enterprise user who completed in-person identity verification with their HR department using their passport receives the maximum available trust tier, allowing their AI agents to receive authorization tokens for the full range of actions including high-stakes operations, because the in-person physical verification provides the highest assurance that the registered identity is genuine and not the result of a deepfake or document forgery attack.

The plurality of subsystems 108 further includes the user authenticating subsystem 234 that is communicatively connected to the one or more hardware processors 204. The user authenticating subsystem 234 is configured to authenticate the user for every subsequent login, through the zero-knowledge proof ceremony in which the biometric check is performed within the hardware security module of the user device 102.

The user authenticating subsystem 234 is a software component configured to verify the identity of a previously registered user for every subsequent login attempt through the zero-knowledge proof ceremony performed within the hardware security module of the user device 102. After registration, every subsequent login is a cryptographic proof ceremony where no secret of any kind is transmitted: not a password, not a biometric hash, not a private key. The user authenticating subsystem 234 functions by leveraging the device's secure hardware enclave to perform biometric verification locally - the user's private key lives inside the device's Secure Enclave or TPM chip and it never leaves; the biometric check happens inside the hardware security chip, and the chip reports only pass or fail, meaning the biometric data itself is never accessible to the app, the OS, or the authentication platform. The authentication is a mutual cryptographic challenge-response where both the user device 102 and the server (e.g., authentication server 104) prove they hold the correct private key without either transmitting it. The server 104 learns exactly one thing from the exchange: the user device 102 holds the correct key, and this constitutes a zero-knowledge proof. On success, a master cryptographic key is released, which unlocks the agent credential chain.

The zero-knowledge proof ceremony ensures that even if network communications are intercepted, an attacker gains no usable information because no secret material ever traverses the network. For example, when a user attempts to log into their account, they present their fingerprint or face to the user device 102. The hardware security module internally verifies the biometric matches an enrolled template and reports success without exposing the biometric data. The user device 102 then engages in a cryptographic challenge-response with the server 104 where both parties mathematically prove possession of their respective private keys without revealing them. Upon successful mutual verification, the master cryptographic key is released from the secure enclave, enabling the user to access their account and authorize AI agent actions, all without any password, biometric hash, or private key ever being transmitted over the network.

In an embodiment, for authenticating the user, the user authenticating subsystem 234 is further configured to: (a) provide dual cryptographically distinct keys to the hardware security module of the user device 102, comprising a normal key bound to a primary enrolled biometric entry and a distress key bound to a secondary enrolled biometric entry; (b) upon each authentication attempt, silently attempt the authentication attempts to unlock the normal key, and if the normal key fails, silently attempt to unlock the distress key; and (c) upon activation of the distress key, unlock a sandboxed AI agent environment that is operationally identical to but capability-restricted from a normal AI agent environment, wherein the sandboxed AI agent environment is indistinguishable from the normal AI agent environment to an external observer.

The dual cryptographic key authentication feature is a security mechanism within the user authenticating subsystem 234 that provisions two cryptographically distinct keys in the hardware security module of the user device 102, comprising a normal key bound to a primary enrolled biometric entry for standard authentication and a distress key bound to a secondary enrolled biometric entry for covert distress signalling, enabling silent detection of duress situations without alerting an attacker. Android's Keystore allows different keys to be associated with different enrolled biometrics, and this enables a cryptographically distinct distress path. At enrollment, the user enrols their primary finger, which seals the normal key in the Keystore, and the user then enrols a second finger, for example their little finger, as the distress finger, which seals the distress key in a separate Keystore entry. The user authenticating subsystem 234 functions by silently attempting to unlock the normal key on each authentication attempt, and if the normal key fails, silently attempting to unlock the distress key, with the user seeing one standard biometric prompt while the distinction happens entirely in the cryptographic layer below.

Upon activation of the distress key, the user authenticating subsystem 234 unlocks a sandboxed AI agent environment that is operationally identical to but capability-restricted from a normal AI agent environment, wherein the sandboxed AI agent environment is indistinguishable from the normal AI agent environment to an external observer. The distress key unlocks a sandboxed environment that looks real but is decoy mode. This architecture ensures that the attacker believes they have gained full access while the system has actually transitioned to a restricted operational mode that prevents harmful actions and simultaneously triggers silent alerts. The general duress concept exists as prior art, but the specific implementation of enrolling two separate biometric entries in a hardware security module and binding each to a distinct cryptographic key, where the application silently attempts the normal key then the distress key on each authentication, with the distress key unlocking a sandboxed agent environment, is novel in its construction and application.

For example, when a user initially enrols in the authentication system, they register their right index finger as the primary biometric which generates and seals the normal key in the device's hardware security module, and they separately register their left little finger as the distress biometric which generates and seals the distress key in a separate Keystore entry. During normal daily use, the user authenticates with their right index finger, the user authenticating subsystem 234 successfully unlocks the normal key, and full AI agent functionality is available. However, if an attacker physically coerces the user to unlock their device, the user presents their left little finger instead, the user authenticating subsystem 234 first silently attempts to unlock the normal key which fails because the wrong biometric was presented, then silently attempts to unlock the distress key which succeeds, and the user is authenticated into what appears to be a completely normal interface with all their AI agents visible and apparently functional - but the system has actually entered decoy mode where all agent trust levels are capped at read-only, no transactions or irreversible actions can execute, and a silent encrypted alert with GPS coordinates has been transmitted to the server 104, all while the attacker sees no indication that anything is different from a normal authentication session.

In an embodiment, the authentication of the user is a mutual cryptographic challenge-response in which both the user device 102 and the server 104 prove that the user device 102 and the server 104 possess a correct private key without transmitting the correct private key between each other. The server 104 learns that the user device 102 possesses the correct private key. Upon success authentication of the user, the master cryptographic key is released to unlock an agent credential chain.

The mutual cryptographic challenge-response authentication is a security mechanism within the user authenticating subsystem 234 wherein both the user device 102 and the authentication server 104 independently prove to each other that they possess the correct private key without either party transmitting the private key across the network, and upon successful mutual verification, the master cryptographic key is released to unlock the agent credential chain that enables AI agent authorization operations. After registration, every subsequent login is a cryptographic proof ceremony where no secret of any kind is transmitted: not a password, not a biometric hash, not a private key. The user's private key lives inside the device's Secure Enclave or TPM chip and it never leaves. Authentication is a mutual cryptographic challenge-response where both the user device 102 and the server 104 prove they hold the correct private key without either transmitting it. The server 104 learns exactly one thing from the exchange: the user device 102 holds the correct key, and this is a zero-knowledge proof.

The mechanism functions by having each party generate cryptographic challenges that can only be correctly answered by an entity possessing the corresponding private key, and both parties exchange these challenges and responses in a manner that mathematically proves possession of the key without revealing any information about the key itself. The biometric check happens inside the hardware security chip, and the chip reports only pass or fail, meaning the biometric data itself is never accessible to the app, the OS, or the authentication platform. On success, a master cryptographic key is released, which unlocks the agent credential chain. The agent credential chain represents the hierarchical structure of cryptographic keys from which per-AI-agent keys are mathematically derived using a deterministic key derivation function, enabling each AI agent to receive its own cryptographically isolated identity that is linked to the verified human owner. Per-agent keys are mathematically derived from the master key using a deterministic key derivation function, and each agent has a cryptographically isolated identity such that compromising one agent reveals nothing about any other. No agent can operate without the chain beginning with the verified human, and revoking the human's access causes every agent the human owns to be immediately locked out.

For example, when a user initiates a login attempt, the user device 102 retrieves the user's private key from the hardware security module after successful biometric verification, and simultaneously the authentication server 104 retrieves its own private key. The server 104 generates a random challenge encrypted with the user's public key and sends it to the user device 102, while the user device 102 generates its own challenge encrypted with the server's public key. The user device 102 decrypts the server's challenge using its private key and sends back the correct response, while the server 104 decrypts the user device's challenge and responds correctly. Both parties verify that the other's response matches the expected answer, thereby proving mutual possession of the correct private keys without either key ever being transmitted; upon successful mutual verification, the hardware security module releases the master cryptographic key which then enables the agent authorizing subsystem 238 to derive unique cryptographic keys for each of the user's AI agents such as a financial assistant, a calendar manager, and a document processor - each receiving its own derived key from the now-unlocked agent credential chain, allowing these agents to operate with cryptographically verified authorization that traces back to the authenticated human identity.

The plurality of subsystems 108 further includes the credential self-destructing subsystem 236 that is communicatively connected to the one or more hardware processors 204. The credential self-destructing subsystem 236 is configured to: (a) monitor the enrolled biometric set of the user device 102, and (b) upon detection of a newly added biometric entry after the registration of the user identity, initiate cryptographic zeroization of credential material stored on the user device 102.

The credential self-destructing subsystem 236 is a software component configured to continuously monitor the enrolled biometric set of the user device 102 and initiate automatic destruction of cryptographic credential material upon detection of unauthorized biometric modifications. The most realistic physical attack against device authentication is to steal the user device 102, add the attacker's own biometric, and unlock the secure enclave using their own finger or face. The credential self-destructing subsystem 236 addresses this threat by monitoring the device's enrolled biometric set, and if a new biometric is added to the device after the application is enrolled, the credential self-destructing subsystem 236 immediately and permanently self-destructs by performing the following operations: all locally held cryptographic material is zeroized, the enrollment record is flagged on the server 104, and the application becomes non-functional, requiring full re-registration. This mechanism ensures that physical possession of the user device 102 without the enrolled biometric is permanently neutralized, as there is no patient attack strategy that works - any attempt to add a new biometric destroys the target before it can be used, making stealing the device an unviable attack path.

Cryptographic zeroization of credential material is a security operation that permanently and irreversibly erases all cryptographic keys, secrets, and authentication credentials stored within the user device's hardware security module and secure storage areas upon detection of an unauthorized modification to the device's enrolled biometric set. The zeroization process involves overwriting all cryptographic key material with zeros or random data to ensure that no residual information remains recoverable through forensic analysis or memory extraction techniques. The cryptographic zeroization is irreversible and requires full re-registration including identity re-verification, ensuring that physical possession of the user device 102 without the original enrolled biometric yields no recoverable credential material. For example, if an attacker steals a user's smartphone and attempts to gain access by adding their own fingerprint to the device's biometric enrollment, the credential self-destructing subsystem 236 immediately detects this new biometric entry, triggers the zeroization protocol that permanently erases all cryptographic keys and credential material from the device's secure enclave, flags the enrollment record on the authentication server 104 as compromised, and renders the application completely non-functional - the attacker is left with a device that contains no usable authentication credentials, and the legitimate user must complete a full re-registration process with physical identity verification to restore access on a new or the same device.

In an embodiment, the credential self-destructing subsystem 236 is further configured to: (a) detect a duress authentication event based on entry of a designated panic PIN or activation of a distress biometric; (b) in response to detecting the duress authentication event, silently transition the authentication to a restricted operational mode without visible indication to an authenticating party; (c) transmit an encrypted alert comprising GPS coordinates, a timestamp, and a device identifier, to a server 104; (d) set trust levels of each AI agent to read-only for precluding execution of transactions and irreversible actions during a duress session; and (e) log every action attempted during the duress session with enhanced forensic metadata comprising geolocation, timestamp, and a duress session identifier.

The duress authentication detection and response subsystem is a security component within the credential self-destructing subsystem 236 that is configured to detect when a user is being coerced or threatened during an authentication attempt and to silently transition the system into a restricted operational mode that appears normal to an attacker while simultaneously alerting authorities and preventing harmful actions. The self-destruct protects against an attacker who has the user device 102 but not the user, but a separate protection is needed when the attacker has both the user device 102 and the user under coercion. The wrong response to coercion is to lock or destroy the app because escalating danger to the user by making the attack visibly fail is worse than appearing to comply. The correct response is decoy mode: the attacker believes they have access, the access does not actually work for anything meaningful, and a forensic alert is firing silently.

The credential self-destructing subsystem 236 functions by monitoring authentication inputs for designated duress triggers, which may include entry of a panic PIN through the standard PIN fallback path or activation of a distress biometric such as a secondary enrolled fingerprint. At enrollment, the user designates a specific PIN as their panic PIN, and normal authentication uses biometric as expected; under coercion, the user taps "use PIN" and enters the panic PIN, and the app appears to authenticate normally and opens in decoy mode while the distress protocol fires silently in the background before the UI transitions. When a distress trigger fires, an encrypted alert is sent immediately to the server 104 with GPS coordinates, timestamp, and device identifier. The app appears to open and function normally to avoid escalating danger to the coerced user, but all agent trust levels are silently capped at read-only so that no transactions and no irreversible actions can execute. Any CIBA approval requests are routed to an emergency contact, not the user. Every action the attacker attempts is logged with enhanced forensic metadata. The session is flagged as a duress session in the audit trail from the first moment. The goal is to give the attacker the appearance of winning while buying time. Every action they attempt is recorded, law enforcement receives a timestamped GPS-anchored alert, and nothing of consequence can actually execute.

For example, if an attacker physically threatens a user and forces them to unlock their phone and access their financial AI agent, the user enters their designated panic PIN instead of using their normal fingerprint. The credential self-destructing subsystem 236 detects this duress trigger and silently transitions to restricted operational mode - the app opens and displays the user's accounts and AI agents exactly as they would appear normally, giving the attacker no indication that anything is different. However, the credential self-destructing subsystem 236 has immediately transmitted an encrypted alert containing the user's GPS coordinates, the current timestamp, and the device identifier to the security server, which can forward this information to law enforcement or designated emergency contacts. Simultaneously, all AI agent trust levels have been silently set to read-only, so when the attacker attempts to use the financial AI agent to initiate a wire transfer, the transaction silently fails or returns a plausible error message without revealing that the system is in duress mode. Every action the attacker attempts - viewing account balances, attempting transfers, accessing documents, is logged with enhanced forensic metadata including precise geolocation, timestamps, and a duress session identifier that links all activities to this coercion event. If the attacker attempts a high-stakes action that would normally require CIBA approval from a second device, that approval request is automatically rerouted to the user's pre-registered emergency contact rather than appearing on any device the attacker might control. Throughout this entire interaction, the attacker sees what appears to be a fully functional system and believes they have successfully gained access, while in reality they can only view information and cannot execute any harmful transactions, and law enforcement has been alerted with the user's exact location and a complete forensic record of every action the attacker attempted.

In an embodiment, the credential self-destructing subsystem 236 is further configured to re-route client initiated backchannel authentication (CIBA) approval requests generated during the duress session to a pre-registered emergency contact instead of routing to the user.

The CIBA approval request re-routing feature is a security mechanism within the credential self-destructing subsystem 236 that automatically redirects Client-Initiated Backchannel Authentication approval requests to a pre-registered emergency contact when the system detects that the user is authenticating under duress, rather than delivering these approval requests to the coerced user who would be forced to approve malicious actions. When a distress trigger fires, any CIBA approval requests are routed to an emergency contact, not the user.

The CIBA re-routing mechanism operates in conjunction with other duress protections including the silent transmission of an encrypted alert with GPS coordinates, timestamp, and device identifier, the capping of all agent trust levels to read-only so that no transactions or irreversible actions can execute, and the logging of every action attempted during the duress session with enhanced forensic metadata. For actions above a configurable risk threshold, the agent cannot proceed without a cryptographic approval from a second device, and this is called CIBA (Client-Initiated Backchannel Authentication). Under normal circumstances, when an AI agent attempts a high-stakes action such as a wire transfer, data deletion, or irreversible operation, a confirmation request is sent to the account owner's second enrolled device, where the owner reviews and approves or denies using biometric authentication on that device, and the approval is a cryptographic signature, not a tap on a notification.

However, during a duress session, the attacker controlling the primary device would expect these CIBA approval requests to appear on devices they can access or force the user to approve. The re-routing feature defeats this expectation by silently redirecting all such approval requests to a trusted emergency contact who is not under the attacker's control. For example, if an attacker physically coerces a user to unlock their phone using the panic PIN and then attempts to use the user's financial AI agent to initiate a large wire transfer that exceeds the risk threshold, the system would normally send a CIBA approval request to the user's second enrolled device such as their tablet. However, because the system detected the duress authentication via the panic PIN entry, the CIBA approval request is instead silently re-routed to the user's pre-registered emergency contact, such as a spouse, trusted colleague, or corporate security team, who receives the approval request on their own device and can immediately recognize that something is wrong because they did not initiate this transaction, deny the approval to block the fraudulent transfer, and alert authorities using the GPS coordinates and forensic metadata that were transmitted when the duress session began - all while the attacker sees what appears to be a pending approval request and remains unaware that the request was never delivered to any device they could access or coerce the user to approve.

In an embodiment, with respect to the deepfake defense, the user device 102 is designated as a sole recovery authority for an associated user account. In responsive to loss of the user device 102, re-establishment of access requires re-registration based on physical identity verification. Each security-critical operation is authorized exclusively based on cryptographic verification of one or more cryptographic proofs generated by the user device 102. In an embodiment, authorization of a security-critical operation requires validation of a cryptographic signature, successful completion of a cryptographic challenge, and verification of possession of an enrolled physical device, thereby preventing execution of the security-critical operation by synthetic media, impersonation artifacts, or other non-device-based authentication attempts.

The deepfake defense feature is a security architecture wherein the user device 102 is designated as the sole recovery authority for an associated user account, each security-critical operation is authorized exclusively based on cryptographic verification of proofs generated by the user device 102, and authorization requires validation of a cryptographic signature, successful completion of a cryptographic challenge, and verification of possession of an enrolled physical device, thereby preventing execution of security-critical operations by synthetic media, impersonation artifacts, or other non-device-based authentication attempts. The defense is architectural, not perceptual i.e., the system does not try to build a better deepfake detector but instead eliminates the steps where deepfake detection is the security mechanism.

Deepfakes are a real threat in account recovery flows involving a human reviewer or video verification check, remote enrollment where a human confirms identity before issuing a registration credential, customer support interactions where access is granted based on visual identification, and CIBA approval steps that use video or phone call confirmation rather than cryptographic device proof. The architecture addresses this by implementing the following measures: (a) no account recovery flow exists, and loss of device requires re-registration with physical identity verification - no video check, no human reviewer, no deepfakeable step; (b) enterprise enrollment happens in person with HR where the identity check is physical document verification by a trained person, not a video call with a remote agent; (c) CIBA approvals for high-stakes agent actions require a cryptographic signature from a second enrolled device, and a deepfake cannot produce a valid cryptographic signature; and (d) no human-reviewable step exists in any security-critical flow, and where human judgment was previously required, cryptographic proof now substitutes. The core principle is that a deepfake can fool a human reviewer, but a deepfake cannot produce a valid Ed25519 signature, solve a cryptographic challenge, or present a physical enrolled device - every step moved from human-reviewable to cryptographic is a step that deepfakes cannot attack.

If a device is lost, there is no account recovery flow, and the user re-registers because every recovery mechanism is an attack surface and eliminating recovery eliminates the attack surface; agent policy configurations are retained server-side and re-associated with the newly enrolled device after re-registration completes. For example, if an attacker creates a sophisticated deepfake video of a legitimate user and attempts to use it to recover access to the user's account through a video verification call, the attack fails completely because no such video verification pathway exists in the system - the only way to regain access after losing a device is to complete full re-registration with physical identity verification, such as presenting a government-issued passport in person to an HR officer for enterprise users or completing document verification with NFC passport chip cryptographic signature verification for consumer users. Similarly, if the attacker attempts to use the deepfake to approve a high-stakes AI agent action that would normally require CIBA confirmation, the attack fails because CIBA approval requires a cryptographic signature from a second enrolled physical device that has independently completed biometric authentication, and no amount of video manipulation can produce the valid Ed25519 cryptographic signature that only the physical hardware security module of the enrolled device can generate - the system has architecturally eliminated every pathway where a deepfake could succeed by replacing human visual judgment with mathematical cryptographic verification that synthetic media fundamentally cannot satisfy.

The plurality of subsystems 108 further includes the agent authorizing subsystem 238 that is communicatively connected to the one or more hardware processors 204. The agent authorizing subsystem 238 is configured to, upon successful authentication, derive cryptographic keys assigned to each AI agent from the master cryptographic key using the deterministic key derivation function. Each cryptographic key assigned to each AI agent is cryptographically isolated, whereby access to credentials of one AI agent provide no information regarding credentials of other AI agents.

The agent authorizing subsystem 238 is a software component configured to derive unique cryptographic keys for each AI agent from a master cryptographic key that is released upon successful biometric authentication of the human user. The master cryptographic key serves as the root of trust from which all AI agent identities are mathematically derived, establishing an unbroken chain of authorization that links every agent action back to the verified human identity. Upon successful authentication, the master cryptographic key is released from the verified human's identity, and per-agent keys are mathematically derived from the master key using a deterministic key derivation function. This deterministic key derivation function ensures that each AI agent receives a unique cryptographic identity that is mathematically linked to the human owner's master key while remaining cryptographically isolated from all other agent keys. Each agent has a cryptographically isolated identity, meaning that compromising one agent reveals nothing about any other agent's credentials. The cryptographic isolation property ensures that even if an attacker successfully compromises one AI agent and extracts its cryptographic credentials, the attacker gains no mathematical advantage in attacking any other AI agent owned by the same user, as the derivation function produces outputs that are computationally independent despite sharing a common root. No agent can operate without the chain beginning with the verified human, and revoking the human's access causes every agent the human owns to be immediately locked out. This immediate revocation capability is a direct consequence of the hierarchical key derivation architecture - when the master key is invalidated, all derived agent keys become simultaneously unusable without requiring explicit per-agent revocation commands. For example, when a user successfully authenticates using their biometric on their enrolled device, the hardware security module releases the master cryptographic key. The agent authorizing subsystem 238 then applies the deterministic key derivation function to generate unique cryptographic identities for each of the user's AI agents, such as a financial assistant agent, a calendar management agent, and a document processing agent. Each agent receives its own derived key that enables it to sign authorization tokens and prove its identity to service providers, but if the user's account is compromised or the user chooses to revoke access, invalidating the master key instantly renders all three agent keys unusable, immediately locking out every agent without the need to individually revoke each one, and if an attacker somehow extracts the financial assistant agent's derived key, that compromised key provides absolutely no information that would help the attacker derive or guess the keys assigned to the calendar or document processing agents.

The agent authorizing subsystem 238 is further configured to, for each action requested by an AI agent, generate the single-use authorization token encoding the permitted tool or service the AI agent is permitted to call, the authorized data scope, the action constraints, and the trust tier. The single-use authorization token is atomically consumed upon first use, rendering the single-use authorization token unavailable for replay.

The single-use authorization token is a cryptographic credential generated uniquely for each individual action requested by an AI agent, encoding precisely scoped permissions that specify exactly which tool or service the AI agent is permitted to call, the authorized data scope, action constraints including maximum amounts, row limits, and time windows, and a trust tier ranging from T0 read-only through T3 full execution with human confirmation. Every action an agent takes requires its own unique authorization token, valid for that one call only, and the token encodes exactly which tool or service the agent is permitted to call, exactly what data scope is authorized, constraints on the action such as maximum amount, row limit, and time window, and the trust tier. The token is single-use, encrypted, and verified in under 400 microseconds with no network calls at runtime, meaning that once the token is consumed upon first use, it is atomically marked as used and rendered permanently unavailable for replay, preventing any attacker who intercepts or steals the token from reusing it for subsequent unauthorized actions. A stolen token cannot be replayed, and a compromised agent cannot escalate its own permissions because the token's scope is pre-signed by a policy engine rather than being settable by the agent itself.

The atomic consumption mechanism ensures that even if an attacker captures network traffic containing a valid authorization token, attempting to replay that token will fail because the authentication system maintains a record of consumed tokens and rejects any duplicate usage attempts. For example, when a user's financial assistant AI agent needs to check the user's bank account balance, the agent authorizing subsystem 238 generates a single-use authorization token that encodes permission to call only the specific bank API balance inquiry endpoint, limits the data scope to read-only access for that user's accounts, constrains the action to retrieve no more than the current balance without modification capabilities, and assigns a trust tier of T1 allowing automated read operations. The agent presents this token to the bank's API, which verifies the token's cryptographic signature and scope in under 400 microseconds, executes the balance inquiry, and atomically marks the token as consumed. If an attacker intercepts this token from network traffic and attempts to replay it even milliseconds later to perform another balance check or escalate to a fund transfer operation, the authentication system immediately rejects the replayed token because it has already been consumed, and the token's encoded constraints prevent any operation beyond the originally authorized balance inquiry, thereby ensuring that each AI agent action requires fresh cryptographic authorization that cannot be reused, replayed, or escalated by malicious actors.

The agent authorizing subsystem 238 is further configured to, for AI agent actions above a configurable risk threshold, require the cryptographic signature from the second enrolled device that has independently completed biometric authentication. The notification tap, video confirmation, or voice confirmation is insufficient to satisfy the requiring.

The cryptographic signature requirement from a second enrolled device is a security mechanism that mandates an independently authenticated cryptographic approval from a separate physical device before permitting AI agent actions that exceed a configurable risk threshold, explicitly rejecting weaker confirmation methods such as notification taps, video confirmations, or voice confirmations as insufficient authorization. For actions above a configurable risk threshold, the agent cannot proceed without a cryptographic approval from a second device, and this is called CIBA (Client-Initiated Backchannel Authentication). The mechanism functions by intercepting high-stakes action requests from AI agents and routing a confirmation request to the account owner's second enrolled device, where the owner reviews and approves or denies using biometric authentication on that device, and critically, the approval is a cryptographic signature, not a tap on a notification.

The agent receives the signed approval before the action executes. This constitutes a genuinely independent gate because an attacker who has the primary device and has coerced the user into authenticating still cannot approve high-stakes actions without the second device, and the two devices must both be physically present and authenticated independently. The specific construction requires the approval to be a cryptographic Ed25519 signature produced by an independently authenticated second device, where that signature is a prerequisite for minting a high-stakes AI agent action token, and the system explicitly specifies that a notification tap, video confirmation, or voice confirmation is explicitly insufficient - only a device-bound cryptographic signature satisfies the gate. The property that an attacker controlling the primary device cannot authorize high-stakes agent actions without physical possession and independent authentication of the second enrolled device provides defense against both remote attackers and physical coercion scenarios.

A deepfake cannot produce a valid cryptographic signature, which is why this mechanism provides architectural protection against sophisticated impersonation attacks. For example, when a user's financial AI agent attempts to initiate a wire transfer of ten thousand dollars, which exceeds the configured risk threshold, the agent authorizing subsystem 238 intercepts the request and sends a CIBA confirmation request to the user's second enrolled device such as a tablet. The user receives the request on the tablet, reviews the transaction details, and authenticates using the tablet's biometric sensor which triggers the tablet's hardware security module to generate an Ed25519 cryptographic signature over the transaction details. This signature is transmitted back to the authentication server 104 which verifies the signature against the second device's registered public key. Only upon successful verification of this cryptographic signature does the agent authorizing subsystem 238 mint the authorization token permitting the wire transfer to execute - if an attacker has compromised the user's primary smartphone and is attempting to authorize fraudulent transfers, the attacker cannot complete the transaction because they lack physical possession of the second enrolled tablet and cannot produce a valid cryptographic signature without the tablet's hardware-bound private key, and no amount of deepfake video, voice impersonation, or intercepted notification taps can substitute for the mathematically verifiable cryptographic proof that only the physical second device can generate.

The agent authorizing subsystem 238 is further configured to, upon execution of each AI agent action, generate the bilateral cryptographic receipt comprising the authorization signature from the user and the execution signature from the service provider. The bilateral cryptographic receipt is independently verifiable by the third party without access to the session keys.

The bilateral cryptographic receipt is a dual-signature digital record generated upon execution of each AI agent action, comprising an authorization signature from the human user and an execution signature from the service provider, wherein both signatures are independently verifiable by any third party without requiring access to session keys or confidential authentication material. After every agent action, both parties sign a receipt: the user's authorization signature confirms that the specific verified human authorized this action, and the service provider's execution signature confirms that the service executed exactly that action. The bilateral receipt mechanism functions by capturing two distinct cryptographic proofs at the moment of action execution: first, the authorization signature is generated using the human account owner's cryptographic key that is anchored to their hardware-bound biometrically-verified identity, establishing cryptographic proof of human intent rather than merely application-level authorization; second, the execution signature is generated by the service provider's cryptographic key, confirming the precise action that was performed in response to the authorization.

An independent third party can verify both signatures without access to any session keys, which creates audit-grade evidence for every agent action, not just a server log, and the record cannot be altered retroactively by either party. This bilateral structure ensures non-repudiation from both directions - the user cannot deny having authorized an action they cryptographically signed, and the service provider cannot deny having executed an action they cryptographically acknowledged. The independent verifiability property means that auditors, regulators, dispute resolution bodies, or any other third party can mathematically confirm the authenticity of both signatures using only the public keys of the respective parties, without needing access to the private session keys, temporary authentication tokens, or any other confidential material that was used during the original transaction.

For example, when a user's financial AI agent executes a wire transfer of five thousand dollars, the agent authorizing subsystem 238 generates a bilateral cryptographic receipt at the moment of execution: the receipt contains the user's authorization signature created using their hardware-bound identity key that was released upon successful biometric authentication, cryptographically proving that this specific verified human authorized this specific wire transfer with these specific parameters. Simultaneously, the bank's service provider system generates its execution signature over the transaction details, cryptographically confirming that the bank executed a wire transfer of exactly five thousand dollars to the specified recipient account. If a dispute later arises where the user claims they never authorized the transfer or the bank claims the user requested a different amount, any independent auditor can retrieve the bilateral receipt, verify the user's authorization signature against their registered public key to confirm the user did authorize exactly this transaction, and verify the bank's execution signature against the bank's public key to confirm the bank executed exactly this transaction - all without needing access to any session keys, temporary tokens, or confidential authentication data that existed only during the original transaction, thereby providing irrefutable cryptographic evidence that resolves the dispute based on mathematical proof rather than competing claims or server logs that either party could potentially manipulate.

FIG. 2C is an interface view depicting a cryptographic bridge between the users and AI agents, in accordance with another embodiment of the present disclosure.

The interface diagram illustrates the cryptographic bridge architecture that connects two distinct operational domains: the Human world and the Agent world. For the first time, the human identity and AI agents share the same root of trust. At the center of the diagram is the core principle that human identity becomes the agent's key, representing the cryptographic root from which all agent credentials are derived. The human identity becomes the Agent's key. The system authenticates the human once. Every agent they own derives its credentials from that verified identity. The system revokes the human and every agent locks out instantly.

On the Human world side, three functional components are displayed. The first component is identity registration, which is verified once at enrollment. The enterprise users verify via HR with the government-issued document. The consumer users verify via live selfie matched against a government ID. No OTP. No SMS. No secret is transmitted. The second component is authentication, where biometrics tied to tamper-resistant device hardware. No secret of any kind crosses the network such as not a password, not a biometric hash, not a private key. A zero-knowledge proof verifies the person mathematically. The third component is device protection, where new biometric enrollment triggers permanent app self-destruct. Coercion triggers a silent distress mode i.e., agents capped read-only, GPS alert fired, every attacker action forensically logged.

On the Agent world side, three corresponding functional components are displayed. The first component is agent credentials, where each agent's identity is derived uniquely from the owner's master key. Compromise one agent may lead to learn nothing about any other. The system revokes the human and all agent credentials are instantly invalidated. The second component is single-use token, where every action requires its own cryptographic token valid for that call only. The system encodes exactly which tool, data, and constraints apply. The system the token's cryptographic signature and scope in under 400 microseconds. The stolen token cannot be replayed or escalated. The third component is bilateral receipt, where every action generates two signatures - the human's authorization and the service provider's execution. Those signatures are independently verifiable by any third party without session key access.

The interface diagram indicates that existing platforms such as Okta and Auth0 operate only within the human authentication domain, while agent platforms such as Composio, Merge, and Oasis operate only within the agent domain. No existing platform connects human identity to agent execution. That gap may be an attack surface. The architecture addresses this gap by providing a unified cryptographic connection between human identity verification and agent credential management, ensuring that the cryptographic bridge spans both worlds through a single root of trust.

FIG. 3 is a flow chart 300 illustrating a registration/signup process for the authentication between the one or more user devices 102 and the one or more authentication servers 104, in accordance with an embodiment of the present disclosure. The detailed explanation for the registration/signup process for the authentication between the one or more user devices 102 and the one or more authentication servers 104, is given in the above said alternative embodiments (e.g., signup steps in the method 1).

FIG. 4 is a flow chart 400 illustrating a logging in process for the authentication between the one or more user devices 102 and the one or more authentication servers 104, in accordance with an embodiment of the present disclosure. The detailed explanation for the logging in process for the authentication between the one or more user devices 102 and the one or more authentication servers 104, is given in the above said alternative embodiments (e.g., login steps in the method 1).

FIG. 5 is a flow chart 500 illustrating a registration/signup process for the authentication between the one or more user devices 102 and the one or more authentication servers 104 based on one or more device fingerprints, in accordance with an embodiment of the present disclosure. The detailed explanation for the registration/signup process for the authentication between the one or more user devices 102 and the one or more authentication servers 104, is given in the above said alternative embodiments (e.g., signup steps in the method 2).

FIG. 6 is a flow chart 600 illustrating a logging in process for the authentication between the one or more user devices 102 and the one or more authentication servers 104 based on the one or more device fingerprints, in accordance with an embodiment of the present disclosure. The detailed explanation for the logging in process for the authentication between the one or more user devices 102 and the one or more authentication servers 104, is given in the above said alternative embodiments (e.g., login steps in the method 2).

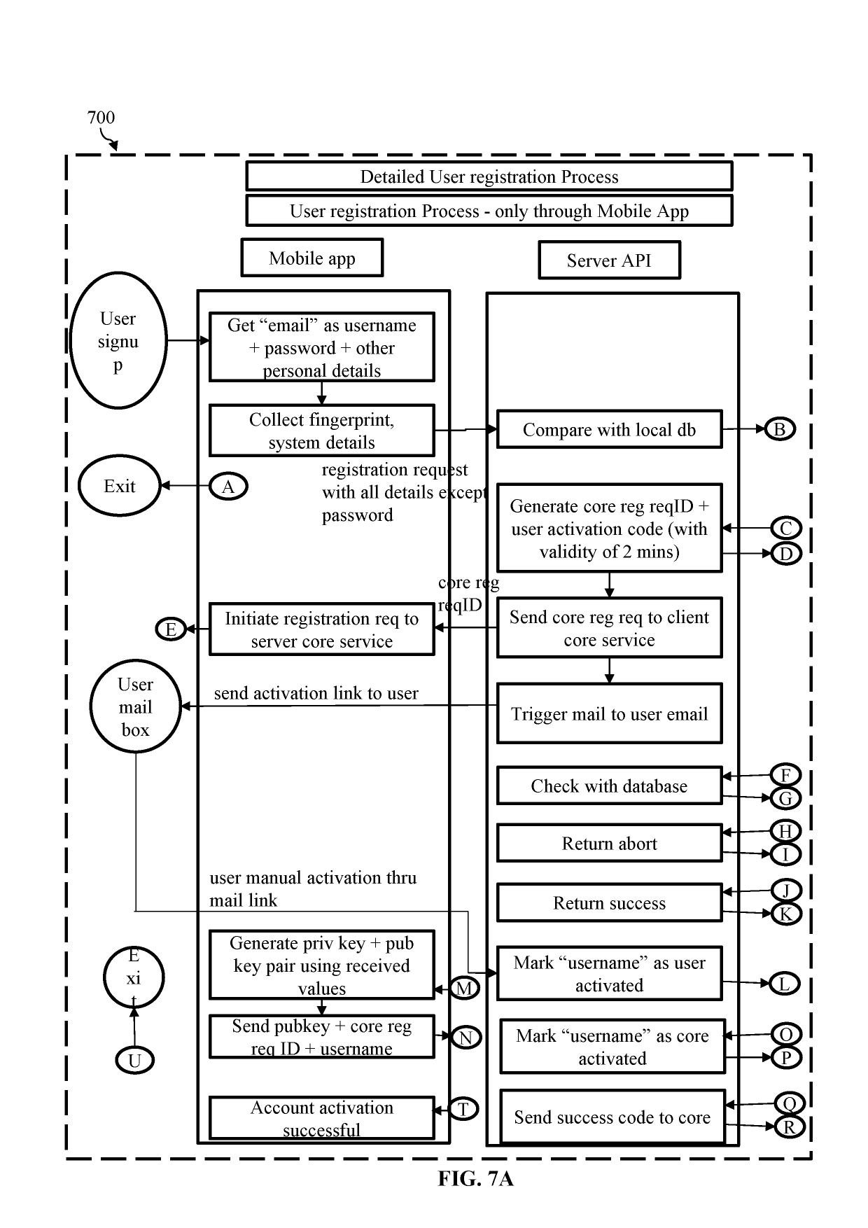

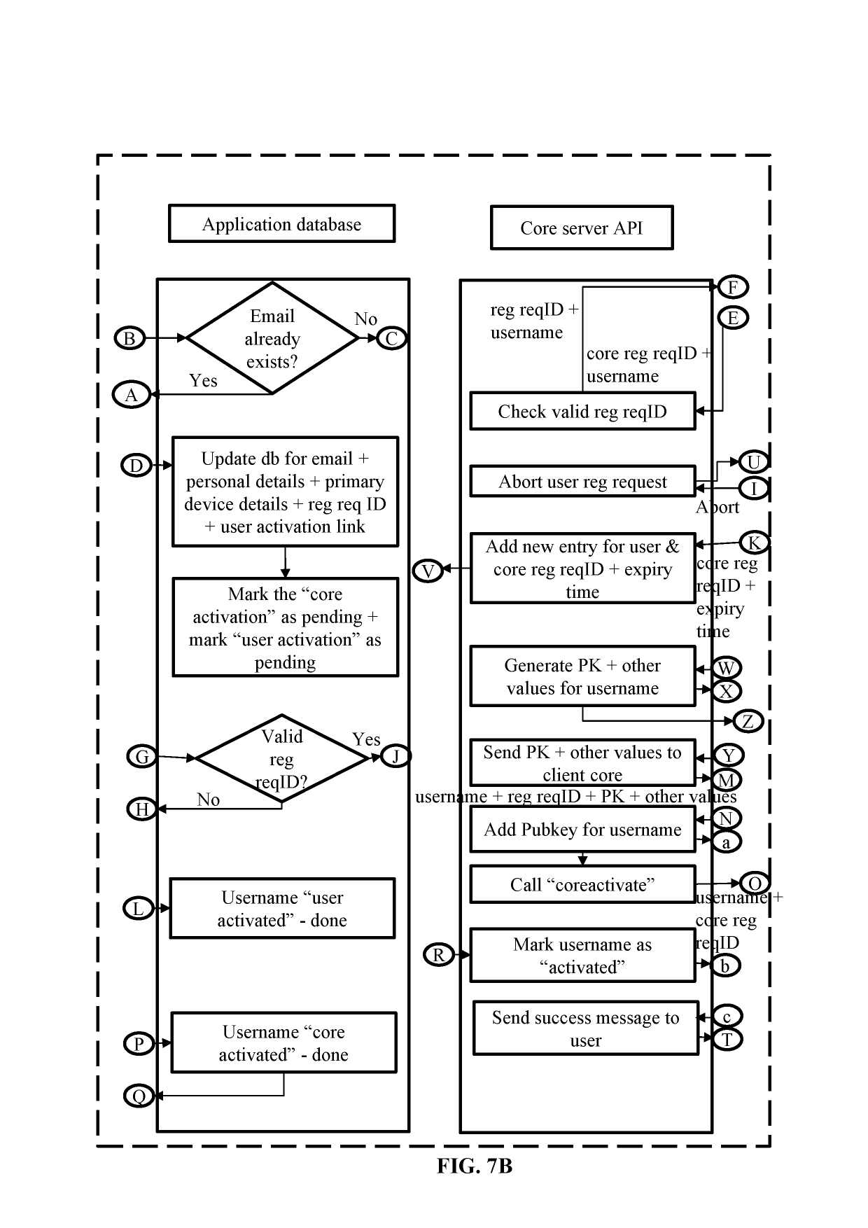

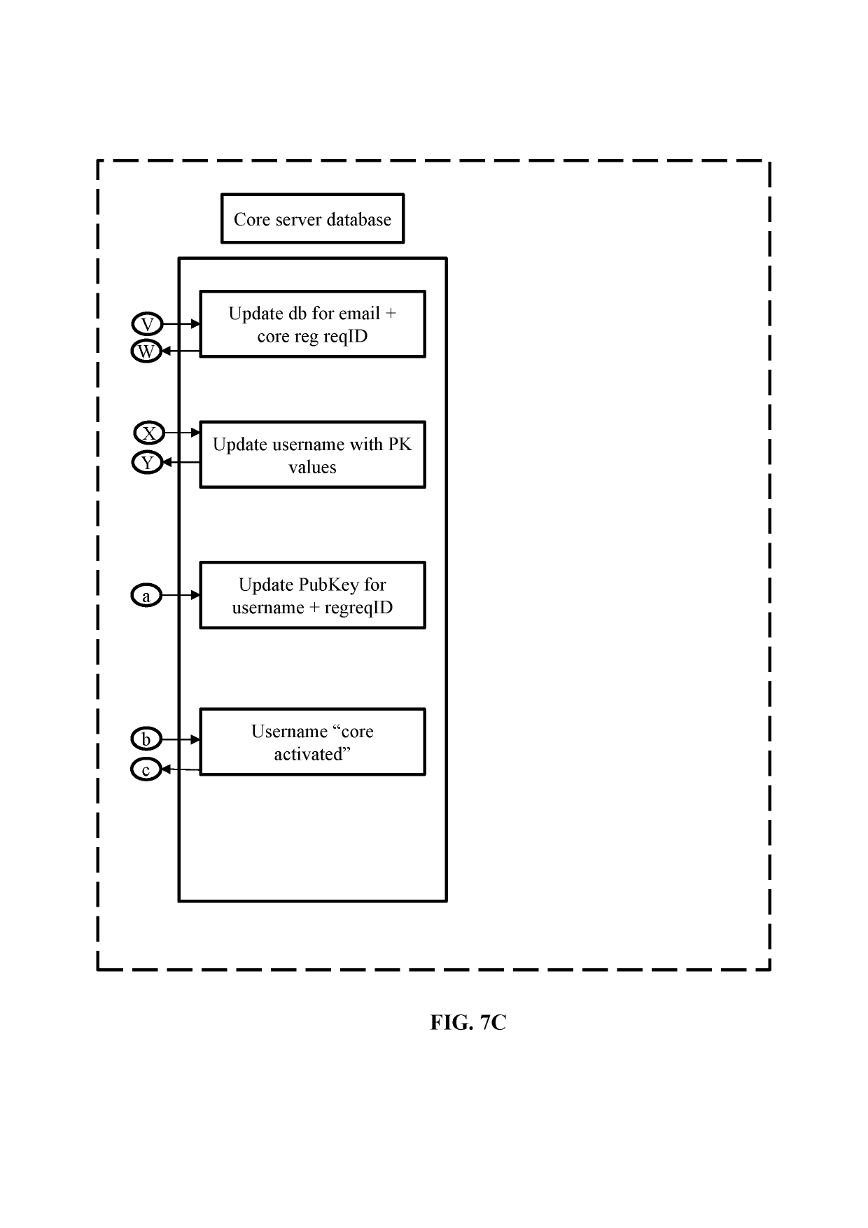

FIG. 7A-7C is a process flow 700 of a user registration process for the authentication between the one or more user devices 102 and the one or more authentication servers 104, through one or more applications, in accordance with an embodiment of the present disclosure. The mobile application of the user device 102 may obtain the user credentials (e.g., the emails, password, and other personal details) from the users. The mobile application of the user device 102 may further collect fingerprints and system details. The authentication server API may compare the user information in a local database. The authentication server 104 checks whether the email already exists. If no, the authentication server 104 generates core registration request identity (ID) with user activation code, which enables the user device 102 to initiate registration request to the server core service.

The core server API may check a valid registration request ID. The authentication server 104 may check the registration request ID with the user information to check the valid registration request ID in the application database. If valid, the core server API may add new entry for user and core registration request ID along with expiry time. The core server database may be updated for email and core registration request ID and also updated with username and primary kay values, which are then sent to client core service. The client core or the mobile application may generate private key and public key pair using the received values associated with the private keys. The mobile application of the user device 102 may send the public key and core registration request ID with the user name to the core server API for adding the public key for the user name. In an embodiment, the public key, the user name, and the registration request ID are updated in the core server database. The core server API may activate the core registration request ID and the user name to mark the user name as core activated. Once the core activation is done, the success code is sent to the core server API to activate the user name and the user name is updated in the core server database. The core server API may send the success message to the user device 102.

In FIG. 7A-7C, the circular symbols with “A-Z and a-c” written inside are being used as off-page connectors. These are used for indicating that FIG. 7A continues to the subsequent pages as FIG. 7C.

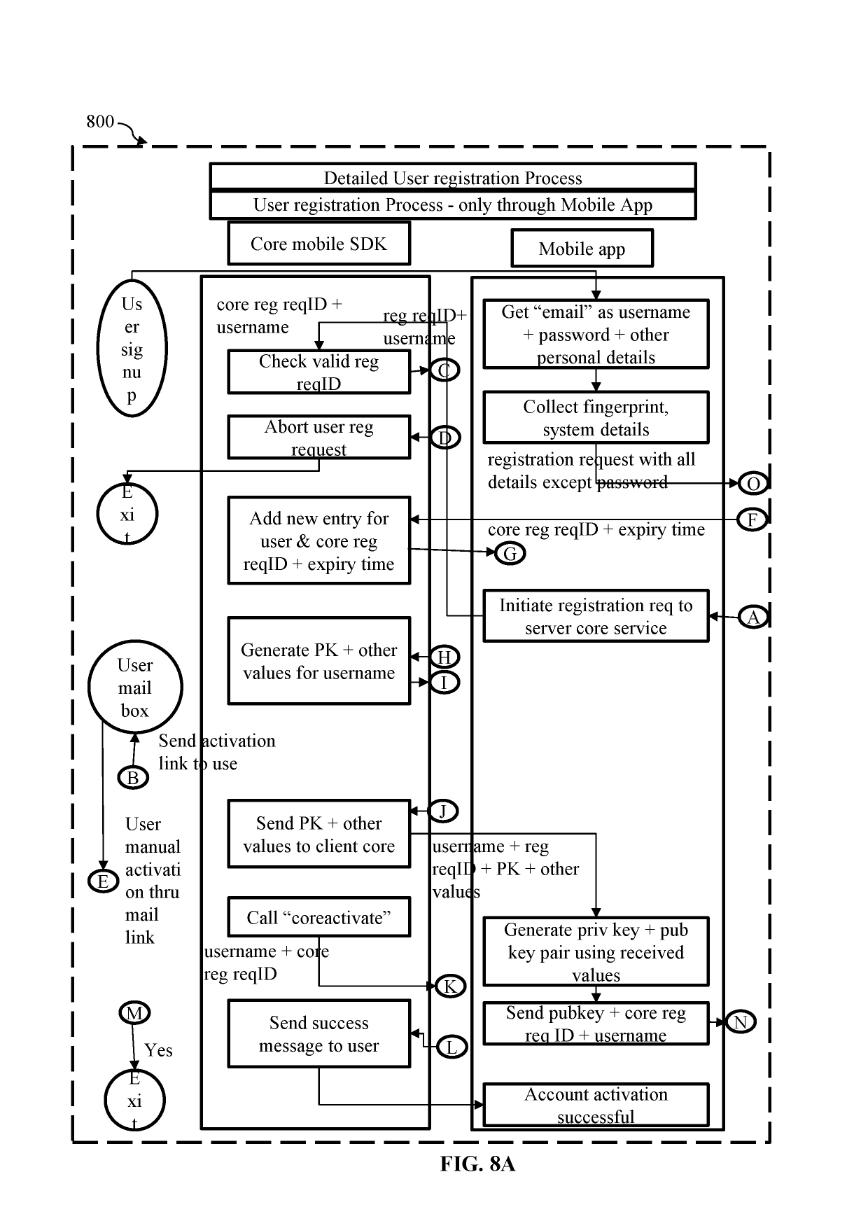

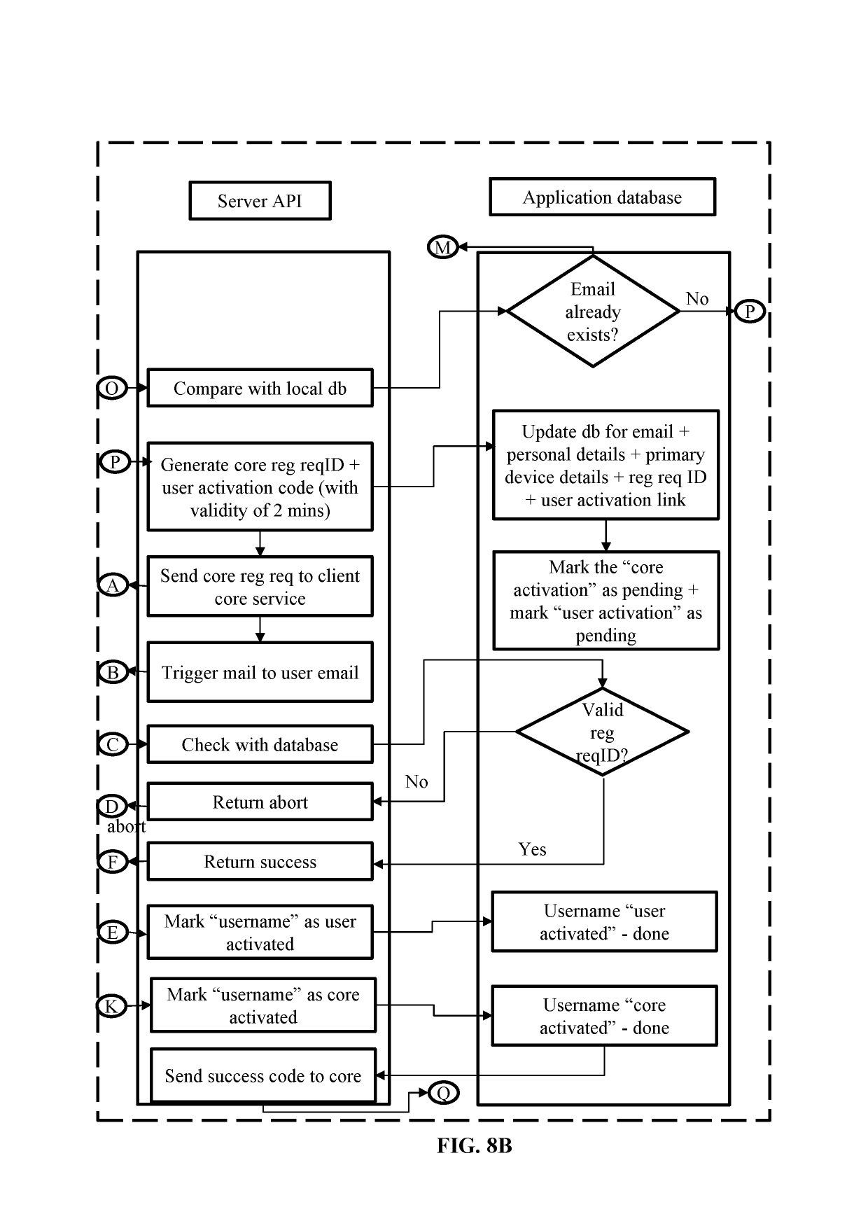

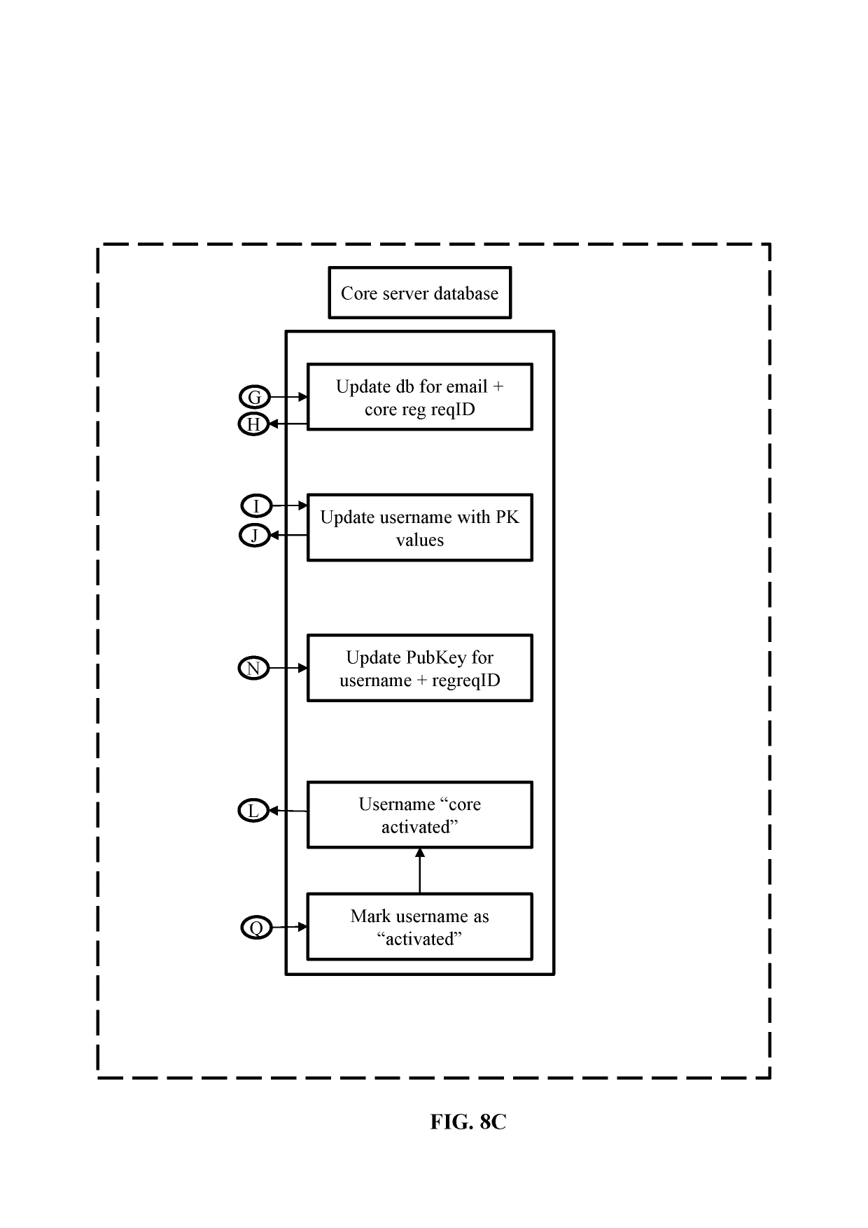

FIG. 8A-8C is a process flow 800 of the user registration process for the authentication between the one or more user devices 102 and the one or more authentication servers 104, through one or more applications, in accordance with an embodiment of the present disclosure. The mobile application of the user device 102 may obtain the user credentials (e.g., the emails, password, and other personal details) from the users. The mobile application of the user device 102 may further collect the fingerprints and the system details. The authentication server API may compare the user information in the local database. The authentication server 104 checks whether the email already exists. If no, the authentication server 104 generates core registration request identity (ID) with user activation code, which enables the user device 102 to initiate registration request to the server core service.

The core mobile SDK may check a valid registration request ID. The authentication server 104 may check the registration request ID with the user information to check the valid registration request ID in the application database. If valid, the core server API may add new entry for user and core registration request ID along with expiry time. The core server database may be updated for email and core registration request ID and also updated with username and primary kay values, which are then sent to core mobile SDK. The client core or the mobile application may generate private key and public key pair using the received values associated with the private keys. The mobile application of the user device 102 may send the public key and core registration request ID with the user name to the core server database. In an embodiment, the public key, the user name, and the registration request ID are updated in the core server database. The core mobile SDK may activate the core registration request ID and the user name to mark the user name as core activated. Once the core activation is done, the success code is sent to the core server API to activate the user name and the user name is updated in the core server database. The core mobile SDK may send the success message to the user device 102.

In FIG. 8A-8C, the circular symbols with “A-Q” written inside are being used as off-page connectors. These are used for indicating that FIG. 8A continues to the subsequent pages as FIG. 8C.

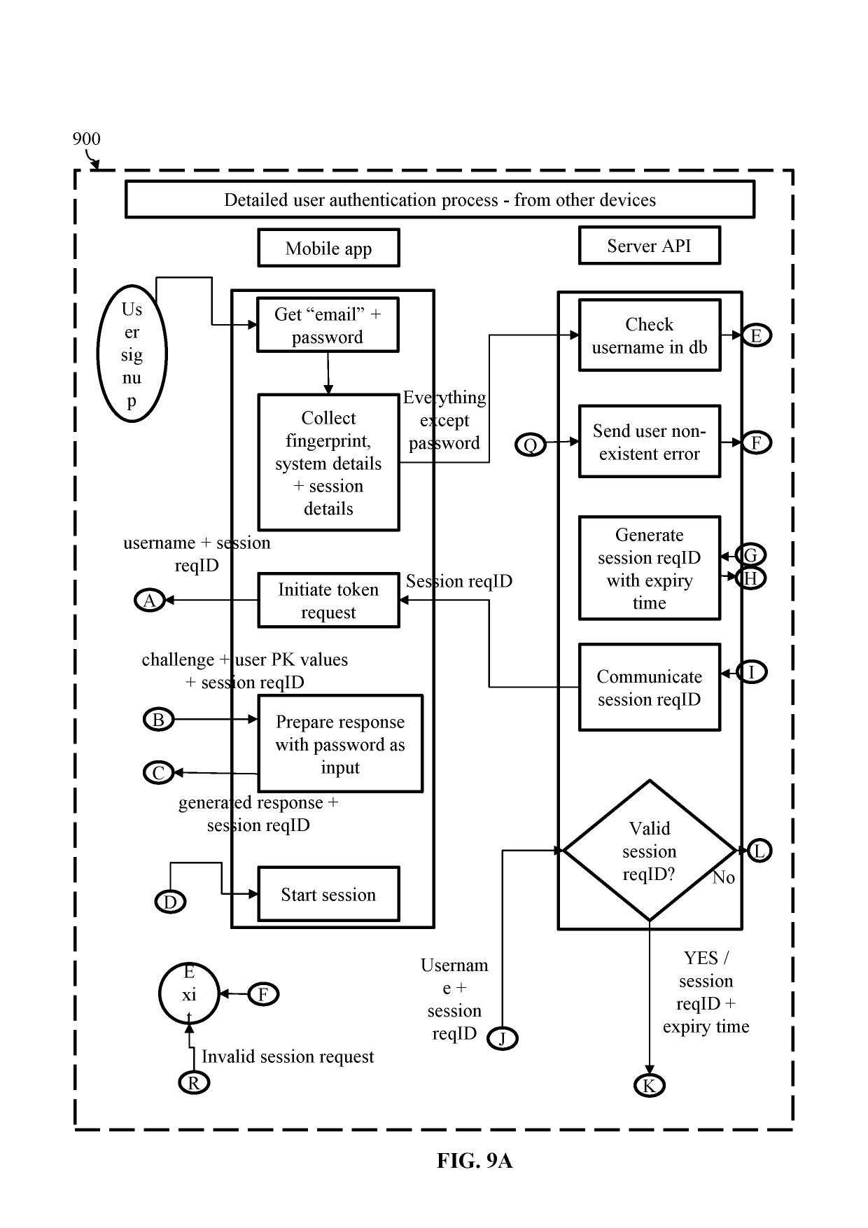

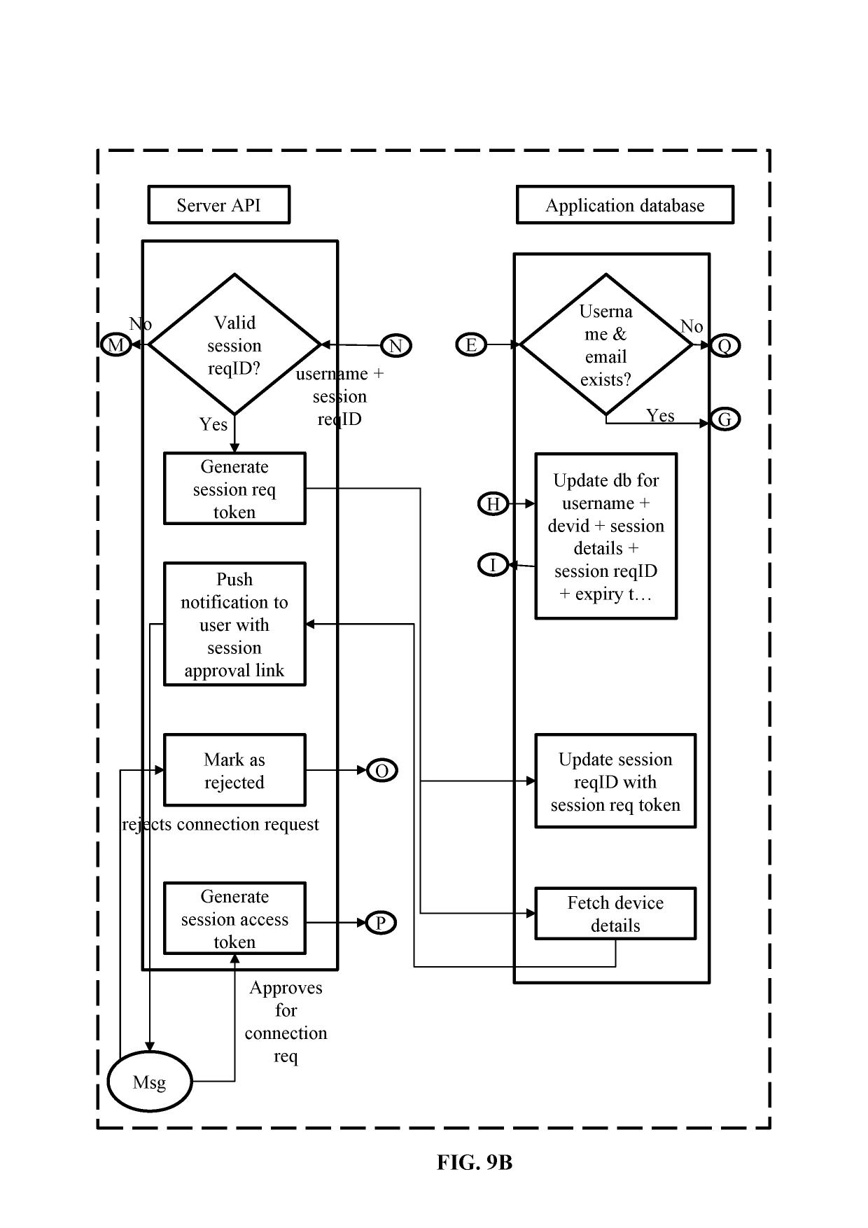

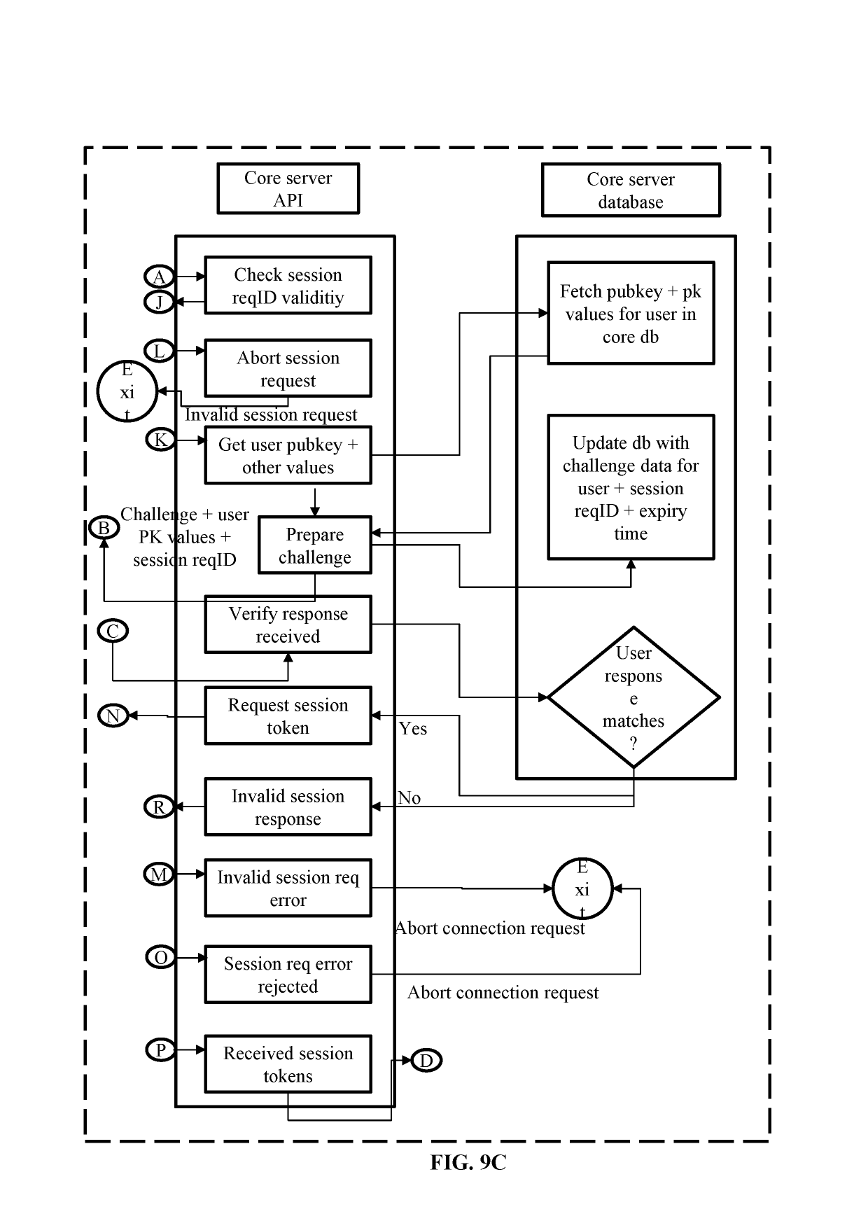

FIG. 9A-9C is a process flow 900 of the user registration process for the authentication between the one or more user devices 102 and the one or more authentication servers 104, through one or more devices, in accordance with an embodiment of the present disclosure. The mobile application of the user device 102 may obtain the user credentials (e.g., the emails, password, and other personal details) from the users. The mobile application of the user device 102 may further collect the fingerprints, the system details, and session details. The authentication server API may compare the user information in the local database. The authentication server 104 checks whether the email already exists. If no, the authentication server 104 generates session request identity (ID) with expiry time, which enables the application database to update the user name, session details, devid, session request ID, and expiry time. The authentication server 104 communicates the session request ID to the mobile application of the user device 102 to initiate a token request.

The core server API may check for a valid session request ID. The authentication server 104 may check the session request ID with the user information to check the valid registration request ID in the application database. If valid, the core server API may obtain user public key with other values. The core server database may fetch the public key with primary key values for the user in core database. The core server API may prepare challenge based on the public key and other primary key values. The core server API may send the challenge, primary key values and the session request ID to the mobile application of the user device 102 to enable the user device 102 to prepare response with password as an input. The core server API receives the response and verifies the response at the core server database. If matches, the core server API requests the session token to the authentication server 104 and the authentication server 104 may check the validity of the session request ID. If yes, the authentication server 104 may generate session request token and fetch the device information from the application database. The authentication server 104 may push a notification to the user device 102 with the session approval link, as messages. The authentication server 104 may generate the session access token and send the session access token to the core server API to enable the user device 102 to start the session.

In FIG. 9A-9C, the circular symbols with “A-R” written inside are being used as off-page connectors. These are used for indicating that FIG. 9A continues to the subsequent pages as FIG. 9C.

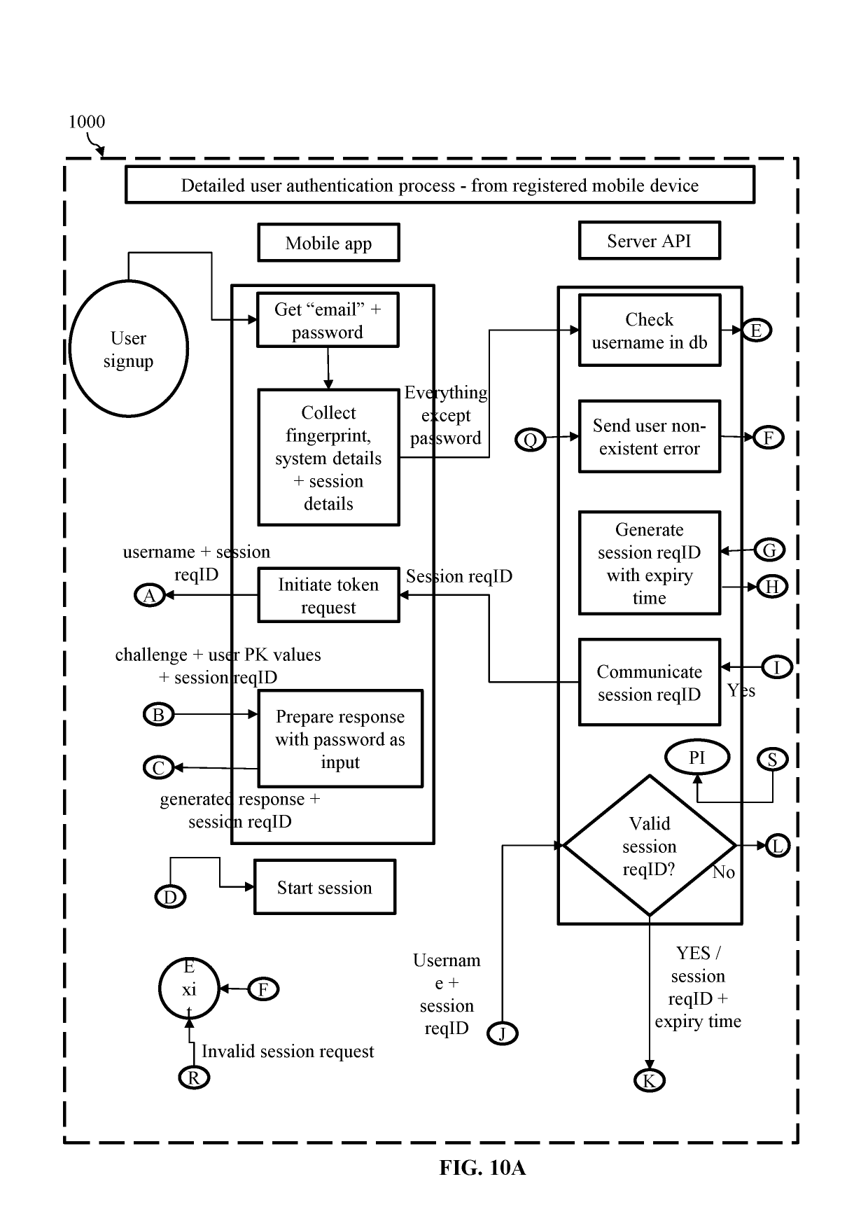

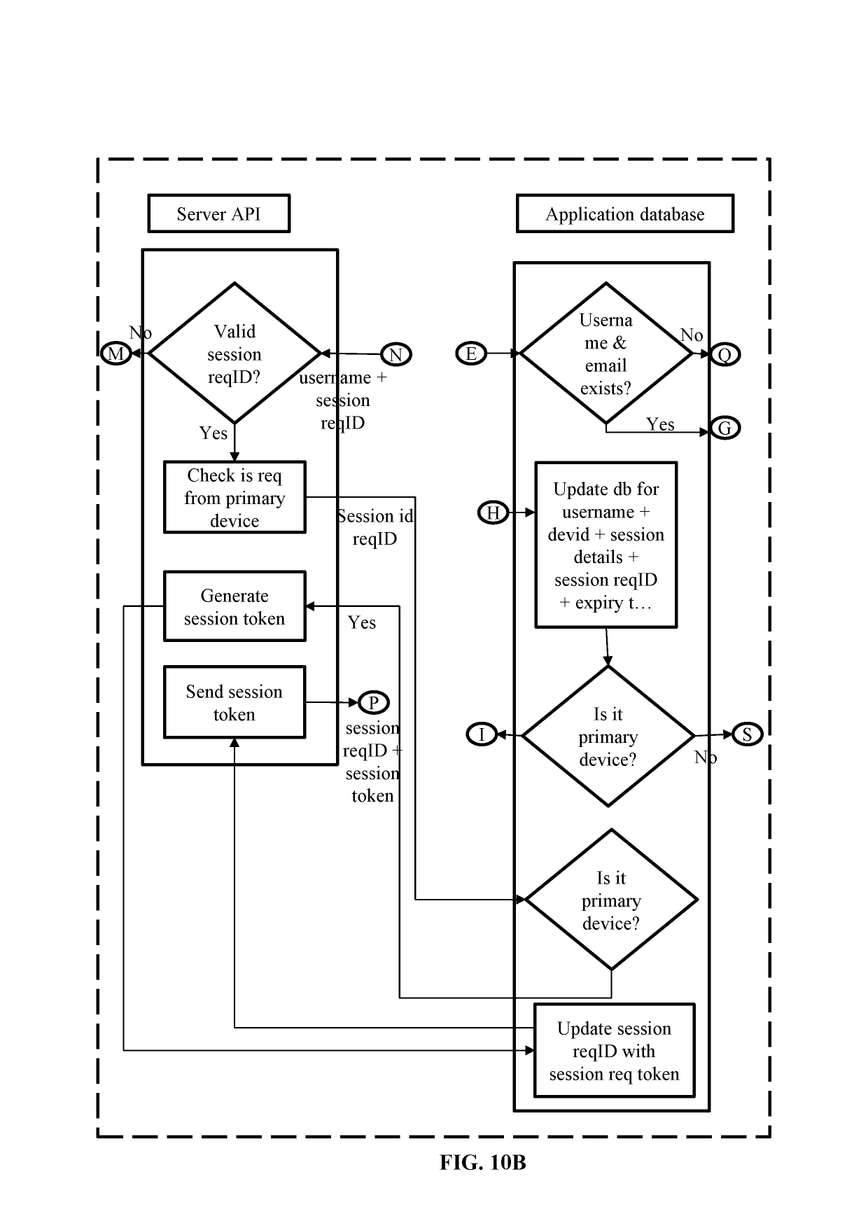

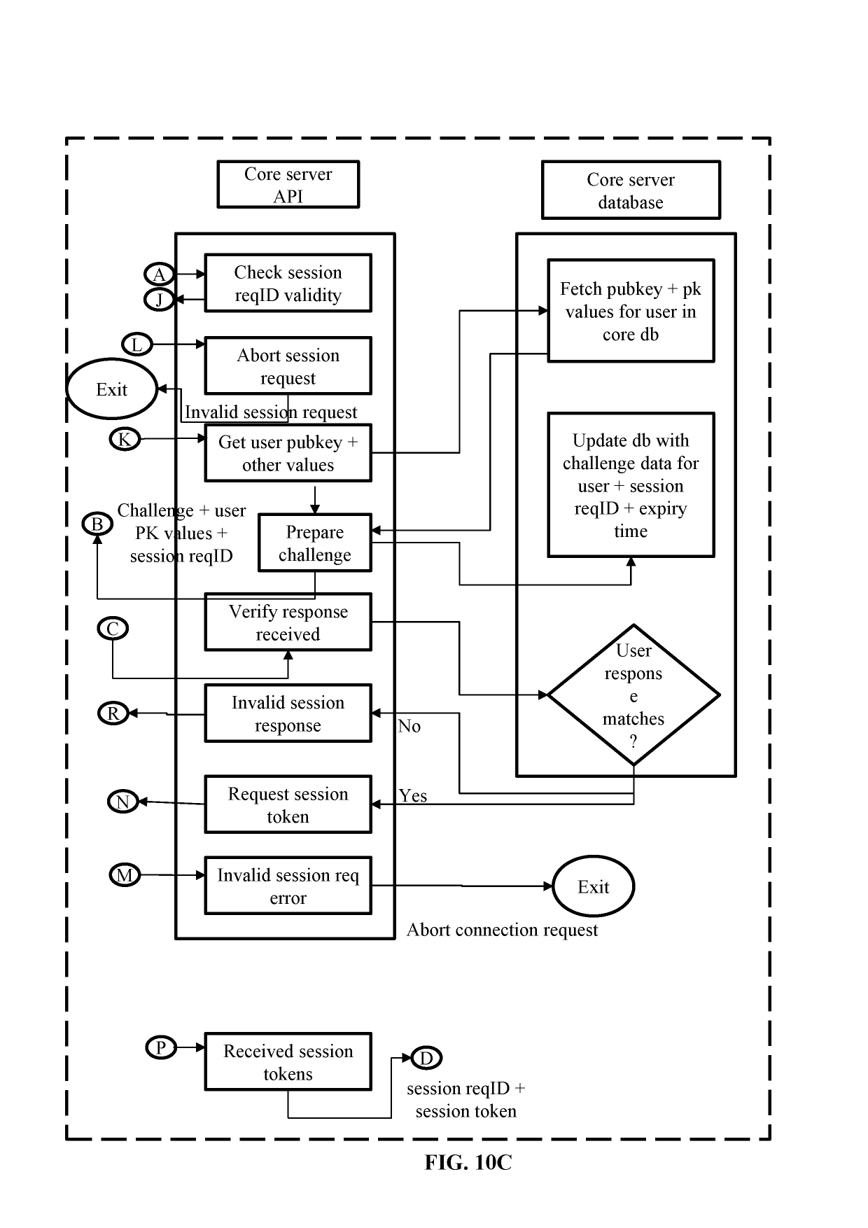

FIG. 10A-10C is a process flow 1000 of the user registration process for the authentication between the one or more user devices 102 and the one or more authentication servers 104, through one or more registered user devices, in accordance with an embodiment of the present disclosure. The mobile application of the user device 102 may obtain the user credentials (e.g., the emails and the password) from the users. The mobile application of the user device 102 may further collect the fingerprints, the system details, and the session details. The authentication server API may compare the user information in the local database. The authentication server 104 checks whether the email already exists. If no, the authentication server 104 generates the session request identity (ID) with expiry time, which enables the application database to update the user name, session details, devid, session request ID, and expiry time. The application database again checks whether it is a primary device. If yes, the authentication server 104 communicates the session request ID to the mobile application of the user device 102 to initiate a token request.

The core server API may check for a valid session request ID. The authentication server 104 may check the session request ID with the user information to check the valid registration request ID in the application database. If valid, the core server API may obtain user public key with other values. The core server database may fetch the public key with primary key values for the user in core database. The core server API may prepare challenge based on the public key and other primary key values. The core server API may send the challenge, primary key values and the session request ID to the mobile application of the user device 102 to enable the user device 102 to prepare response with password as an input. The core server API receives the response and verifies the response at the core server database. If matches, the core server API requests the session token to the authentication server 104 and the authentication server 104 may check the validity of the session request ID. If yes, the authentication server 104 may check whether it is the primary device. If yes, then the authentication server 104 generates session request token and updates the session request ID with the session request token at the application database. The authentication server 104 may send the session access token to the core server API to enable the user device 102 to start the session.

In FIG. 10A-10C, the circular symbols with “A-S” written inside are being used as off-page connectors. These are used for indicating that FIG. 10A continues to the subsequent pages as FIG. 10C.

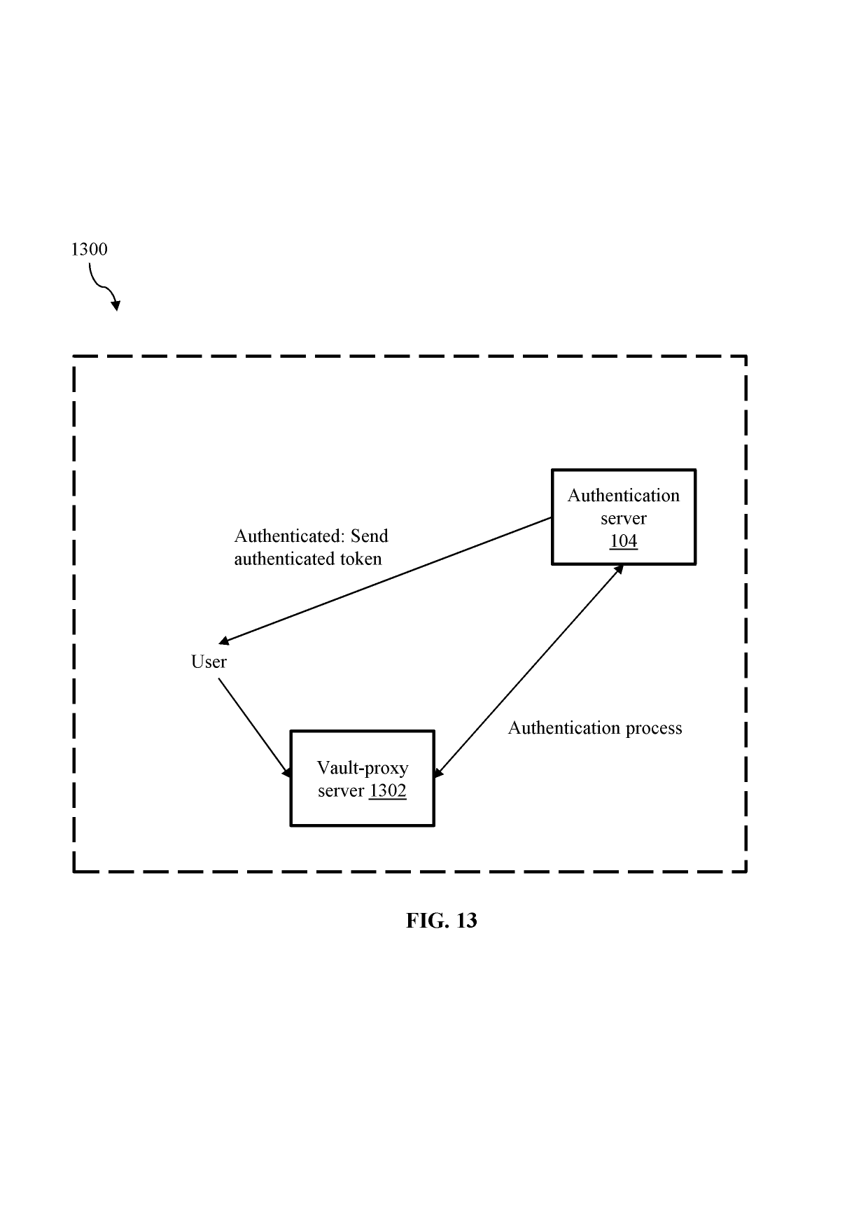

FIG. 13 is a schematic representation 1300 of one or more vaults in a cloud to store the one or more user credentials, in accordance with an embodiment of the present disclosure. The one or more vaults in the cloud may be used instead of secure storage in the one or more user/client devices 102 to store the one or more user credentials and these user credentials may be accessed through the passcodes, and the private keys are dynamically regenerated in the one or more vaults. In an embodiment, a vault server 1302 may act as a proxy for the user associated with the one or more user devices 102 to authenticate with the one or more authentication servers 104. Once authenticated, the token is issued to the one or more user/client devices to access the service. The one or more vaults may act as a secure storage on the cloud and also a proxy agent to automatically authenticate the user associated with the one or more user devices 102 with the one or more authentication servers 104.

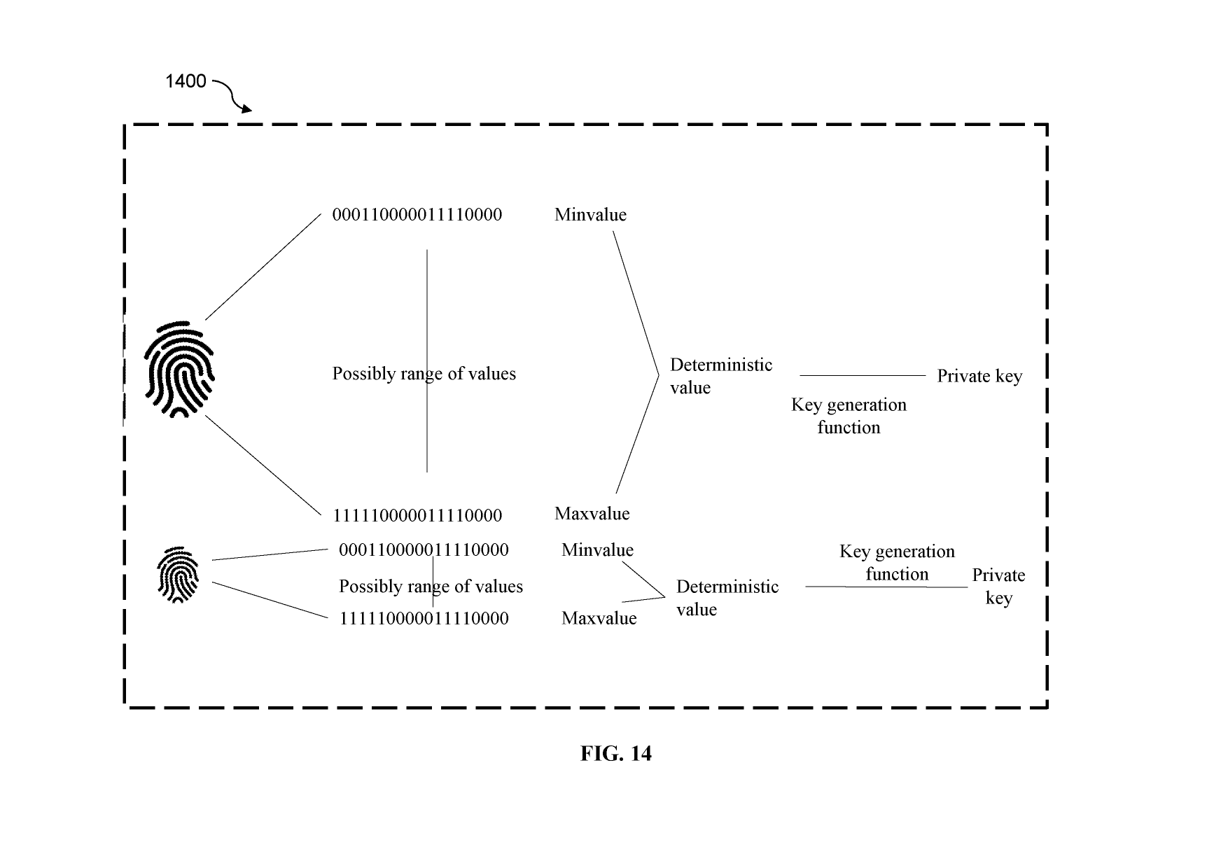

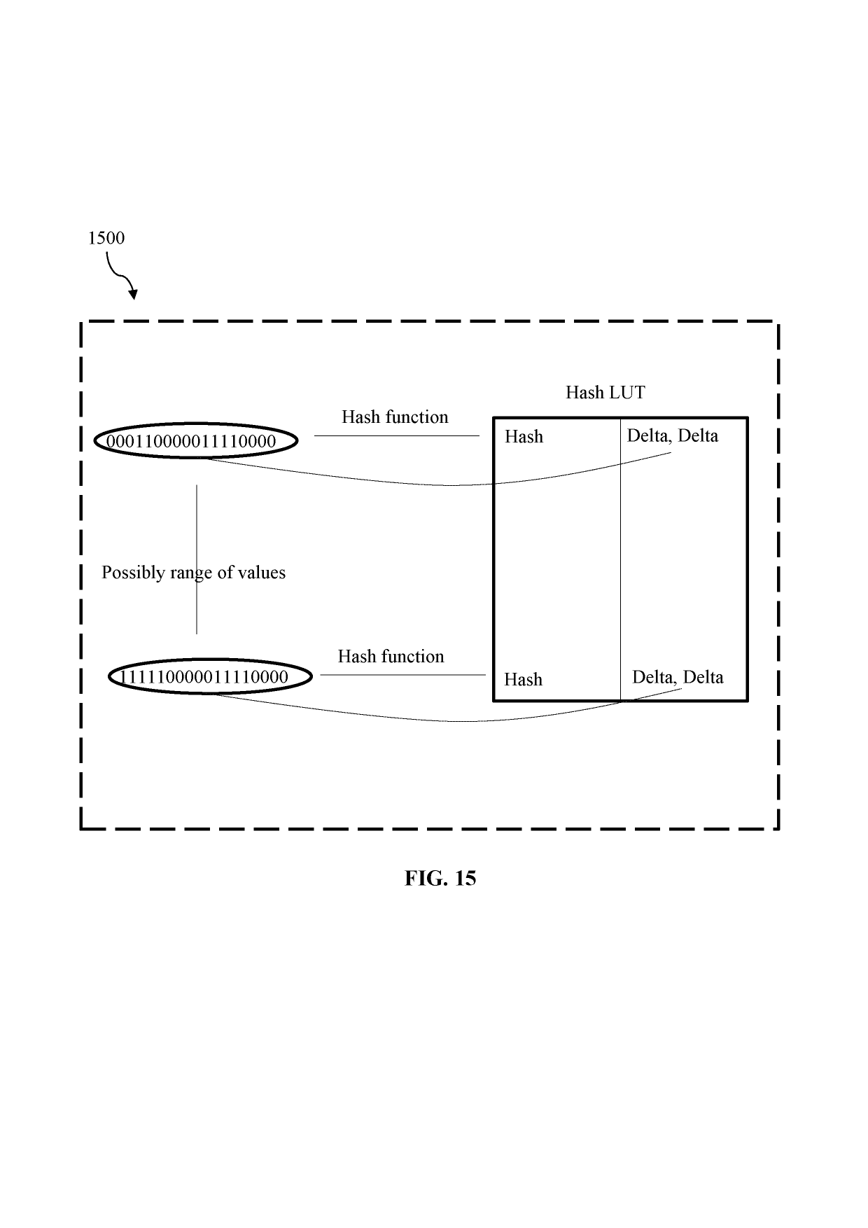

FIG. 14 is a schematic representation 1400 of generation of a private key based on biometric information, in accordance with an embodiment of the present disclosure. FIG. 14 shows that the biometric information of the one or more users are converted as possible range of values which are used to generate the one or more private keys. In an embodiment, the possible range of values may be maximum deterministic values and minimum deterministic values for generating the one or more private keys. FIG. 15 is a schematic representation of a hash lookup table having delta values based on the possible range of values associated with the biometric information, such as those shown in FIG. 14, in accordance with an embodiment of the present disclosure.

In an embodiment, in double blind authentication, the one or more user devices 102 may authenticate the one or more authentication servers 104 as the one or more authentication servers 104 authenticate the one or more user devices 102. In the double blind authentication, both the one or more user devices 102 and the one or more authentication servers 104 do not know the one or more private keys each other.

The double blind authentication may be used for machine to machine authentication, wherein both the machines concurrently act as a user device and an authentication server to each other. Both the machines may register with each other. Only when both the machines authenticate with each other makes the login happened, else the login may be rejected. In an embodiment, the hash square function (HASH(HASH(n)) = H²(n)) may provide a strong verification on the one or more user devices 102 and a weak verification of the one or more authentication servers 104. The double blind authentication may provide a strong verification on both the one or more user devices 102 and the one or more authentication servers 104.

The migration of the one or more user devices 102 based on at least one of: the one or more user identities, the one or more salts, the hash function of the salts and passwords, to enable the public-private key cryptography based authentication is a challenging task. The computer-implemented system 106 may allow just-in-time migration of the one or more user devices 102 and also bulk user device migration which is transparent to the users and the users may not see the difference. When a user device logs in for the first time, and if the password matches a password in the existing password database to logging in. The computer-implemented system 106 may convert the simple keyed-in password to a complex password. The computer-implemented system 106 may utilize the complex password as an input to generate the one or more private key variables.

In an embodiment, the one or more public keys may be stored in the user database and the one or more private key variables may be stored in the one or more vaults. The hashed password in the user’s legacy authentication process may be deleted and a flag may be set for the user to “Yes” indicating the user as a primary user. When the user logs in next time, the password may be used by the computer-implemented system 106 to authenticate the one or more user devices 102 with the one or more authentication servers 104. The computer-implemented system 106 may migrate one user at a time at their first login after the computer-implemented system 106 is configured for the user. For the users wanting to do mass migration, the user devices 102 may send a push notification in batches asking their users to login once, which may automatically trigger the migration for the system 106.

In an embodiment, the one or more passwords/passcodes are used to generate the one or more strong passwords, as mentioned in above said alternate embodiments (e.g., method 3 and 4). The one or more passwords/passcodes are used as an input to a key derive function and an output of the key derive function is used as an encryption key instead of the random number R3, as mentioned in above said alternate embodiments (e.g., in method 5 to method 8). The utilization of the one or more passwords/passcodes may provide a continuation experience to the one or more users. In another implementation, the existing password is converted to the random number (R3) using one time code which may be salt or random number. In an embodiment, the password may not be required for subsequent login providing a passwordless experience, once the random number (R3) is created/generated.

In an embodiment, for a situation where there is no dedicated mobile application for signing up, a roaming authenticator may act as the mobile application for authenticating the user device 102. The one Time Passcode sent through SMS may not be authenticated whether the SMS coming from a claimed service provider or a malicious server. The roaming authenticator may authenticate and validate the one time password (OTP) for the user device 102, which defeats a situation where a user receives an OTP for the service provider A and enters the OTP in a malicious website that uses the OTP to login to the user's financial institution. By using the authenticator of the present invention, the user may enter the OTP code received in the authenticator for the corresponding service provider. The authenticator of the present invention may utilize the OTP to authenticate with the server.

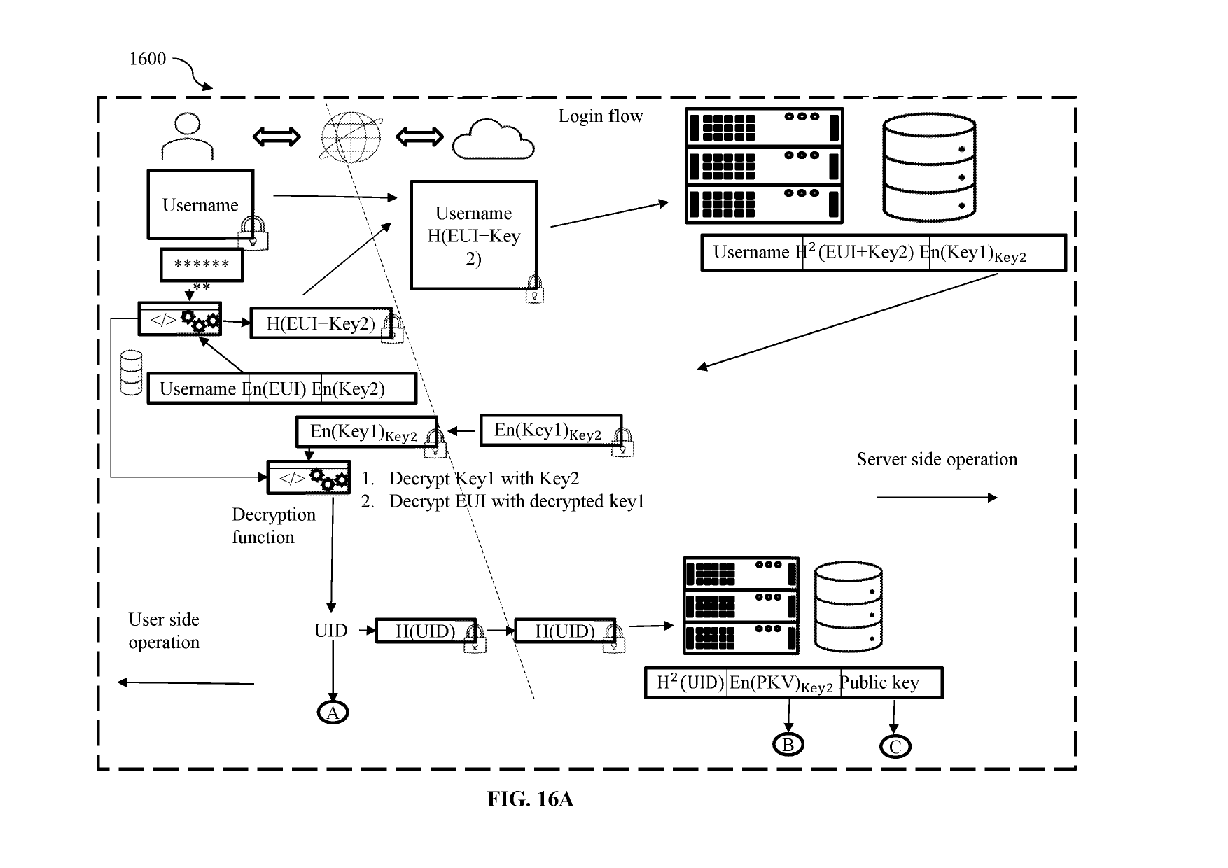

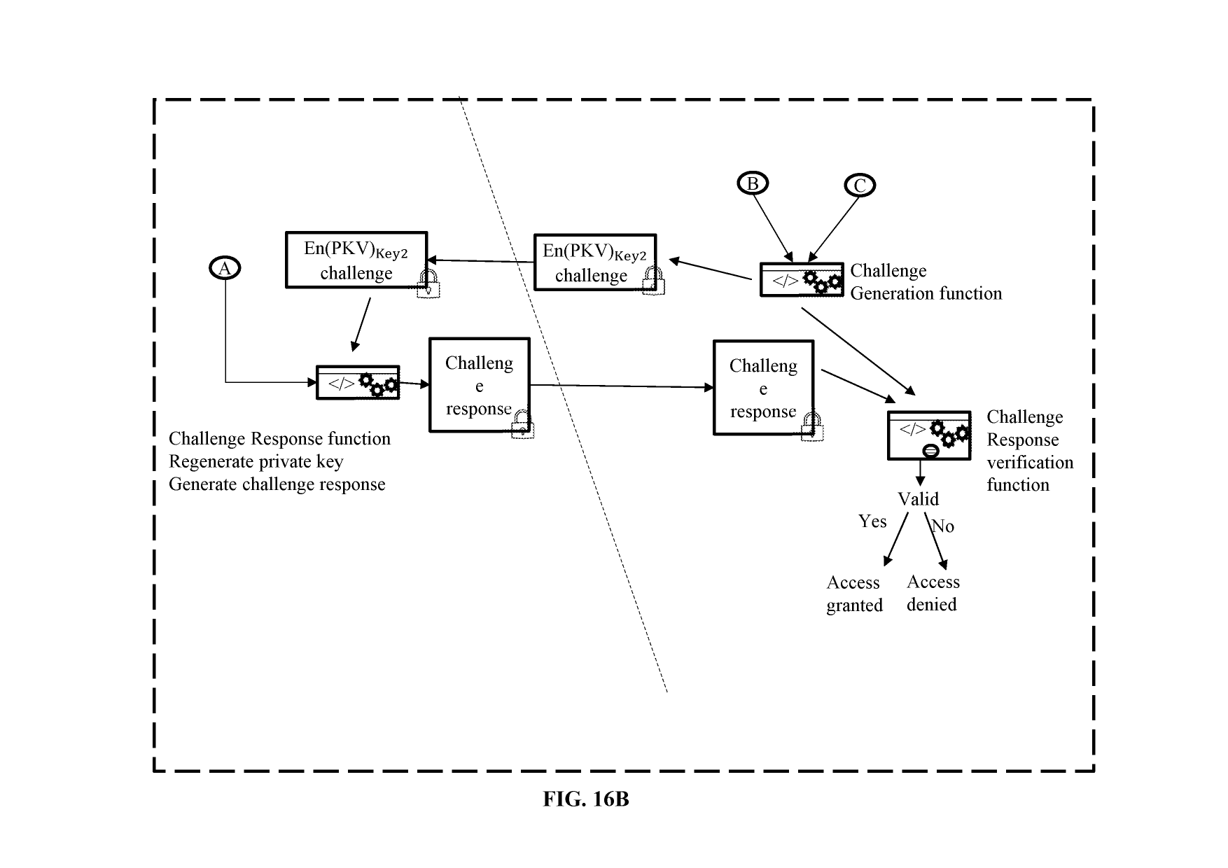

FIG. 16A-16B is a schematic representation 1600 depicting the login process for the authentication between the one or more user devices 102 and the one or more authentication servers 104, in accordance with an embodiment of the present disclosure. The detailed explanation for the login process for the authentication between the one or more user devices 102 and the one or more authentication servers 104, is given in the above said alternative embodiments.

In FIG. 16A-16B, the circular symbols with “A-C” written inside are being used as off-page connectors. These are used for indicating that FIG. 16A continues to the next page as FIG. 16B.

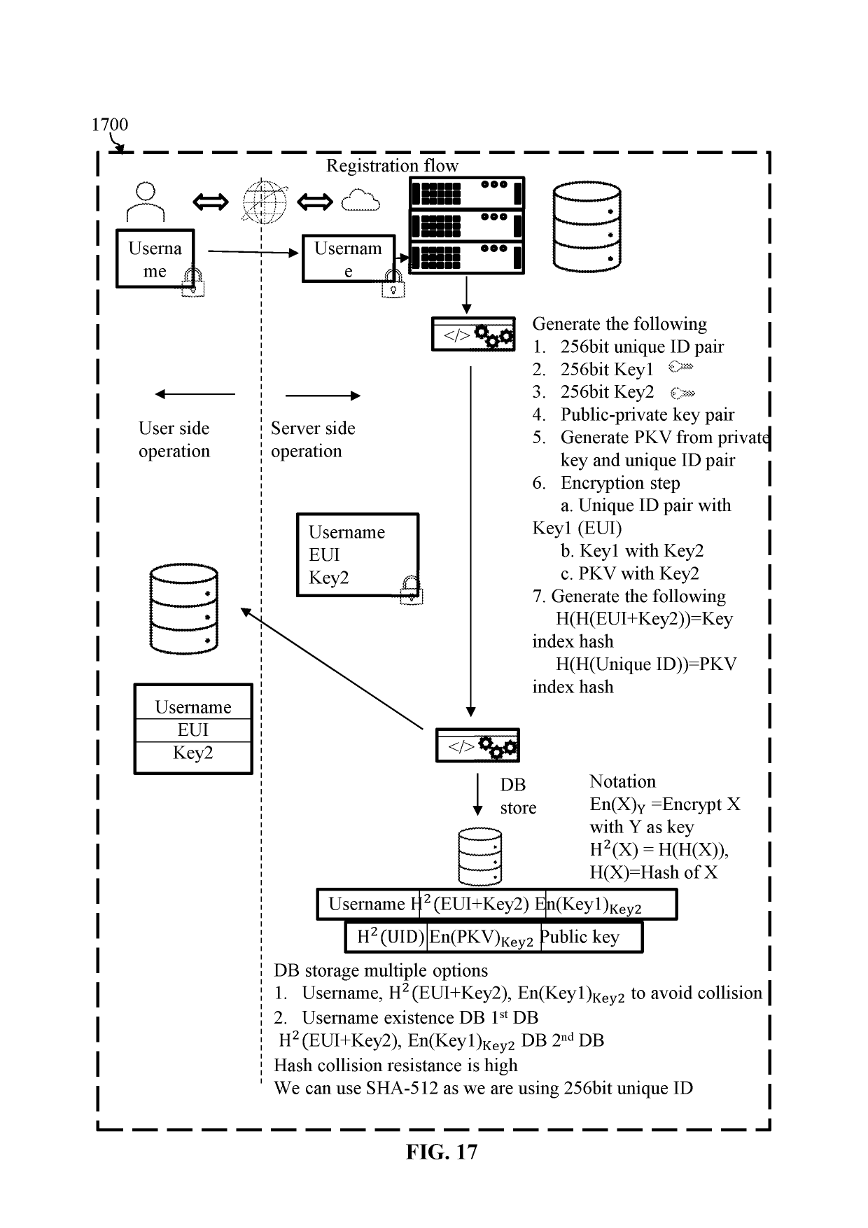

FIG. 17 is a schematic representation 1700 depicting the registration process for the authentication between the one or more user devices 102 and the one or more authentication servers 104, in accordance with an embodiment of the present disclosure. The detailed explanation for the registration process for the authentication between the one or more user devices 102 and the one or more authentication servers 104, is given in the above said alternative embodiments.

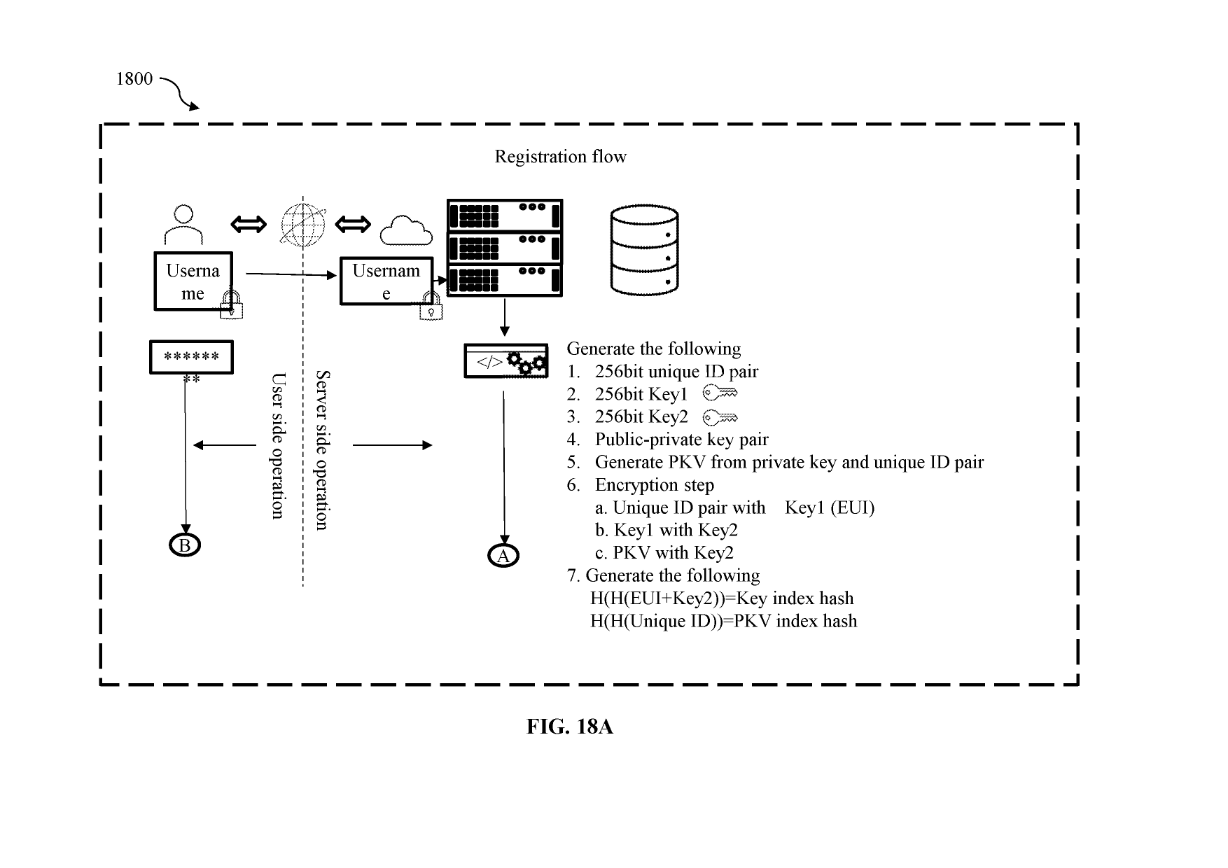

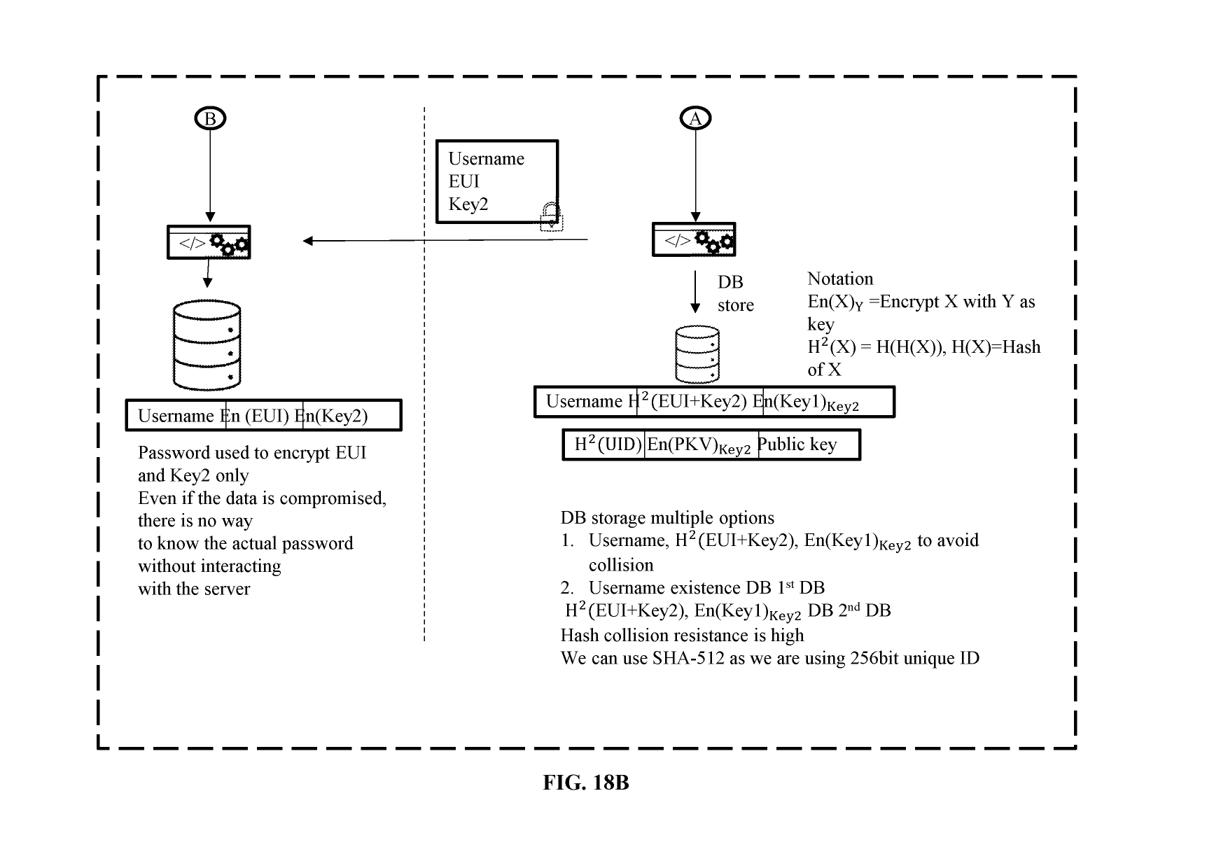

FIG. 18A-18B is a schematic representation 1800 depicting the registration process for the authentication between the one or more user devices 102 and the one or more authentication servers 104, based on one or more passwords used to encrypt extended unique identifier and one or more keys, in accordance with an embodiment of the present disclosure. The detailed explanation for the registration process for the authentication between the one or more user devices 102 and the one or more authentication servers 104, is given in the above said alternative embodiments.

In FIG. 18A-18B, the circular symbols with “A-B” written inside are being used as off-page connectors. These are used for indicating that FIG. 18A continues to the next page as FIG. 18B.

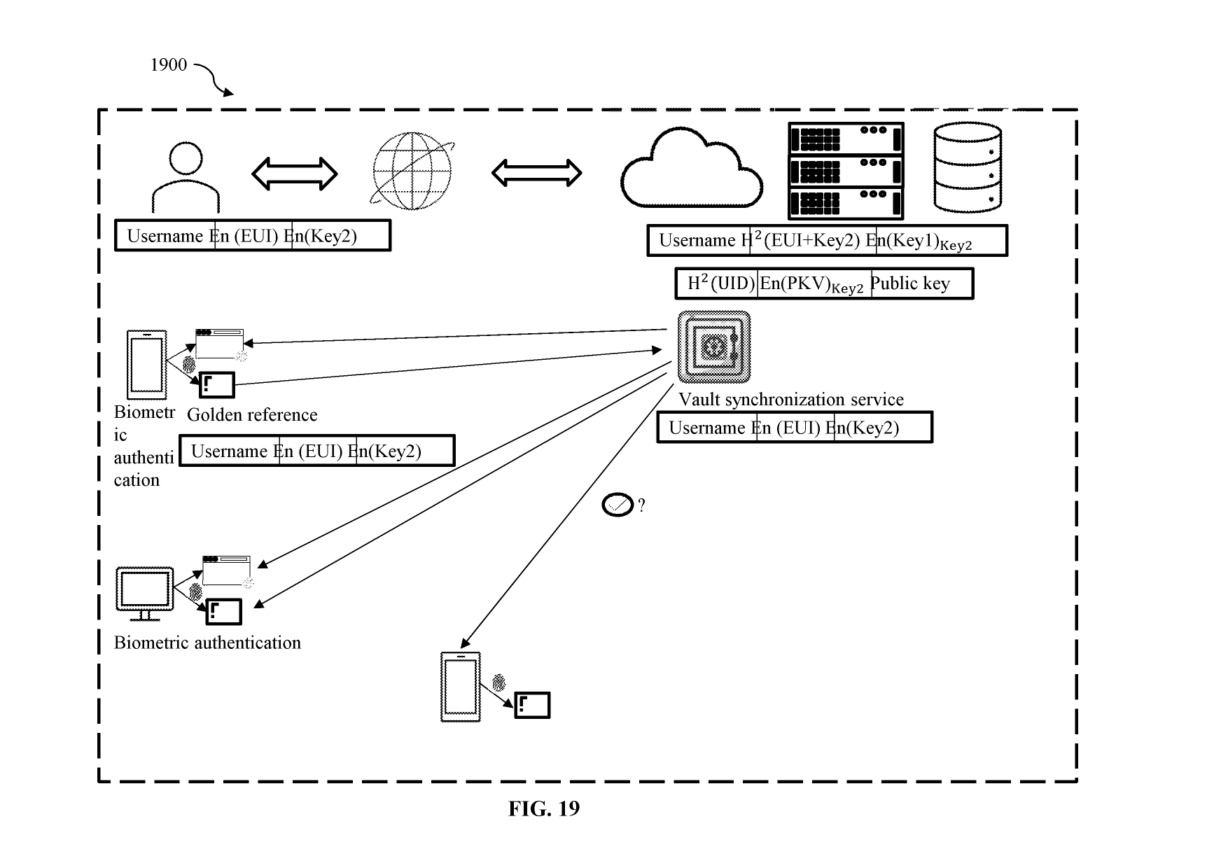

FIG. 19 is a schematic representation 1900 depicting a vault synchronization service for the authentication between the one or more user devices and the one or more authentication servers, in accordance with an embodiment of the present disclosure. The vault may store the one or more user identities, the encrypted extended unique identifier (EUI), the encrypted keys, for authenticating with the one or more user devices 102.

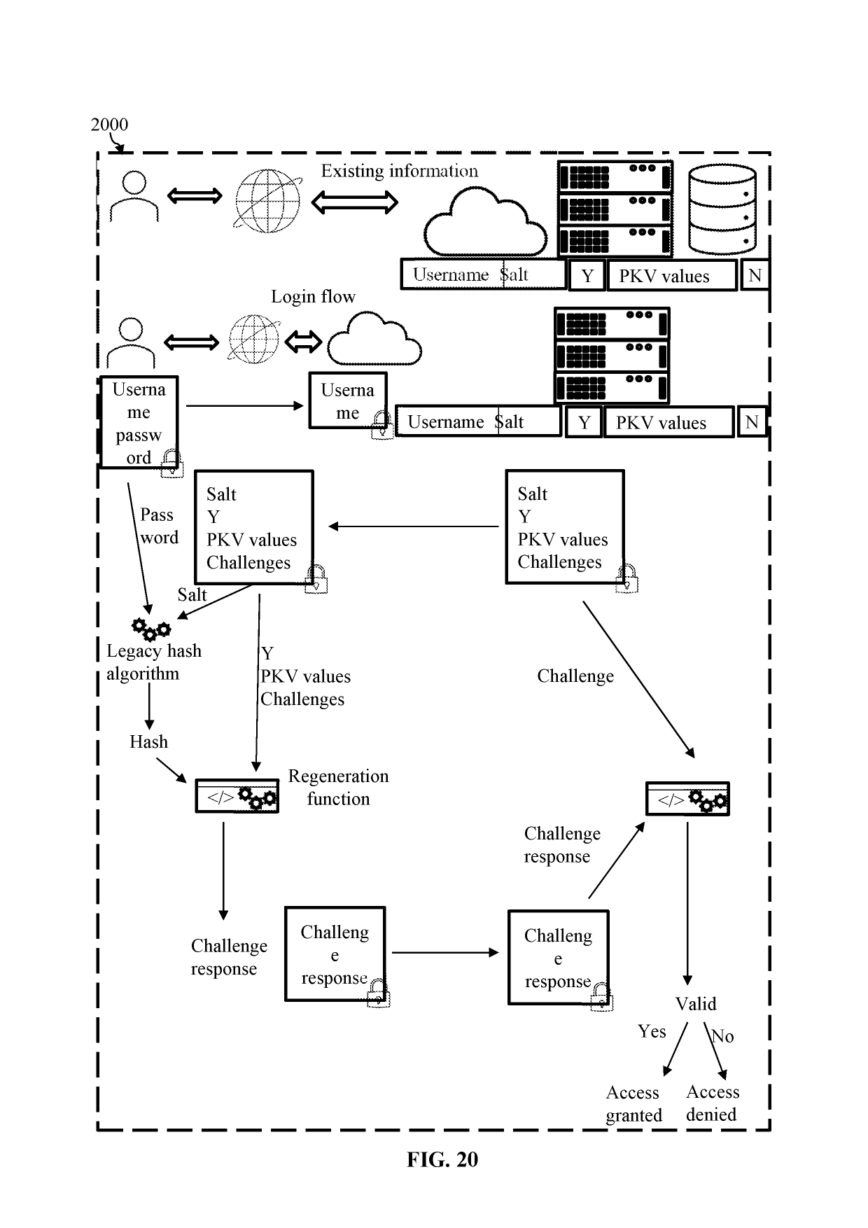

FIG. 20 is a schematic representation 2000 depicting the login process for the authentication between the one or more user devices and the one or more authentication servers, based on existing information, in accordance with an embodiment of the present disclosure. The detailed explanation for the logging in process for the authentication between the one or more user devices 102 and the one or more authentication servers 104, is given in the above said alternative embodiments. The schematic representation 2000 depicts a user logging using the username and password and the authentication is based on public private key cryptography zero knowledge proof. The user entered password is not transmitted to the one or more authentication servers 104 to match for authenticating the user. The username and password to public private key authentication process is depicted. The one or more authentication servers 104 stores the user credentials that compromise of username, one or more salt, one or more Y (random value or seed) for strong password generation, one or more private keys variables, and one or more public keys. When one or more user devices 102 initiate the logging in process for authentication, the one or more authentication servers 104 checks for the existence of the username. If the username matches, the one or more authentication servers 104 transmit to the one or more user devices 102 the one or more salt, one or more Y, one or more private key variables and the challenge. The private key regeneration subsystem (i.e., the key generation subsystem 218) in the one or more user devices 102, regenerates the HASH of the user entered password and the salt, the regenerated HASH with the private key variable regenerates the private key. The regenerated private key is used to solve the challenge received from the one or more authentication servers 104 and transmit the challenge response to the one or more authentication servers 104. The one or more authentication servers 104 compares the received challenge response to the challenge. If it matches, the one or more user devices 102 are authenticated otherwise rejected. From the user perspective, the user enters the username and password credentials for the logging in process and the authentication process uses public-private key cryptography based zero knowledge authentication instead of matching the user entered password in the one or more authentication servers 104.

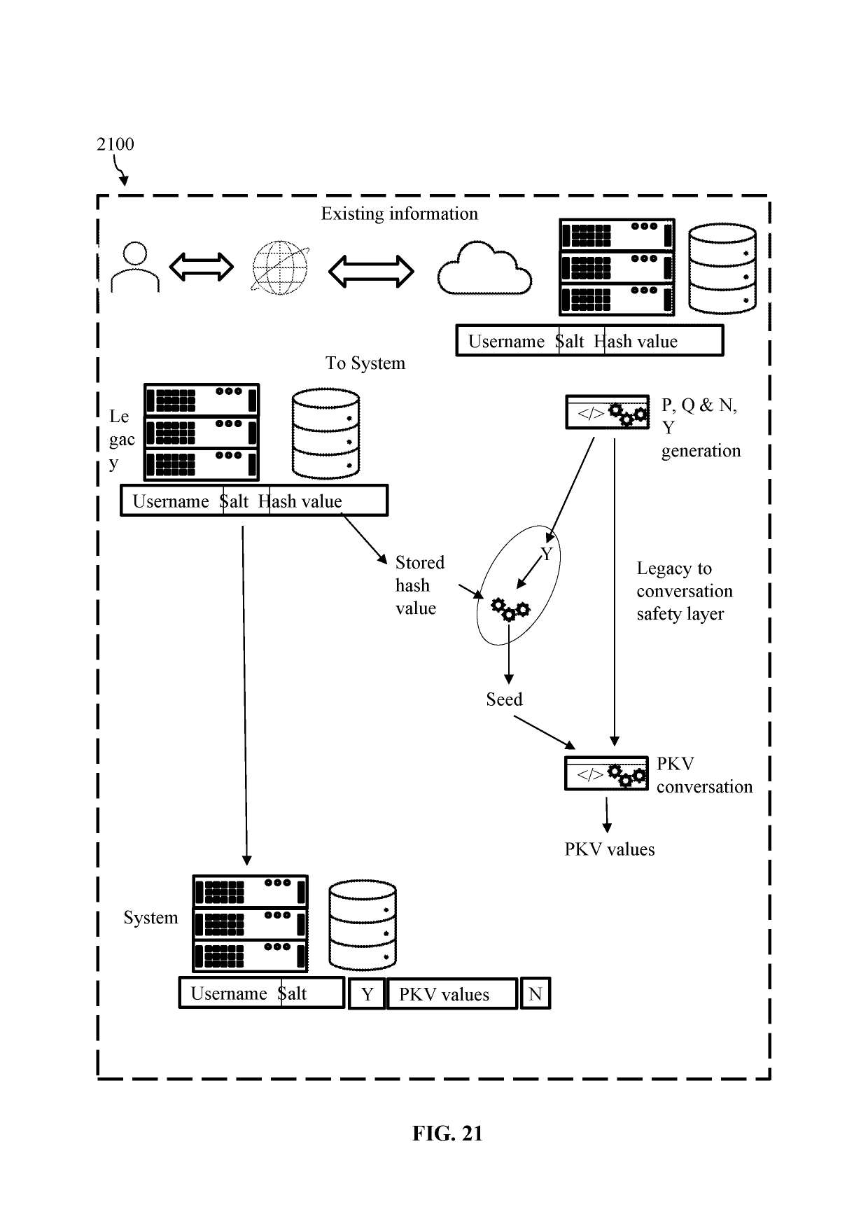

FIG. 21 is a schematic representation 2100 depicting the conversion of the username and password based authentication to zero knowledge authentication based on public private key cryptography. The existing legacy authentication that is based on username, salt, and the HASH of salt. In an embodiment, the password is converted into public private key cryptography. The public private key cryptography conversion system generates prime numbers P and Q, public key N=P*Q, and random value Y. The existing Hash value with random value Y is used to generate a strong password, the strong password and the prime numbers P,Q are used to generate the private key values. The new authentication server stores updated user credentials username, salt, Y, private key values, and public key. The login process for the authentication between the one or more user devices 102 and the one or more authentication servers 104 using the computer-implemented system 106, based on the existing information, in accordance with an embodiment of the present disclosure. The schematic representation 2100 depicts that the existing information may be utilized by the computer-implemented system 106 to generate the one or more private key variables.

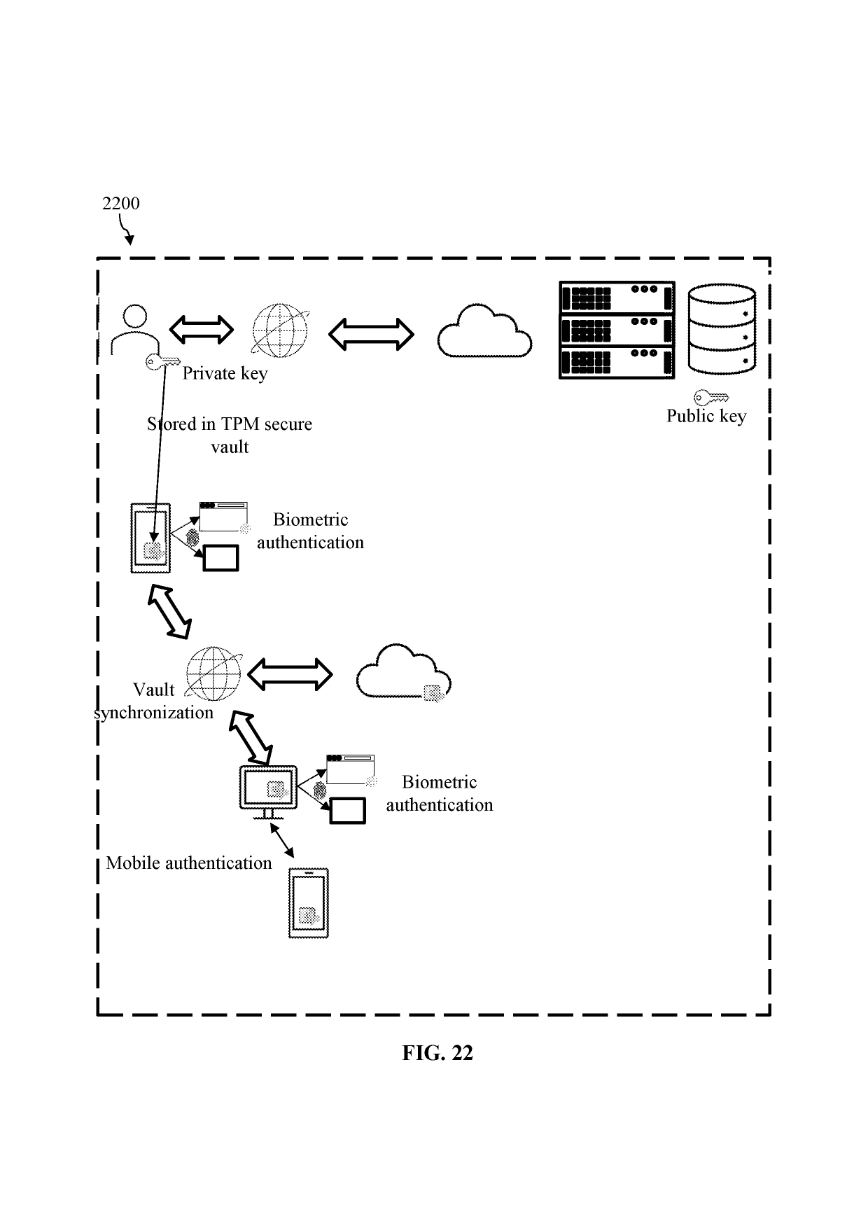

FIG. 22 is a schematic representation 2200 depicting a secure vault storing the private keys for the authentication, in accordance with an embodiment of the present disclosure. The schematic representation 2200 depicts that the one or more private keys generated in the one or more user devices 102 may be securely stored in the secure vault (e.g., trusted platform module (TPM)). The securely stored private keys are synchronized across one or more user devices 102 using vault synchronizer. The one or more user devices 102 uses user biometric for authenticating the one or more user device requests for synchronizing the private key stored in the user device 102.

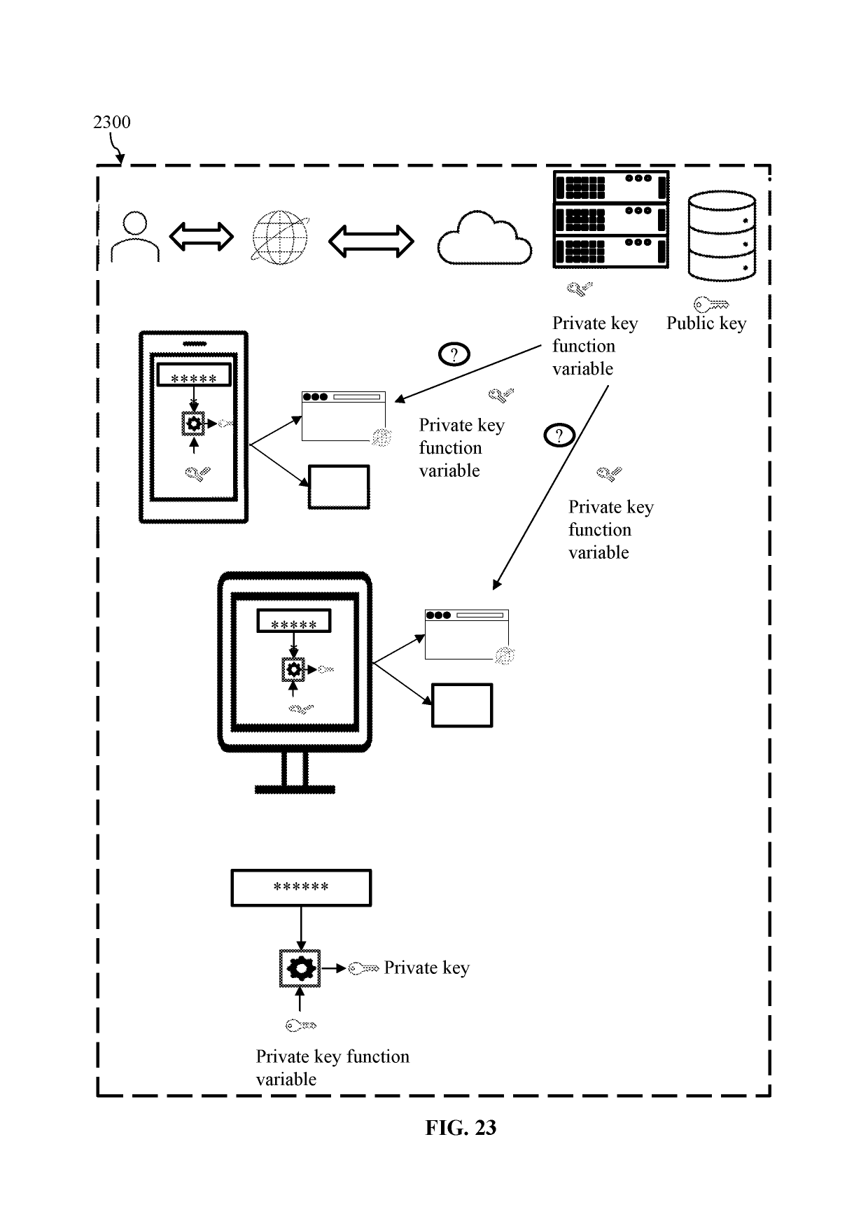

FIG. 23 is a schematic representation 2300 depicting the authentication between the one or more user devices 102 and the one or more authentication servers 104 based on one or more private key variables generated from the one or more servers 104, in accordance with an embodiment of the present disclosure. The schematic representation 2300 depicts private key regeneration using the user entered password and the private key variables transmitted by the authentication server 104 in one or more user devices 102, according to an embodiment of the present disclosure.

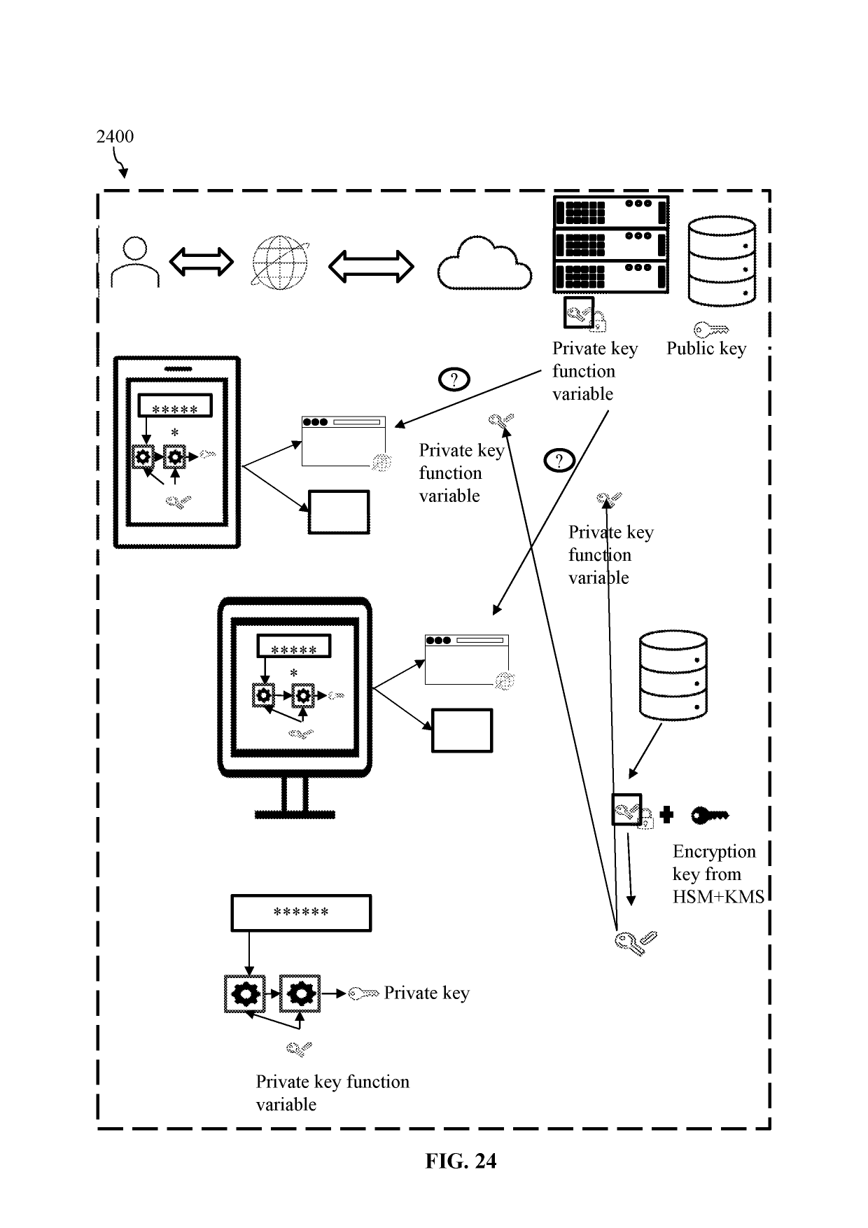

FIG. 24 is a schematic representation 2400 depicting the authentication between the one or more user devices 102 and the one or more authentication servers 104 based on the one or more private key variables with one or more encryption keys, in accordance with an embodiment of the present disclosure. The schematic representation 2400 depicts the private key regeneration using the user entered password and the private key variables transmitted by the authentication server 104 in one or more user devices 102, according to one of the embodiment described. The private key variables are further secured in the authentication server 104 by encrypting the private key variables with key from Hardware Security Module (HSM) and Key Management Service (KSM) subsystem.

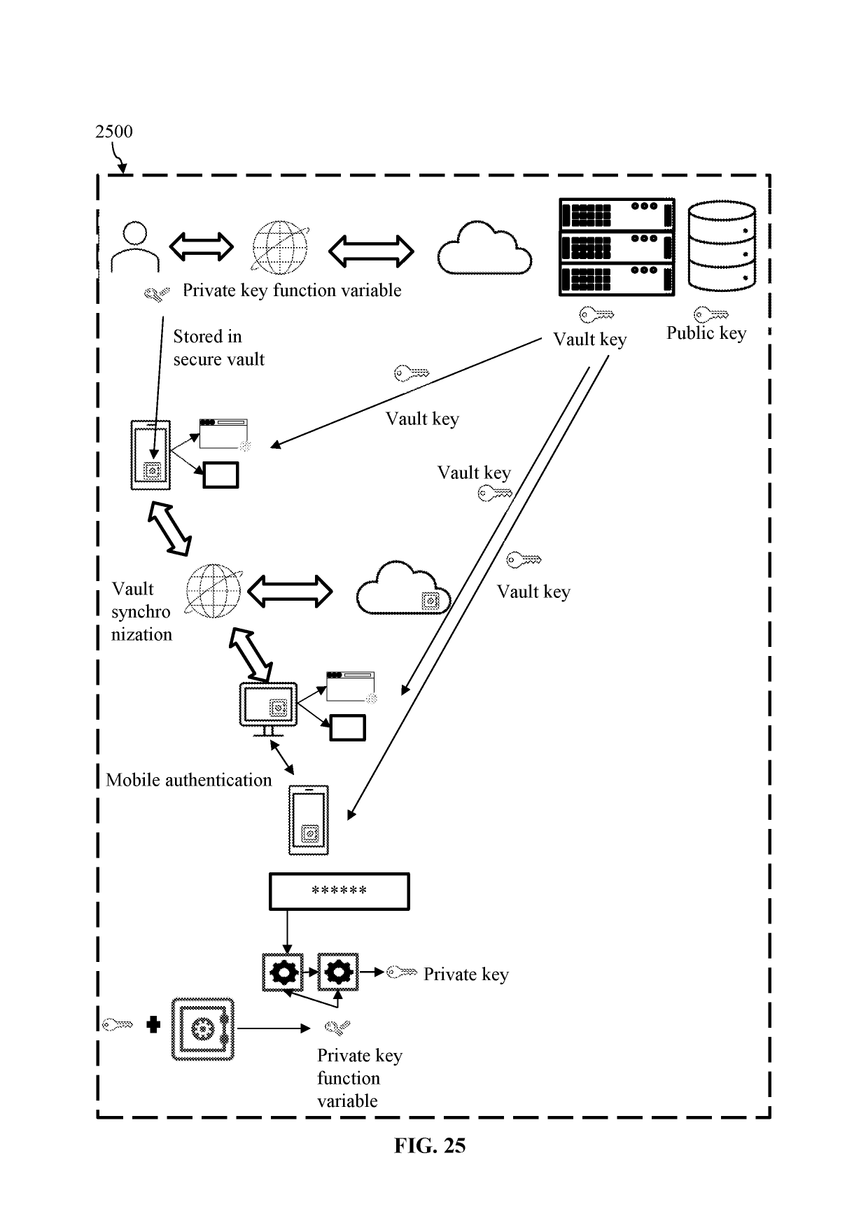

FIG. 25 is a schematic representation 2600 depicting the authentication between the one or more user devices 102 and the one or more authentication servers 104 based on one or more vault keys, in accordance with an embodiment of the present disclosure. The authentication server user credentials comprises of at least one of: username, a public key and a second key (e.g., vault key). During the logging in process, when the username matches in the one or more authentication servers 104, the one or more authentication servers 104 transmit the challenge generated using the public key and the vault key. The vault key is an encryption key that is used in the one or more user devices 102 to decrypt the private key stored in the one or more user devices 102 during the registration process. The encrypted private key stored locally in the one or more user devices 102 may be synchronized across the one or more user devices 102 using a synchronization subsystem. The encrypted private key stored locally in the one or more user devices 102 may be viewed as being the vault. In an embodiment, the vault may not be unlocked without the correct key and the private key may not be decrypted correctly without the correct encryption key. The decryption of the private key here is done by the private key regeneration sub system (i.e., the key generation subsystem 218) and the regenerated private key is used to generate the response to the challenge transmitted by the one or more authentication servers 104. The one or more authentication servers 104 compare the transmitted challenge response from the one or more user devices 102 to the challenge generated by the one or more authentication servers 104. In an embodiment, if the challenges match, then the user is authenticated otherwise rejected. In one embodiment, during the registration process, the prime numbers P, Q, of 1024 bit length and a random value R of 256 bit length are generated. The public key N = P*Q is generated and the private keys are encrypted using the random value R. The username, public key N, and the random value R which is the vault key is transmitted to the one or more authentication servers 104 for the registration.

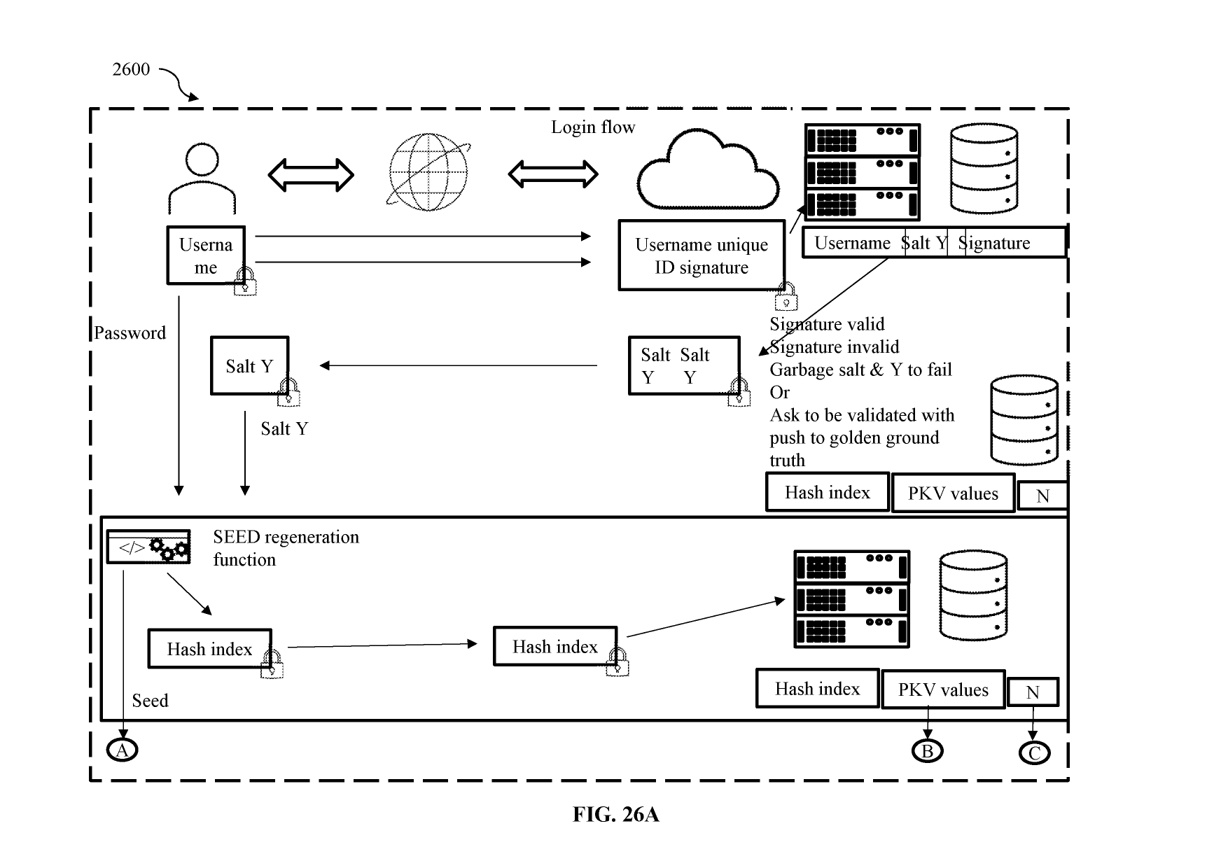

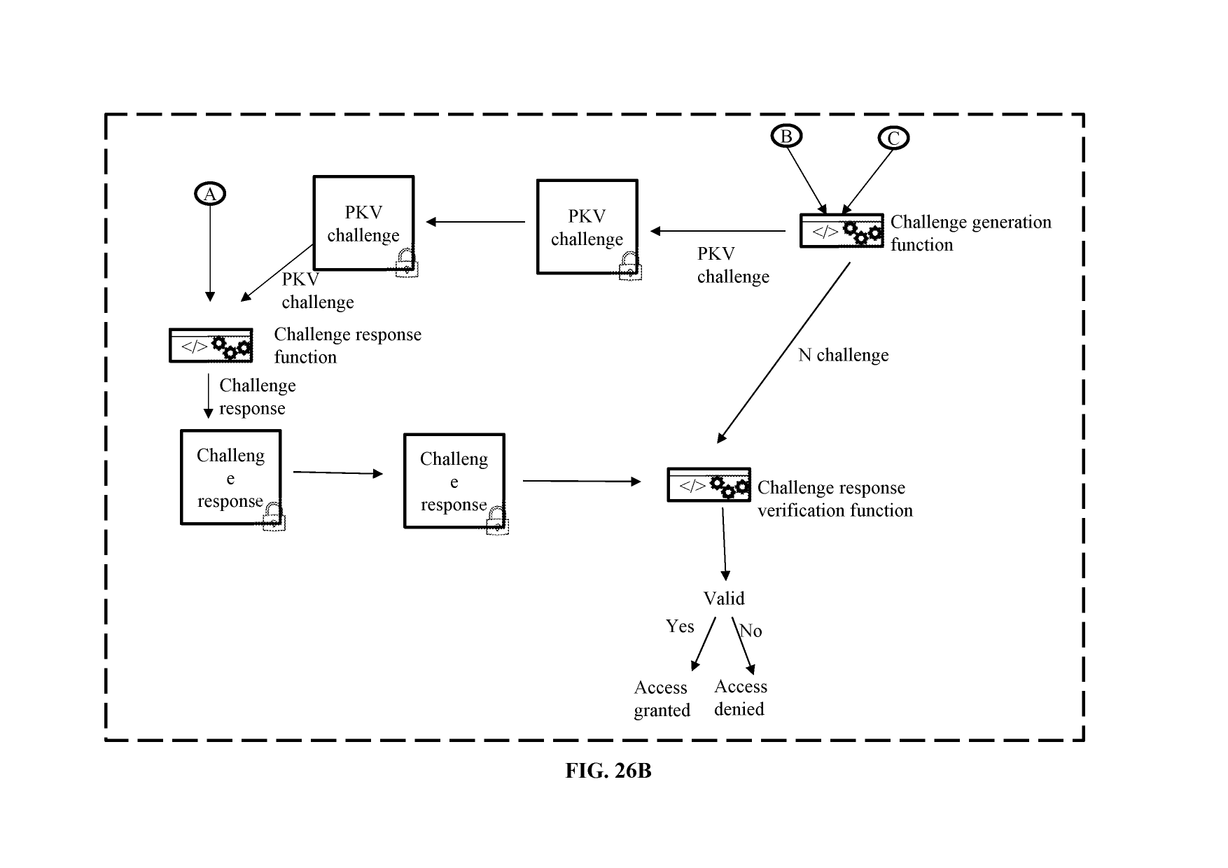

FIG. 26A-26B is a schematic representation 2600 depicting the authentication between the one or more user devices 102 and the one or more authentication servers 104 using one or more salts, in accordance with an embodiment of the present disclosure. The detailed explanation for the logging in process for the authentication between the one or more user devices 102 and the one or more authentication servers 104, is given in the above said alternative embodiments.

In FIG. 26A-26B, the circular symbols with “A-C” written inside are being used as off-page connectors. These are used for indicating that FIG. 26A continues to the next page as FIG. 26B.

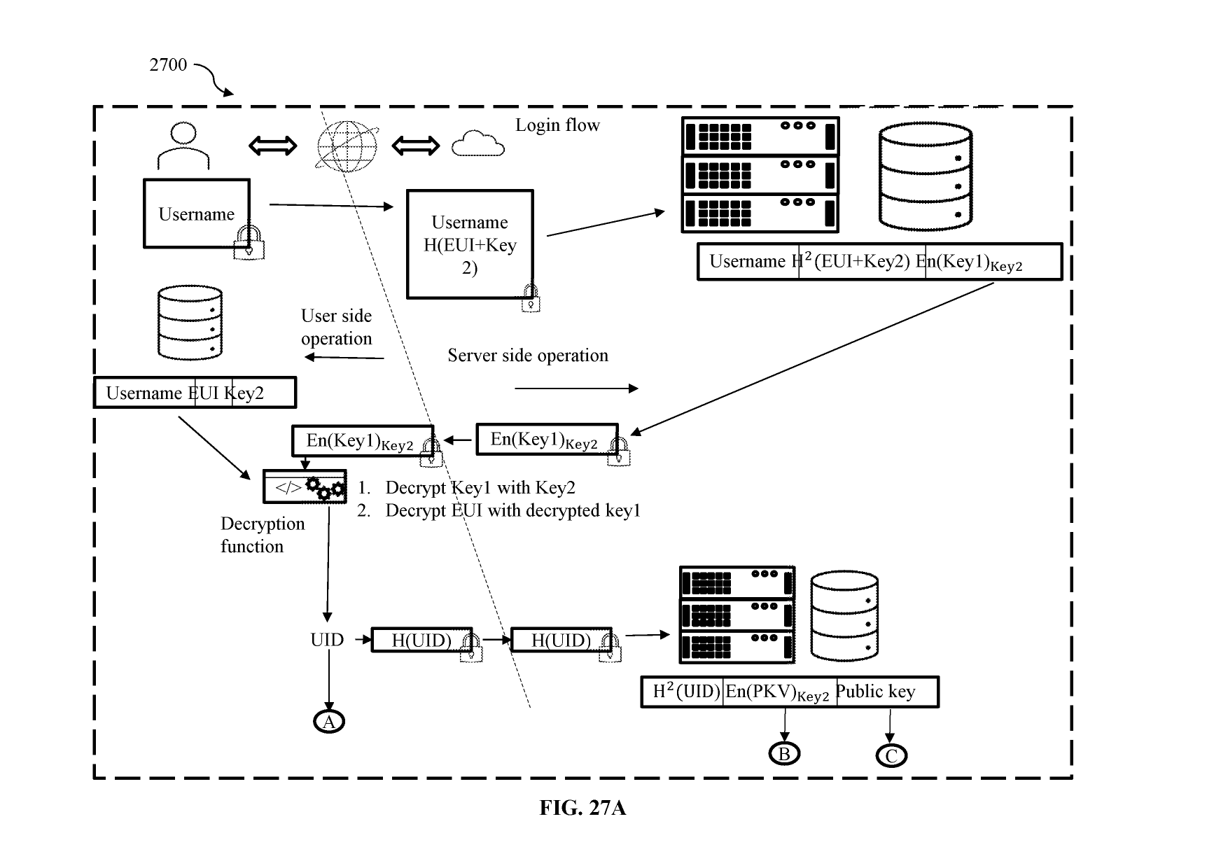

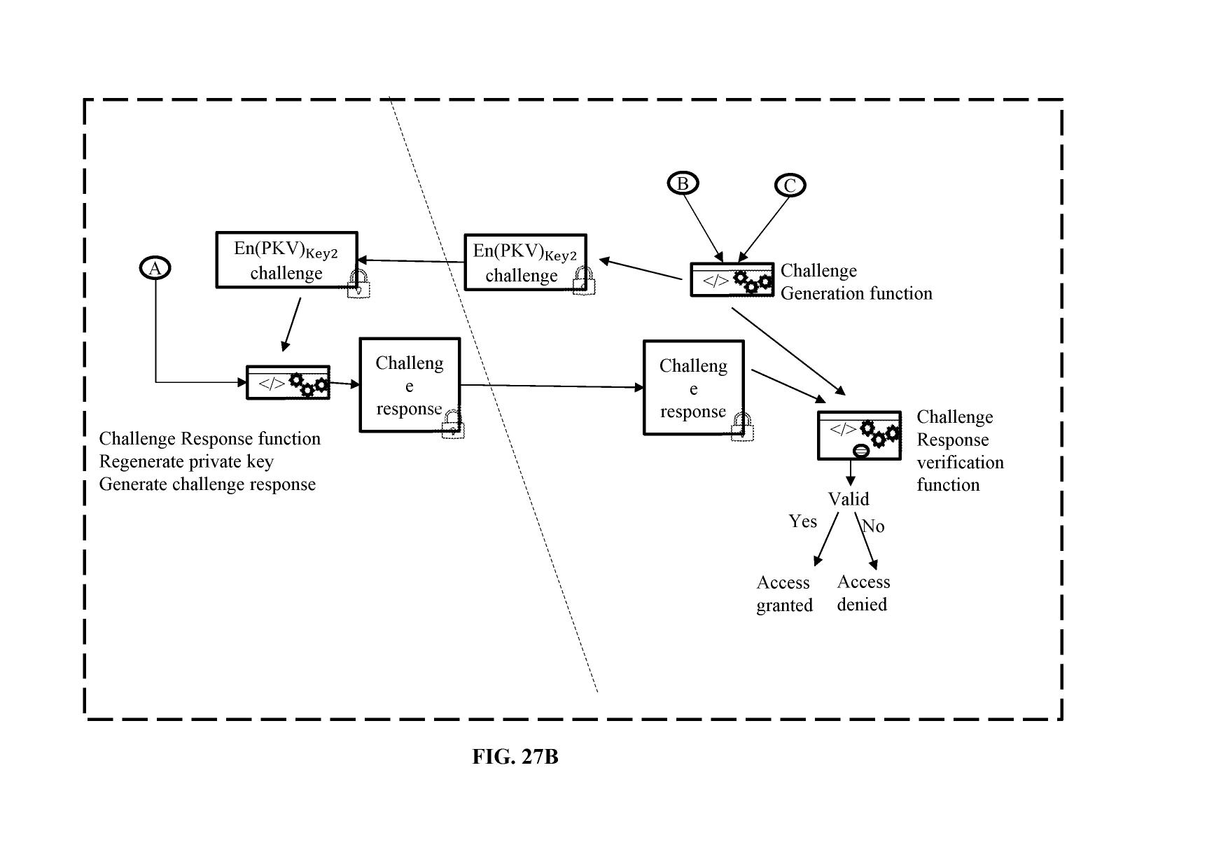

FIG. 27A-27B is a schematic representation 2700 depicting the login process for the authentication between the one or more user devices 102 and the one or more authentication servers 104, based hash square functions, in accordance with an embodiment of the present disclosure. The detailed explanation for the logging in process for the authentication between the one or more user devices 102 and the one or more authentication servers 104, is given in the above said alternative embodiments.

In FIG. 27A-27B, the circular symbols with “A-C” written inside are being used as off-page connectors. These are used for indicating that FIG. 27A continues to the next page as FIG. 27B.

FIG. 28A-28B is an exemplary process 2800 depicting an implementation for authentication between the one or more user devices 102 and the one or more authentication servers 104, in accordance with an embodiment of the present disclosure. The detailed explanation for the implementation for authentication between the one or more user devices 102 and the one or more authentication servers 104, is given in above paragraphs.

In FIG. 28A-28B, the circular symbol with “A” written inside is being used as an off-page connector. This is used for indicating that FIG. 28A continues to the next page as FIG. 28B.

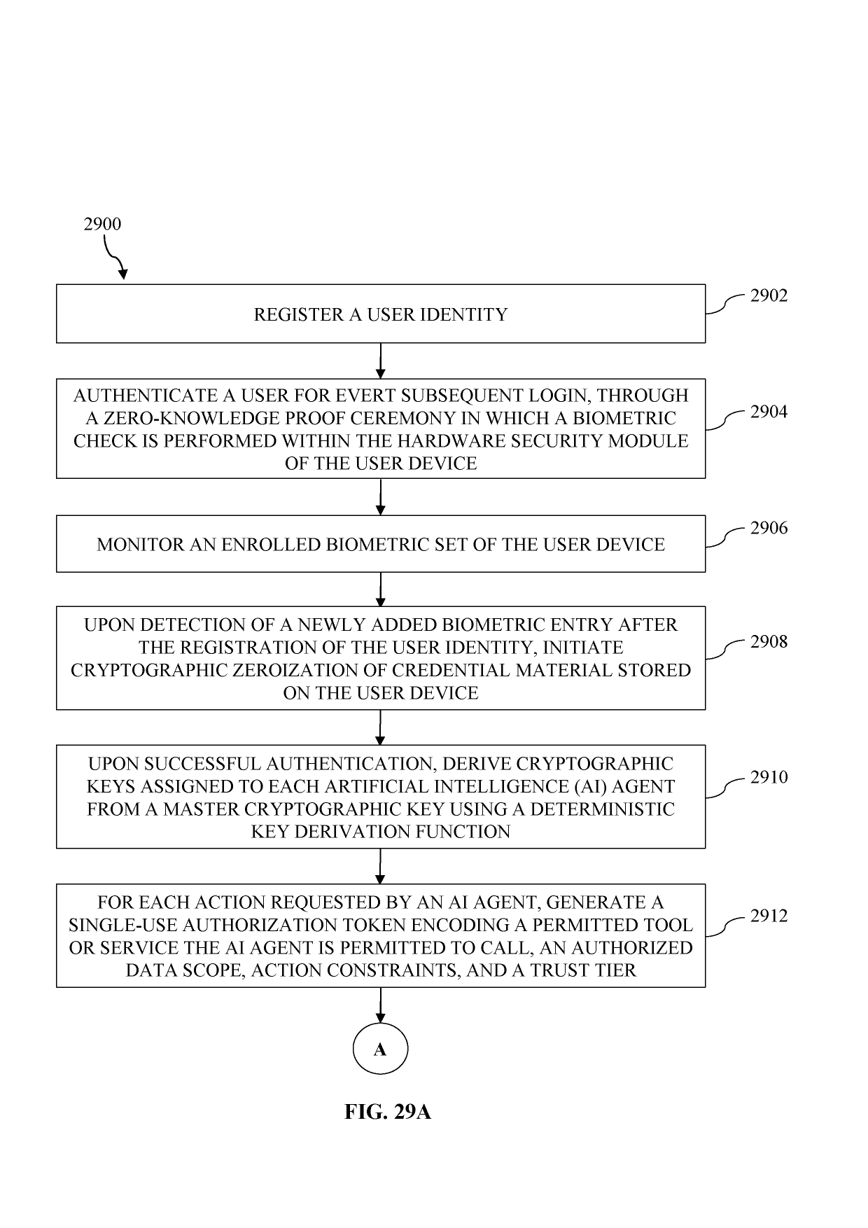

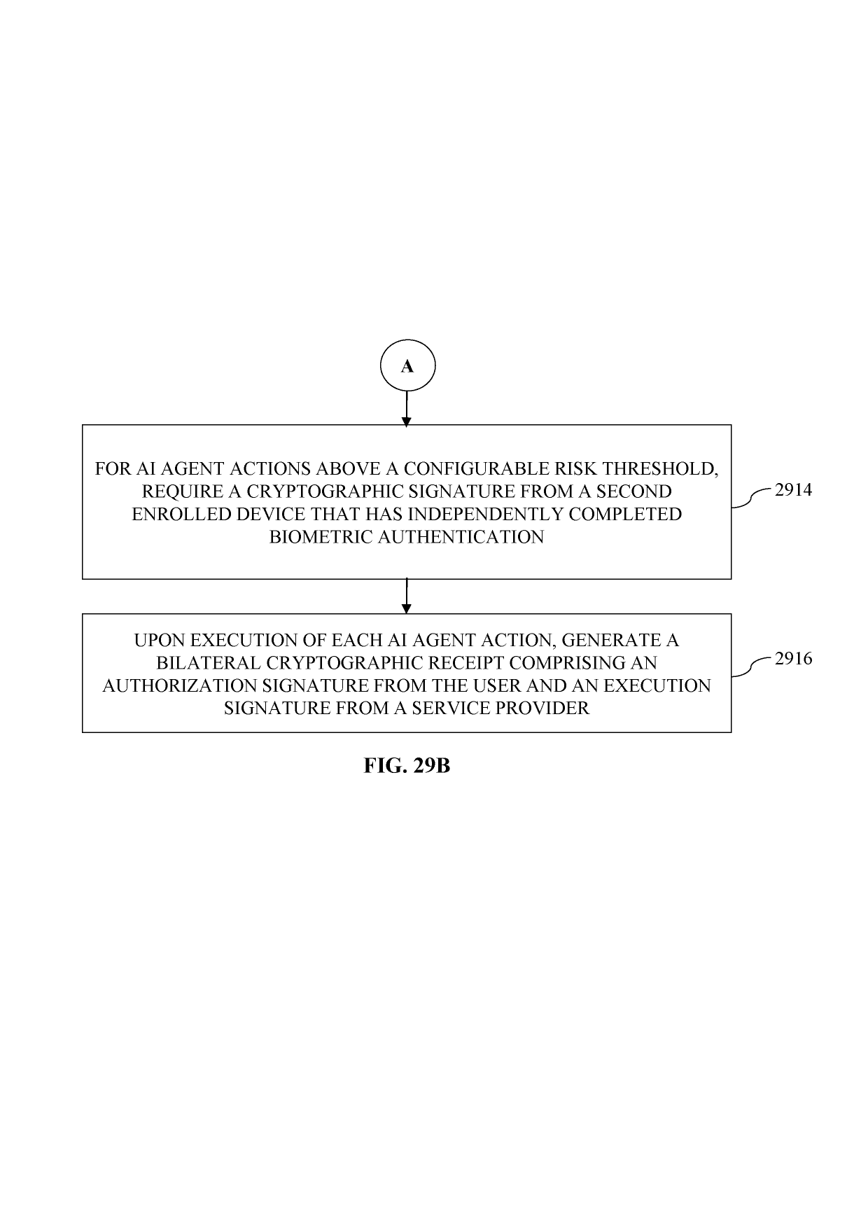

FIG. 29A-29B is a flow chart illustrating a computer-implemented method 2900 for securing authentication of the users, in accordance with an embodiment of the present disclosure.

At step 2902, the user identity is registered (by verifying the government-issued identity document). The registration of the user identity generates the master cryptographic key stored in the hardware security module of the user device 102. No secret data is transmitted after the registration of the user identity is completed.

At step 2904, for every subsequent login, the user is authenticated through the zero-knowledge proof ceremony in which the biometric check is performed within the hardware security module of the user device 102.

At step 2906, the enrolled biometric set of the user device 102 is monitored.

At step 2908, upon detection of the newly added biometric entry after the registration of the user identity, the cryptographic zeroization of credential material stored on the user device 102, is initiated. At step 2910, upon successful authentication, the cryptographic keys assigned to each AI agent are derived from the master cryptographic key using the deterministic key derivation function. Each cryptographic key assigned to each AI agent is cryptographically isolated, whereby access to credentials of one AI agent provide no information regarding credentials of other AI agents.

At step 2912, for each action requested by an AI agent, the single-use authorization token encoding the permitted tool or service the AI agent is permitted to call, the authorized data scope, the action constraints, and the trust tier, wherein the single-use authorization token is atomically consumed upon first use, rendering the single-use authorization token unavailable for replay. At step 2914, for AI agent actions above the configurable risk threshold, the cryptographic signature is required from the second enrolled device that has independently completed biometric authentication. The notification tap, video confirmation, or voice confirmation is insufficient to satisfy the requiring. At step 2916, upon execution of each AI agent action, the bilateral cryptographic receipt comprising the authorization signature is generated from the user and the execution signature is generated from the service provider. The bilateral cryptographic receipt is independently verifiable by the third party without access to session keys.

In FIG. 29A-29B, the circular symbol with “A” written inside is being used as an off-page connector. This is used for indicating that FIG. 29A continues to the next page as FIG. 29B.

The present invention has following advantages. The present invention with the computer-implemented system 106 utilizes the private-public key cryptography based on the zero knowledge proof for authentication called zero knowledge authentication. The one or more authentication servers 104 may store only the public key which does not provide any information about the private key and the one or more authentication servers 104 are not feasible to derive the private key from the public key. The private key(s) variables stored in the one or more authentication servers 104 may not provide extra information about the private key(s). During the authentication process, the one or more authentication servers 104 may not learn any information about the private key(s) based on the authentication steps.

The present invention with the computer-implemented system 106 may not store the private key(s) anywhere either in the one or more user/client devices 102 or at the one or more authentication servers 104. During the login process, the private key(s) is/are dynamically regenerated using multiple different options including at least one of: the one or more passwords/passcodes, the one or more biometric information, the one or more device fingerprints, and one or more external devices connected through universal serial bus (USB)/Bluetooth/Near-Field communication (NFC).

The present invention with the computer-implemented system 106 provides a fundamental security advantage by ensuring that no secret of any kind crosses the network during authentication - not a password, not a biometric hash, not a private key. Traditional authentication systems transmit credentials that can be intercepted, phished, or stolen through man-in-the-middle attacks. The present invention with the computer-implemented system 106 employs zero-knowledge proof ceremonies where both the user device 102 and the authentication server mathematically prove possession of the correct private key without either party transmitting the key itself. The user's private key lives exclusively inside the device's Secure Enclave or TPM chip and never leaves, eliminating the entire class of remote credential theft attacks that plague conventional authentication architectures.

The present invention with the computer-implemented system 106 establishes a hierarchical key derivation architecture where each AI agent's identity is derived uniquely from the owner's master key using a deterministic key derivation function. This cryptographic isolation ensures that compromising one agent reveals nothing about any other agent's credentials, preventing lateral movement attacks across an organization's AI agent ecosystem. Additionally, because all agent credentials derive from the human's master key, revoking the human's access causes every agent they own to be immediately and automatically locked out without requiring explicit per-agent revocation commands, providing instantaneous security response capabilities that are impossible with traditional bearer token architectures.

The present invention with the computer-implemented system 106 implements a per-action authorization model where every action an AI agent takes requires its own unique cryptographic token valid for that one call only. Each token encodes exactly which tool or service the agent is permitted to call, the authorized data scope, action constraints such as maximum amounts and time windows, and the trust tier. The token is atomically consumed on first use and verified in under 400 microseconds with no network calls at runtime, meaning a stolen token cannot be replayed and a compromised agent cannot escalate its own permissions because the scopes are pre-signed by a policy engine rather than being settable by the agent itself.

The present invention with the computer-implemented system 106 provides architectural defense against deepfake attacks by eliminating all human-reviewable steps from security-critical flows and substituting cryptographic proof where human judgment was previously required. A deepfake can fool a human reviewer, but a deepfake cannot produce a valid Ed25519 signature, solve a cryptographic challenge, or present a physical enrolled device. The high-stakes actions require cryptographic approval from a second independently enrolled device, and only a device-bound cryptographic signature satisfies this gate - notification taps, video confirmations, and voice confirmations are explicitly insufficient. This architectural approach eliminates the deepfake attack surface entirely rather than engaging in an arms race of increasingly sophisticated deepfake detection.

The present invention with the computer-implemented system 106 addresses physical attack vectors through two complementary mechanisms. First, the computer-implemented system 106 monitors the device's enrolled biometric set and triggers permanent cryptographic self-destruction if a new biometric is added after enrollment, neutralizing the attack strategy of stealing a device and adding the attacker's own fingerprint or face. Second, the present invention with the computer-implemented system 106 implements a duress detection system where coercion triggers a silent distress mode that appears normal to the attacker while capping all agent trust levels to read-only, firing GPS alerts, routing CIBA approval requests to emergency contacts, and forensically logging every attacker action. This dual-layer physical security ensures that neither device theft nor user coercion provides a viable attack path.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the computer-implemented system 106 either directly or through intervening I/O controllers. Network adapters may also be coupled to the computer-implemented system 106 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/computer-implemented system 106 in accordance with the embodiments herein. The computer-implemented system 106 herein comprises at least one processor or central processing unit (CPU). The CPUs are interconnected via the system bus 208 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the computer-implemented system 106. The computer-implemented system 106 can read the inventive instructions on the program storage devices and follow these instructions to execute the methodology of the embodiments herein.

The computer-implemented system 106 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. A computer-implemented method for securing authentication of users, the computer-implemented method comprising:
registering, by one or more hardware processors, a user identity, wherein the registration of the user identity generates a master cryptographic key stored in a hardware security module of a user device, and wherein no secret data is transmitted after the registration of the user identity is completed;
for every subsequent login, authenticating, by the one or more hardware processors, a user through a zero-knowledge proof ceremony in which a biometric check is performed within the hardware security module of the user device;
monitoring, by the one or more hardware processors, an enrolled biometric set of the user device;
upon detection of a newly added biometric entry after the registration of the user identity, initiating, by the one or more hardware processors, cryptographic zeroization of credential material stored on the user device;
upon successful authentication, deriving, by the one or more hardware processors, cryptographic keys assigned to each artificial intelligence (AI) agent from a master cryptographic key using a deterministic key derivation function, wherein each cryptographic key assigned to each AI agent is cryptographically isolated, whereby access to credentials of one AI agent provide no information regarding credentials of other AI agents;
for each action requested by an AI agent, generating, by the one or more hardware processors, a single-use authorization token encoding a permitted tool or service the AI agent is permitted to call, an authorized data scope, action constraints, and a trust tier, wherein the single-use authorization token is atomically consumed upon first use, rendering the single-use authorization token unavailable for replay;
for AI agent actions above a configurable risk threshold, requiring, by the one or more hardware processors, a cryptographic signature from a second enrolled device that has independently completed biometric authentication, wherein a notification tap, video confirmation, or voice confirmation is insufficient to satisfy the requiring; and
upon execution of each AI agent action, generating, by the one or more hardware processors, a bilateral cryptographic receipt comprising an authorization signature from the user and an execution signature from a service provider, wherein the bilateral cryptographic receipt is independently verifiable by a third party without access to session keys.

2. The computer-implemented method of claim 1, further comprising:
detecting, by the one or more hardware processors, a duress authentication event based on entry of a designated panic PIN or activation of a distress biometric;
in response to detecting the duress authentication event, silently transitioning, by the one or more hardware processors, the authentication to a restricted operational mode without visible indication to an authenticating party;
transmitting, by the one or more hardware processors, an encrypted alert comprising GPS coordinates, a timestamp, and a device identifier, to a server;
setting, by the one or more hardware processors, trust levels of each AI agent to read-only for precluding execution of transactions and irreversible actions during a duress session; and
logging, by the one or more hardware processors, every action attempted during the duress session with enhanced forensic metadata comprising geolocation, timestamp, and a duress session identifier.

3. The computer-implemented method of claim 2, further comprising re-routing, by the one or more hardware processors, client initiated backchannel authentication (CIBA) approval requests generated during the duress session to a pre-registered emergency contact instead of routing to the user.

4. The computer-implemented method of claim 1, wherein registering the user identity comprises:
for an enterprise user, verifying, by the one or more hardware processors, a government-issued identity document in person by an authority, and generating a one-time registration code tied to the verified government-issued identity document, wherein the one-time registration code is single-use, time-bounded, and valid only on a specific device being enrolled; and
for a consumer user, capturing, by the one or more hardware processors, the government-issued identity document, completing a live selfie check with liveness detection using challenge-response verification, performing a document authenticity check to verify that the government-issued identity document is not forged, and performing a face match to confirm that the user matches the government-issued identity document.

5. The computer-implemented method of claim 4, wherein the computer-implemented method provides authorization of AI agent actions, and further comprising assigning, by the one or more hardware processors, a maximum AI agent authorization trust tier to an account based on an assurance level of an identity verification method used during the registration of the user identity, wherein the maximum AI agent authorization trust tier is enforced cryptographically at a token minting layer, and
wherein in-person physical verification maps to a maximum available AI agent authorization trust tier, a near field communication (NFC) passport chip cryptographic verification maps to a higher trust tier instead of selfie-based verification, and selfie plus document verification maps to a defined lower trust tier ceiling.

6. The computer-implemented method of claim 1, wherein authenticating the user further comprises:
providing, by the one or more hardware processors, dual cryptographically distinct keys to the hardware security module of the user device, comprising a normal key bound to a primary enrolled biometric entry and a distress key bound to a secondary enrolled biometric entry;
upon each authentication attempt, silently attempting, by the one or more hardware processors, the authentication attempts to unlock the normal key, and if the normal key fails, silently attempting to unlock the distress key; and
upon activation of the distress key, unlocking, by the one or more hardware processors, a sandboxed AI agent environment that is operationally identical to but capability-restricted from a normal AI agent environment, wherein the sandboxed AI agent environment is indistinguishable from the normal AI agent environment to an external observer.

7. The computer-implemented method of claim 1, wherein:
the user device is designated as a sole recovery authority for an associated user account, and, responsive to loss of the user device, re-establishment of access requires re-registration based on physical identity verification;
each security-critical operation is authorized exclusively based on cryptographic verification of one or more cryptographic proofs generated by the user device; and
authorization of a security-critical operation requires validation of a cryptographic signature, successful completion of a cryptographic challenge, and verification of possession of an enrolled physical device, thereby preventing execution of the security-critical operation by synthetic media, impersonation artifacts, or other non-device-based authentication attempts.

8. The computer-implemented method of claim 1, wherein the authentication of the user is a mutual cryptographic challenge-response in which both the user device and the server prove that the user device and the server possess a correct private key without transmitting the correct private key between each other, wherein the server learns that the user device possesses the correct private key, and wherein upon success authentication of the user, the master cryptographic key is released to unlock an agent credential chain.

9. A computer-implemented system for securing authentication of users, the computer-implemented system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a user registering subsystem configured to register a user identity, wherein the registration of the user identity generates a master cryptographic key stored in a hardware security module of a user device, and wherein no secret data is transmitted after the registration of the user identity is completed;
a user authenticating subsystem configured to authenticate a user for every subsequent login, through a zero-knowledge proof ceremony in which a biometric check is performed within the hardware security module of the user device;
a credential self-destructing subsystem configured to:
monitor an enrolled biometric set of the user device; and
upon detection of a newly added biometric entry after the registration of the user identity, initiate cryptographic zeroization of credential material stored on the user device; and
an agent authorizing subsystem configured to:
upon successful authentication, derive cryptographic keys assigned to each AI agent from a master cryptographic key using a deterministic key derivation function, wherein each cryptographic key assigned to each AI agent is cryptographically isolated, whereby access to credentials of one AI agent provide no information regarding credentials of other AI agents;
for each action requested by an AI agent, generate a single-use authorization token encoding a permitted tool or service the AI agent is permitted to call, an authorized data scope, action constraints, and a trust tier, wherein the single-use authorization token is atomically consumed upon first use, rendering the single-use authorization token unavailable for replay;
for AI agent actions above a configurable risk threshold, require a cryptographic signature from a second enrolled device that has independently completed biometric authentication, wherein a notification tap, video confirmation, or voice confirmation is insufficient to satisfy the requiring; and
upon execution of each AI agent action, generate a bilateral cryptographic receipt comprising an authorization signature from the user and an execution signature from a service provider, wherein the bilateral cryptographic receipt is independently verifiable by a third party without access to session keys.

10. The computer-implemented system of claim 9, wherein the credential self-destructing subsystem is further configured to:
detect a duress authentication event based on entry of a designated panic PIN or activation of a distress biometric;
in response to detecting the duress authentication event, silently transition the authentication to a restricted operational mode without visible indication to an authenticating party;
transmit an encrypted alert comprising GPS coordinates, a timestamp, and a device identifier, to a server;
set trust levels of each AI agent to read-only for precluding execution of transactions and irreversible actions during a duress session; and
log every action attempted during the duress session with enhanced forensic metadata comprising geolocation, timestamp, and a duress session identifier.

11. The computer-implemented system of claim 10, wherein the credential self-destructing subsystem is further configured to re-route client initiated backchannel authentication (CIBA) approval requests generated during the duress session to a pre-registered emergency contact instead of routing to the user.

12. The computer-implemented system of claim 9, wherein in registering the user identity, the user registering subsystem is further configured to:
for an enterprise user, verify a government-issued identity document in person by an authority, and generate a one-time registration code tied to the verified government-issued identity document, wherein the one-time registration code is single-use, time-bounded, and valid only on a specific device being enrolled; and
for a consumer user, capture the government-issued identity document, completing a live selfie check with liveness detection using challenge-response verification, performing a document authenticity check to verify that the government-issued identity document is not forged, and performing a face match to confirm that the user matches the government-issued identity document.

13. The computer-implemented system of claim 12, wherein the computer-implemented system provides authorization of artificial intelligence (AI) agent actions, wherein the user registering subsystem is further configured to assign a maximum AI agent authorization trust tier to an account based on an assurance level of an identity verification method used during the registration of the user identity, wherein the maximum AI agent authorization trust tier is enforced cryptographically at a token minting layer, and
wherein in-person physical verification maps to a maximum available AI agent authorization trust tier, a near field communication (NFC) passport chip cryptographic verification maps to a higher trust tier instead of selfie-based verification, and selfie plus document verification maps to a defined lower trust tier ceiling.

14. The computer-implemented system of claim 9, wherein in authenticating the user, the user authenticating subsystem is further configured to:
providing, by the one or more hardware processors, dual cryptographically distinct keys to the hardware security module of the user device, comprising a normal key bound to a primary enrolled biometric entry and a distress key bound to a secondary enrolled biometric entry;
upon each authentication attempt, silently attempt the authentication attempts to unlock the normal key, and if the normal key fails, silently attempt to unlock the distress key; and
upon activation of the distress key, unlock a sandboxed AI agent environment that is operationally identical to but capability-restricted from a normal AI agent environment, wherein the sandboxed AI agent environment is indistinguishable from the normal AI agent environment to an external observer.

15. The computer-implemented system of claim 9, wherein:
the user device is designated as a sole recovery authority for an associated user account, and, responsive to loss of the user device, re-establishment of access requires re-registration based on physical identity verification;
each security-critical operation is authorized exclusively based on cryptographic verification of one or more cryptographic proofs generated by the user device; and
authorization of a security-critical operation requires validation of a cryptographic signature, successful completion of a cryptographic challenge, and verification of possession of an enrolled physical device, thereby preventing execution of the security-critical operation by synthetic media, impersonation artifacts, or other non-device-based authentication attempts.

16. The computer-implemented system of claim 9, wherein the authentication of the user is a mutual cryptographic challenge-response in which both the user device and the server prove that the user device and the server possess a correct private key without transmitting the correct private key between each other, wherein the server learns that the user device possesses the correct private key, and wherein upon success authentication of the user, the master cryptographic key is released to unlock an agent credential chain.

17. A non-transitory computer-readable storage medium having instructions stored therein that when executed by one or more hardware processors, cause the one or more hardware processors to execute operations for securing authentication of users:
registering a user identity, wherein the registration of the user identity generates a master cryptographic key stored in a hardware security module of a user device, and wherein no secret data is transmitted after the registration of the user identity is completed;
for every subsequent login, authenticating a user through a zero-knowledge proof ceremony in which a biometric check is performed within the hardware security module of the user device;
monitoring an enrolled biometric set of the user device;
upon detection of a newly added biometric entry after the registration of the user identity, initiating cryptographic zeroization of credential material stored on the user device;
upon successful authentication, deriving cryptographic keys assigned to each artificial intelligence (AI) agent from a master cryptographic key using a deterministic key derivation function, wherein each cryptographic key assigned to each AI agent is cryptographically isolated, whereby access to credentials of one AI agent provide no information regarding credentials of other AI agents;
for each action requested by an AI agent, generating a single-use authorization token encoding a permitted tool or service the AI agent is permitted to call, an authorized data scope, action constraints, and a trust tier, wherein the single-use authorization token is atomically consumed upon first use, rendering the single-use authorization token unavailable for replay;
for AI agent actions above a configurable risk threshold, requiring a cryptographic signature from a second enrolled device that has independently completed biometric authentication, wherein a notification tap, video confirmation, or voice confirmation is insufficient to satisfy the requiring; and
upon execution of each AI agent action, generating a bilateral cryptographic receipt comprising an authorization signature from the user and an execution signature from a service provider, wherein the bilateral cryptographic receipt is independently verifiable by a third party without access to session keys.

18. The non-transitory computer-readable storage medium of claim 17, further comprising:
detecting a duress authentication event based on entry of a designated panic PIN or activation of a distress biometric;
in response to detecting the duress authentication event, silently transitioning the authentication to a restricted operational mode without visible indication to an authenticating party;
transmitting an encrypted alert comprising GPS coordinates, a timestamp, and a device identifier, to a server;
setting trust levels of each AI agent to read-only for precluding execution of transactions and irreversible actions during a duress session; and
logging every action attempted during the duress session with enhanced forensic metadata comprising geolocation, timestamp, and a duress session identifier.

19. The non-transitory computer-readable storage medium of claim 17, wherein registering the user identity comprises:
for an enterprise user, verifying a government-issued identity document in person by an authority, and generating a one-time registration code tied to the verified government-issued identity document, wherein the one-time registration code is single-use, time-bounded, and valid only on a specific device being enrolled; and
for a consumer user, capturing the government-issued identity document, completing a live selfie check with liveness detection using challenge-response verification, performing a document authenticity check to verify that the government-issued identity document is not forged, and performing a face match to confirm that the user matches the government-issued identity document.

20. The non-transitory computer-readable storage medium of claim 17, wherein authenticating the user further comprises:
providing dual cryptographically distinct keys to the hardware security module of the user device, comprising a normal key bound to a primary enrolled biometric entry and a distress key bound to a secondary enrolled biometric entry;
upon each authentication attempt, silently attempting the authentication attempts to unlock the normal key, and if the normal key fails, silently attempting to unlock the distress key; and
upon activation of the distress key, unlocking a sandboxed AI agent environment that is operationally identical to but capability-restricted from a normal AI agent environment, wherein the sandboxed AI agent environment is indistinguishable from the normal AI agent environment to an external observer.
